(19) United States
(12) Patent Application Publication
(10) Pub. No.: US 2024/0135472 A1
(43) Pub. Date: Apr. 25, 2024

(54) ARTIFICIAL INTELLIGENCE TRAVEL POLICY ADVISOR

(71) Applicant: Onriva LLC, Foster City, CA (US)

(72) Inventors: Vajid H. Jafri, Redwood Shores, CA (US); Michael Joseph d’Almada-Remedios, Discovery Bay, CA (US); Hassan J. Abbas, Brisbane, CA (US)

(21) Appl. No.: 18/402,580

(22) Filed: Jan. 2, 2024

Related U.S. Application Data
(63) Continuation-in-part of application No. 17/377,034, filed on Jul. 15, 2021.

(51) Int. Cl. G06Q 50/14; G06Q 40/12; H04L 67/306

(52) U.S. Cl. CPC G06Q 50/14; G06Q 40/12; H04L 67/306

(57) ABSTRACT

A method to form the travel policy for an organization can include using feedback from a user selecting travel reservations annotated with the travel policy to continuously modify the travel policy. The travel policy can be improved to provide the organization with a control of the travel expenditures, together with an advanced knowledge of the travel reservations of the users. In addition, the travel policy can give the users the freedom to select the travel reservations that are most suitable to the users and also acceptable by the corporation.

### CROSS REFERENCE TO RELATED APPLICATIONS

This application is a continuation-in-part of U.S. application Ser. No. 17/377,034, filed Jul. 15, 2021, which is incorporated by reference in its entirety.

### BACKGROUND

Companies can establish travel policies for controlling travel related expenditures or for ensuring uniform travel services. For example, high level management can be permitted to travel in first class or business class, while regular employees are restricted to coach class.

There are different approaches for companies to manage their employees' corporate travel expenditures, ranging from a very strict policy in which all restrictions and requirements of all aspects of travel reservations are specified, to a very flexible policy in which there is no restrictions or requirements with a company-first guideline. There are also policies which permit only booking through a specific travel agency. For example, the company can have a travel policy requiring the use of a designated travel agency, and travel booking, such as flights, hotels, and rental cars reservations, will only be allowed through the designated travel agency, with booking outside of the designated travel agency is not permitted, e.g., not eligible for reimbursement. There are also policies which in which the employees are allowed to book their corporate travel through their booking system of choice or through a designated travel agency.

There are also policies which specify guidelines regarding what travel related costs are permissible expenses. For example, a detailed policy can include specific restrictions and requirements, which are designed to prevent employees from booking items that are not allowed under the corporate travel policy.

Further, the travel policies can require pre-travel reporting of travel expenses and possible violations of travel policy, for example, to enforce corporate policy on a pre-travel basis. The travel policies can be designed to provide an automated expense reporting system.

FIGS. 1A-1B illustrate prior art travel policies according to some embodiments. At one end of the spectrum, a travel policy 142A for an organization, such as for a corporation, can be highly rigid, and designed for maximum controllability, meaning all travel expenditures are spelled out, such as telling the users, e.g., the employees of the corporation, what to do when making travel reservation for the business of the corporation. The travel details are determined by the corporation, regardless of the employee preferences. The travel policy can determine what travel providers or suppliers to be used. For example, when an employee makes a flight reservation, the flight reservation has to be made from a preferred airline, e.g., an airline having a pre-agreement with the corporation. Similarly, when an employee makes a car rental reservation, the car rental reservation has to be made from a preferred car rental company, e.g., a car rental company having a pre-agreement with the corporation. The travel policy can determine what travel classes can be booked for what levels of employees. For example, a mid-level management employee can make a business class reservation, while a regular employee can only fly economy class.

An advantage of the rigid travel policy is that the corporation can have control over the travel aspects of the employees, such as controlling the travel expenses and controlling the schedule and itineraries of the employees. A disadvantage of the rigid travel policy is the potential higher cost of travel expenditures, since the employees are not permitted to take advantages of any travel discount. Another disadvantage is the dissatisfaction of some employees, since the rigid travel policy does not allow the employees to choose any travel reservation that are not determined by the corporation.

At an opposite end of the spectrum, a travel policy 142B for an organization can be highly flexible, such as designed for maximum flexibility, meaning there are no restrictions on travel expenditures, as long as the travel expenditures are made under the consideration of doing the best for the company. The travel policy does not provide any travel detail, such as there are no preferred suppliers and no restriction on the amenity and travel classes.

An advantage of the flexible travel policy is that high cost saving can be achieved by the employees. In general, even though there can be some employees who can take advantage of the flexible policy to spend more on the travel reservation than they should, the large majority of the employees can be highly responsible, and thus can select the travel reservation that mostly suitable for both the employees and the corporation. A disadvantage of the flexible policy is the small number of employees who might abuse the flexible policy. Another disadvantage of the flexible policy is the lack of control over the employee actions, such as not knowing the travel details until the employees submit the travel reimbursement forms.

Thus, there is a need for an optimized travel policy for the corporation, in which the corporation can have control over the employee actions while the employees can have the freedom to choose travel reservations most suitable for their preferences.

### SUMMARY

In some embodiments, the present invention discloses a method to form the travel policy for an organization. The method can include annotating travel search results with restrictions and requirements translated from the travel policy of the organization. The search results can be sorted or arranged based on the travel policy, such as based on the annotations, which represent the restrictions and requirements of the travel policy. Selections of the user with regard to the travel reservations are analyzed to assess a degree of compliance with the travel policy. The selections and the analysis of the selections of the user are reported to the organization, such as to the department responsible to maintain and enforce the travel policy. The report to the organization can be used to tell the organization about the satisfaction of the user with regard to the travel policy, such as to assist the organization in updating the travel policy to improve satisfaction of the user. The organization can modify the travel policy based on the report of the user selections and the analysis of the user selections. Machine learning or artificial intelligence can be used to provide suggestion to the organization regarding the travel policy modification based on the user selections.

In some embodiments, the present invention discloses an AI advisor, which is a next generation travel advice, recommendation and policy engine that uses data and Artificial Intelligence (AI) to learn and advise travelers on travel insights and choices for themselves and their company.

The AI powered system is designed to empower travelers and companies to “do the right thing” by each other across a wide spectrum of control vs. empowerment bias, using flexible advice and enforcement combinations.

This allows traditional companies to evolve seamlessly from traditional Travel Management Company (TMC) style travel policies to more progressive travel advice with marketplace empowerment.

In some embodiments, the present invention discloses a method to optimize a company travel policy by analyzing actions of its employees and associates, with the action occurred when the employees and associates look for a travel schedule subjected to the control of the travel policy. The actions can be stored in a profile for each user, e.g., for each employee or associate. The actions can be analyzed by an AI algorithm linking a satisfaction of the users with the restrictions of the travel policy. The user satisfaction can be generated through the user actions. The linkage with the policy restriction can be determined through a compliance of the users with the policy. The user profiles can also be used to assist the users in the travel schedule search, for example, by storing the user preferences, with the preferences characterized also based on the user actions.

In some embodiments, the method can be based on a profile for all users, e.g., the user actions are collected in a single user profile. The actions stored in the profile can be analyzed by the AI algorithm, without knowing the particular identities of compliant or non-compliant users or of satisfied or non-satisfied users. The analysis of the user actions can then anonymous, which can allow the users to provide feedbacks without a concern of retribution of the company.

### BRIEF DESCRIPTION OF THE DRAWINGS

FIGS. 1A-1B illustrate prior art travel policies according to some embodiments.

FIG. 2 illustrates a schematic for a travel platform for generating a travel policy for an organization according to some embodiments.

FIGS. 3A-3C illustrate flow charts for a process to form a travel policy according to some embodiments.

FIGS. 4A-4B illustrate configurations for communication with the travel platform according to some embodiments.

FIG. 5 illustrates a flow chart for a travel policy formation according to some embodiments.

FIG. 6 illustrates a display of a graphical user interface according to some embodiments.

FIGS. 7A-7B illustrate configurations of displayed search results according to some embodiments.

FIGS. 8A-8D illustrate flow charts for search result displays according to some embodiments.

FIGS. 9A-9B illustrate configurations of travel expenditures based on market conditions according to some embodiments.

FIGS. 10A-10C illustrate flow charts for search result displays according to some embodiments.

FIG. 11 illustrates a process for reporting user actions according to some embodiments.

FIGS. 12A-12C illustrate flow charts for reporting user actions according to some embodiments.

FIG. 13 illustrates a process for updating a travel policy according to some embodiments.

FIGS. 14A-14C illustrate flow charts for updating a travel policy according to some embodiments.

FIGS. 15A-15B illustrate computing environments according to some embodiments.

FIGS. 16A-16B illustrate display configurations for the search results of a hotel according to some embodiments.

FIGS. 17A-17B illustrate display configurations for the search results of a travel plan according to some embodiments.

FIGS. 18A-18B illustrate positive selection, e.g., selection, and negative selection, e.g., deselection, processes for a flight matrix according to some embodiments.

FIGS. 19A-19B illustrate OR and AND selection processes for a flight matrix according to some embodiments.

FIGS. 20A-20B illustrate expanded and contracted flight matrices according to some embodiments.

FIGS. 21A-21D illustrate a re-arrangement of flight matrices according to some embodiments.

FIGS. 22A-22B illustrate a configuration for a display in a travel listing format according to some embodiments.

FIGS. 23A-23C illustrate a re-arrangement of flight matrices into flight itineraries or flight listing according to some embodiments.

FIGS. 24A-24B illustrate flight matrices to be displayed on a screen according to some embodiments.

FIG. 25 illustrates a configuration of a behavior profile according to some embodiments.

FIG. 26 illustrates a flow chart for authenticating a user according to some embodiments.

FIG. 27 illustrates a flow chart for optimizing a travel policy according to some embodiments.

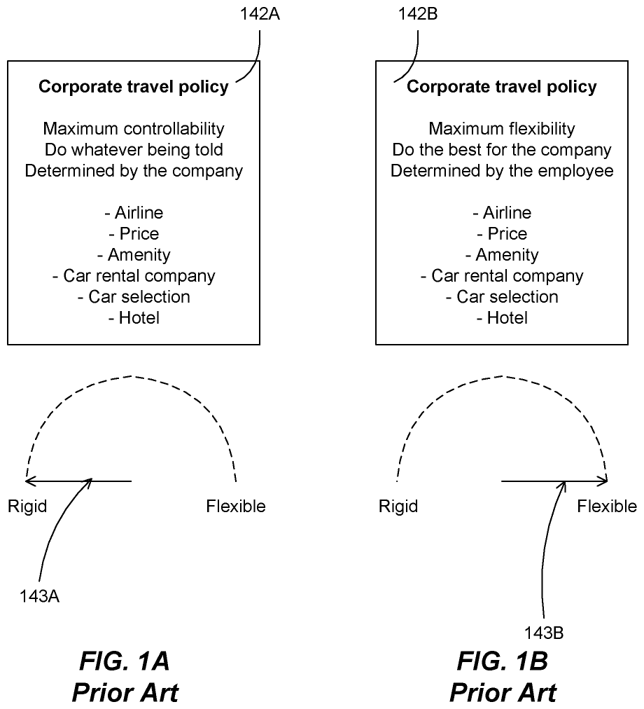

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

In some embodiments, the present invention discloses a travel policy of an organization, and methods to form the travel policy. The travel policy can be optimized to provide the organization with a control of the travel expenditures, together with an advanced knowledge of the travel reservations of the users associated with the organization, such as the employees of the corporation. In addition, the travel policy can give the employees the freedom to select the travel reservations that are most suitable to the employees and also acceptable by the corporation.

The method can include annotating travel search results with restrictions and requirements translated from the travel policy of the organization. The requirements and restrictions from the travel policy can set the policy for the travel related expenditures, including different requirements and restrictions for different associated users of the organization. The classification of travel expenditures can be based on the roles of the users, such as having different travel expenditure limits for officers, for high level managers, for low level managers, or for common employees. The classification of travel expenditures can be based on the salary levels of the users, with higher salary users having higher travel expenditure limits. The classification of travel expenditures can be based on the booking histories of the users, with users having a history of high compliance with the policy having higher travel expenditure limits as compared to users having a history of low compliance with the policy.

In some embodiments, the travel policy can include upper threshold limits, lower threshold limits, warning ranges, and allowed ranges of the travel related expenditures. The upper threshold limits can establish the maximum allowable expenses for different travel related expenditures. For example, air flight or hotel prices can have maximum limits, with different limits for different groups of users. In general, expenses above the upper threshold limits require approval from the organization.

The lower threshold limits can establish maximum automatic allowable expenses for different travel related expenditures. In general, expenses under the lower threshold limits are automatically approved, e.g., being pre-approved by the organization.

The warning ranges can establish ranges of expenditures that are allowable but with a warning from the organization. In general, expenses within the warning ranges require justifications from the user.

The allowable ranges can establish ranges of expenditures that are allowable by the organization. In general, expenses within the allowable ranges are automatically approved.

In some embodiments, the values for the upper and lower threshold limits, and the values for the warning and allowed ranges can be fixed values, e.g., the travel policy can specify numbers for the limits rand ranges. For example, an upper threshold limit for an air flight from Boston to San Francisco can be $2000, or an allowed range of meals is between $20 and $40.

In some embodiments, the values for the limits ranges can be determined by the market conditions, e.g., there is no fixed value specified by the travel policy. Instead, the limits and ranges can be calculated from the average values offered by the market. For example, during an emergency situation or during a highly popular event, the air fares can be significantly increased due to a large number of people travelling from or to the affected areas. The limits and ranges determined by the travel policy can be adjusted to conform to the changes in market valuations. Similarly, during a promotion period in which there is minimal people movement, air fares can be reduced, and the limits and ranges can also be adjusted.

The travel search results can be the results generated from a request for a travel reservation of a user associated with the organization, with the travel reservations made for the organization business. Each search result can include a candidate travel reservation, such as a flight itinerary meeting the departure and destination inputs from the user. Each search result can include an annotation, which can serve to notify the user of the travel policy. For example, the annotations can include a notice of compliance or a notice of non-compliance with the travel policy.

The non-compliance notices can include a non-booking notice, which indicates that the travel reservation is not allowable by the travel policy. The annotation for the non-booking notice can include an explanation from the organization, explaining the reasons for the non-bookable reservation, such as having too high a price, or an unsafe flight. The non-bookable reservation can also include a feedback field, for example, to allow the user to rebut the non-bookable decision of the organization. The feedback of the user can be reported to the organization for review, which can result in an improved travel policy, e.g., a travel policy that is suitable for both the organization and the users.

The non-compliance notices can include a bookable notice, which indicates that the travel reservation is allowed, but not recommended, by the travel policy. The annotation for the bookable, but not complied with the travel policy, reservation can include an explanation from the organization, explaining the reasons why the reservation does not comply with the travel policy, such as having a price that is considered not optimal from the point of view of the organization, or having a flight itinerary that having a long stop over. The bookable, but not complied, reservation can also include a justification field, for example, to allow the user to justify the reasons for selecting the non-compliance reservation. The justification can be optional, for example, if the non-compliance is minor. The justification can be mandatory, for example, if the non-compliance is not minor. The justification of the user can be reported to the organization for review, which can result in an improved travel policy, such as to move the bookably non-compliance reservation to the compliance area, or to move the bookably non-compliance reservation to the non-bookable area.

The compliance notices can include a recommendation notice, which indicates that the travel reservation is recommended by the travel policy. The annotation for the recommended reservation can include an explanation from the organization, explaining the reasons why the reservation is recommended by the organization, such as being supplied by a preferred supplier, or having a price that is approved by the organization. The compliance notices can include a notice of preferred suppliers based on a pre-negotiation agreement from the travel policy.

In some embodiments, for the search results complied with the travel policy, the annotation of compliance can be omitted, or can simply be annotated with an approval note, such as an approved icon.

In some embodiments, the search results are displayed based on a preference profile of the user with some search results or all search results having annotations based on the travel policy. For example, the search result can be displayed in a graphical user interface to show the annotations representing the restrictions or requirements of the travel policy.

In some embodiments, the search results can be sorted or arranged based on the travel policy, such as based on the annotations, which represent the restrictions and requirements of the travel policy. For example, the recommended search results, e.g., the reservations having a recommendation annotation, can be displayed first, followed by the compliance reservations, followed by the bookably non-compliance reservations, and followed by the non-bookable reservations.

The search results can be arranged based on a preference profile of the user. In some embodiments, the user preferences supersede the travel policy, e.g., the searched results are sorted based on the user preferences, with the top reservations most suitable to the users are displayed. In some embodiments, within the most suitable reservations, the reservations are further arranged based on the travel policy. In some embodiments, the reservations are not sorted based on the travel policy, e.g., the reservations are sorted to be displayed only according to the preferences of the user, with the inputs from the organization added as the annotations.

An innovative feature of the present travel policy is the transparency of the rational and decisions of the organization with respect to travelling. The travel policy seeks to convey the message that the organization cares and is concern about the preferences of the user. The travel policy is also hopeful that the user, when selecting travel reservations, can choose the travel reservations that are best for the organization.

The displayed search results are annotated and not hidden from the user, so the user can know about all available candidates for the travel reservations. For example, the user can know that there is a travel reservation that satisfies the user preferences, but is not recommended or is considered non-bookable from the organization point of view. The organization can include an annotation explaining the reasons for the prevention of the user from booking the off-limit travel reservation, or why the reservation is not recommended. The annotations can further include a feedback field, for the user to provide inputs such as why the restrictions should be removed, or why the user should be allowed to choose the non-compliance or non-recommended reservation.

In some embodiments, the selections of the user with regard to the travel reservations are analyzed to assess a degree of compliance with the travel policy. The selections can include a selection for an air flight, a selection for a lodging accommodation, such as choosing a hotel, a selection for a car rental, and other selections, such as selecting food and entertainments.

The degree of compliance can be based on how the selections comply with the travel policy, e.g., how the selections comply with the restrictions and requirements of the travel policy. For example, the degree of compliance can be based on how the selections meet the expenditure limits of the travel policy, such as the user selects travel reservations that are recommended, allowed, or requiring justifications. The degree of compliance can also be based on how the selections comply with the travel policy regarding selecting preferred suppliers having a pre-negotiation agreement from the organization. The preferred suppliers typically earn a recommended annotation from the organization, so a selection of a preferred supplier can have a higher degree of compliance as compared to a selection of a non-preferred supplier.

In some embodiments, the selections and the analysis of the selections of the user are reported to the organization, such as to the department responsible to maintain and enforce the travel policy. The report to the organization can be used to tell the organization about the satisfaction of the user with regard to the travel policy, such as to assist the organization in updating the travel policy to improve satisfaction of the user. For example, if a large majority of users associated with the organization comply with the travel policy when selecting travel reservations, the travel policy can be considered to be successful, e.g., providing many happy users while exerting control over the travel expenses. The number of satisfied users can also be an indication of the regulation of the travel policy. For example, if all users are satisfied, the travel policy might be too relaxed and generous. More restrictions and tighter limitations can be applied to save money for the organization. In contrast, if more than half of the users are not satisfied, then the travel policy might be too rigid. Feedback from the users can be more carefully evaluated and applied to the travel policy, for example, to generate a happy workplace environment and to reduce travel expenses. The percentage of optimum satisfied users can be between 70 and 90%.

The report to the organization can be used to tell the organization the price or value of non-compliance with the travel policy. The report can be configured to assist the organization in regulating the travel expenditures by updating the travel policy. For example, from the analysis of the user selections, the organization can see how much the travel expenditure increases or decreases as compared to the upper or lower expense limits. Higher expenses can mean that the travel policy could be more generous to meet the demands of the user. Too high expenses can mean that the travel policy could be more rigidly enforced, to prevent budget overrun. Lower expenses can mean that the users are conscious with regarding to selecting what is best for the organization, and the travel policy could be even flexible and generous to give the users more room for innovation.

In some embodiments, the report to the organization can be used to assist the organization in setting limits of the travel expenditures to be conformed to market conditions. The report to the organization can use current market values to assist the organization in modifying the travel policy, such as to determine the limits and ranges of the travel related expenditures. Further, the report to the organization can include the feedback and the justifications of the user for selecting travel reservations having warning notices.

The travelling of the user is a necessary element of the functionality and growth of the organization, so it is important that the user can successfully make the travel reservations, in order to fulfill the organization business. If the limits of the travel expenditures are out of the normal prices of the market, the travel policy can impede the working environment of the user, since the user cannot easily make the travel reservations. In general, the limits of the travel expenditures follow the average market conditions, but not the instantaneous fluctuation of the market. Thus, the travel policy can set the limits of the travel expenditures based on the market conditions, such as having maximum limits of 20-40% higher than the average market prices, instead of providing fixed values.

Alternatively, the ravel policy can provide fixed values for the limits, with large ranges of the allowable expenses to allow for the widely fluctuation in market prices. The report of the user selections can assist the organization in knowing the market prices, and the behavior of the user in response to the differences in the travel policy and the market conditions.

In some embodiments, the report to the organization can be used to assist the organization in negotiating with preferred suppliers to update the travel policy. The report can provide a volume of the number of travel reservations of users of the organization, which can be used to negotiate wholesale prices. Multiple preferred suppliers can be selected, in order to satisfy the divert needs of the users.

In some embodiments, the organization can modify the travel policy based on the report of the user selections and the analysis of the user selections. Machine learning or artificial intelligence can be used to provide suggestion to the organization regarding the travel policy modification based on the user selections. For example, the travel policy can be modified to improve efficiency and cost effectiveness of the travel expenses. The travel policy can be modified to improve controls of the travel expenditures of the user. The travel policy can be modified based on the selections of the user to improve satisfaction of the user.

In some embodiments, the method for forming a travel policy for an organization can include a graphical user interface, configured to display the search results together with the annotation generated from the travel policy. The search results are displayed based on a preferential of the user, together with the annotations of the travel policy.

The graphical user interface can be configured to display explanation and reasoning from the travel policy, to give the user the feeling of concern, e.g., the goal of the travel policy is to regulate expenses while taking into consideration the comfort and preferences of the user.

The graphical user interface can be configured to accept inputs, feedback, and justifications from the users, for example, to allow the modification of the travel policy toward an optimal policy. With a two way communication between the organization and the user with regard to the restrictions and requirements of the travel policy, the travel policy can be easily accepted by the users and the organization.

In some embodiments, the graphical user interface can be configured to display the search results based on the annotation such that search results meeting the travel policy are at the top of the search results. The search results can be sorted using a weighting mechanism based on the annotation, a preference profile of the user, and past booking made by the user.

In some embodiments, the graphical user interface can provide improvements on being user friendly with backend search capabilities. The graphical user interface can compete with available travel websites, and thus can attract users to use the organization approved travel platform in make travel reservations, instead of using other travel reservation websites.

In some embodiments, the present invention discloses a method to generate a travel policy for an organization that can provide a balance between a high controllability of users associated with the organization and a flexibility for the users. The method can include annotating the search results for a travel reservation from a user with the requirements and restrictions of the travel policy. The method can also include providing reports to the organization regarding the actions of the user in selecting the travel reservation. The method can also include updating the travel policy with inputs from the organization, which indicate feedback from the organization upon receiving the reports.

The method can provide a travel reservation booking system that can accommodate travel preferences of a user while adhering to the travel policy administered by an organization in which the user is associated with. The method can provide a travel reservation booking system in accordance with the organizational travel policy while meeting the personal requirements of the user. The method can offer the user the ability to provide inputs and feedback to the organization travel policy, in order to generate an optimal travel policy that can satisfy both the organization and the user. The optimized travel policy can eliminate the need for the user to produce creative ways to circumvent the travel policy to be comfortable in travelling. The optimized travel policy can eliminate the need for the user to bypass the travel policy whenever possible to take advantage of travel perks offered by the organization. With the optimized travel policy, the user would be satisfied following the policy, which can prevent travel data being lost.

In some embodiments, the present invention discloses a platform, e.g., a program running on a data processing system, which can be configured to provide travel reservations to users, who are associated with an organization, looking for travel reservations, such as for air, bus, or train travel, together with lodging accommodation and car rental. The platform can communicate with the organization to obtain detail instructions regarding the travel policy for users of the platform who are associated with the organization.

In operation, the platform can receive communication from a user, such as a request for travel reservations, such as flight itineraries between cities, and/or hotel and car rental reservations in the destination city. The platform can communicate with service providers to search for candidates for the travel reservations. The search results, with each research result containing a candidate for a travel reservation, then are presented to the user together with annotations for the search results, which represent the guidelines, directions, restrictions, and requirements from the travel policy.

The annotated search results can be sorted or displayed to the user based on a preference profile of the user, e.g., the search results containing the travel reservations mostly suitable to the user, according to the preference profile, are displayed at a top portion.

The annotated search results include all search results, e.g., the search results containing the travel reservations not allowable by the organization, e.g., violating the travel policy, are also displayed. Thus, the platform can place all travel information directly in the hands of the user, e.g., the user, through the search, can know about all available travel reservations offered on the market, including the travel reservations prohibited by the organization and the travel reservations allowed by the organization.

The annotated search results are annotated with inputs from the organization, such as with notices of restriction, notices of requirements, or notices offering guidelines. Each search result can be annotated. Alternatively, some search results can have the annotation omitted, which represents a default notice. For example, search results having approval annotations can either be annotated with an approval notice or can have the approval annotation omitted. The search results without the annotations can be the travel reservations having met all the requirements and restrictions of the travel policy.

The user can select one or more travel reservations from the search results. The actions of the user can be reported to the organization. The travel policy can be updated to reflect an improvement of the travel policy, e.g., to provide a balance between the need to control the travelling of the users by the organization and the desire to be comfortable and cost saving by the users.

In some embodiments, the travel policy can assist in generating a summary of the corporate travel expenses by category. By providing a travel policy that is observed by all users in the organization, all users can use the travel platform to make reservations when travelling on organization business. As such, the travel platform can provide the organization with estimations of travel expenses and category breakdowns based on actions of the users. These estimates can be accurate and up to date, including the changes made to early reservations by the users.

In some embodiments, the travel policy can assist in maintaining consistency in travel and to keep costs at a reasonable level. By providing a travel policy that is observed by all users in the organization, there can be no travel booking outside of the travel policy. For example, new travel suppliers (e.g., airlines, hotels, and car rental agencies) with new pricing rates can be included in the updated travel policy to ensure satisfaction of the users in compliance with the travel policy.

The travel policy can provide an overall cost saving, instead of individual low prices. For example, even though an out-of-policy hotel rate is the same or less than the in-policy rate, the selection of the in-policy hotel can provide hotel-night volume or qualify for other incentives with the preferred hotel supplier. The reason can be communicated to the user, for example, through the annotation having an explanation field, so that the user can be aware of the hidden benefits of the recommending higher-rate travel reservations.

In some embodiments, the travel platform can offer bonus point to the users, for example, to prevent the users from booking with out-of-policy suppliers or reservations to gain personal rewards.

In some embodiments, the travel platform can collect user actions in selecting travel reservations from travel search results annotated with data from a travel policy, and analyzing the user actions to modify the travel policy. The travel platform can employ artificial intelligent algorithms linking the user behavior and the travel policy to generate a travel policy suitable for both organization and users.

In the present specification, the reference is made to flight reservations. It is readily understood that the travel reservation described herein are applicable to other types of travel services, such as bus transportation, rail transportation, lodging accommodation such as hotel reservations, car rentals, tours, food, and entertainment reservations.

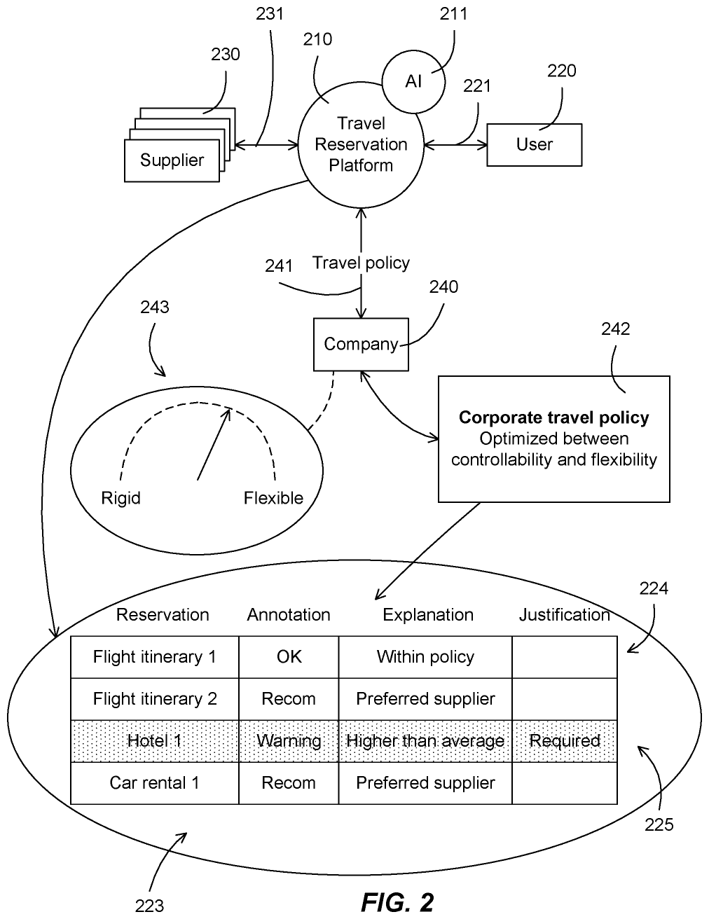

FIG. 2 illustrates a schematic for a travel platform for generating a travel policy for an organization according to some embodiments. A user 220 can contact 221 a travel platform 210 to obtain candidates for travel reservations. The platform can be contacted by the user using a mobile phone, a desktop computer, or some other type of computing device. The contact 221 can include a request for searching available travel reservations meeting a user requirement, including airline, car rental, and hotel reservations. For example, the request can be for a flight itinerary, with departure and destination locations, and time and date of the travel. Alternatively, the request can also for a lodging accommodation and car rental. The request can be sequential, e.g., a flight reservation is provided first, followed by a hotel and car reservation.

The user can provide search criteria and initiate searches for available travel services. The platform 210 can interface 231 with one or more suppliers or data depositories 230. For example, for airlines reservations, the travel platform can contact the reservation systems of the airlines or the data depository Global Distribution System (GDS), which contains reservations for multiple airlines.

Search results 223 meeting the user search criteria can be displayed to the user, including the candidates for reservation, and the annotations based on a travel policy 242 of a company 240. The company can provide 241 the platform with the travel policy, such as providing the platform with restrictions and requirements on travel reservations that meet the travel policy guidelines. The information from the travel policy supplied by the company to the platform can be used to annotate the search results 223, such as to provide inputs to the individual travel reservations. For example, the travel reservation can be annotated with an approval note, a recommendation note, a warning note, or a forbidden note. The annotations can include explanations for the restrictions on the travel reservations. For example, a recommendation note can be accompanied by an explanation stating that the recommended reservation is from a preferred supplier. A warning note can be accompanied by an explanation stating that the fare is higher than average. The annotations can include fields for feedback or for justification from the user. For example, if the user wants to book a reservation with a warning notice, a justification for the booking action is required. Alternatively, even though the user is not allowed to book a non-bookable reservation, the user can provide a feedback to the company through the feedback field.

The user can select a travel reservation 225, among the display travel reservations 224. The selection can be processed by the platform. The selections can be automatically approved and the selected travel reservation can be booked for the user if the selection is within the approval area of the travel policy. The selections can be forwarded to the company for approval if the selection requires additional approval from the company. For example, a minor warning reservation can carry an automatic approval if the user provides the required justification. A major warning reservation can require that the travel reservation be forwarded to the company for processing before deciding whether or not the reservation is approved.

In some embodiments, the present method can provide multiple classes of policy violations, such as forbidden violations, high-level warning violations, or low-level warning violations. In forbidden violations, the user is not allowed to select the forbidden reservations. However, the method does not hide the reservations, but instead, allow the organization to explain the forbidden reason, together with an opportunity for the user to provide feedback to the organization, such as to state why the forbidden reservations indeed should be allowed.

In high-level violations, the user is allowed to select the high-level violation reservations. However, the method requires the user to submit justification, and also requires the user to wait for a review on whether or not the justification is accepted. In low-level violations, the user is also allowed to select the low-level violation reservations. The method also requires the user to submit justification, but does not require the user to wait for a review. The low-level violation reservations can be automatically approved with the submission of a justification.

Data from the users, such as the user selections, the user inputs on the search results, and an analysis of the user actions, can be provided to the company at a certain interval. The reporting data can include individual actions and behavior, trend analysis, year-to-date totals, and chronic policy violations. The company can use the data to modify the travel policy, such as to be more user friendly or user satisfactory, while maintaining the core principle of the travel policy according to the organization. The modified travel policy can be communicated with the platform for updating the travel policy on the platform.

With the continuous feedback, the travel policy can provide a balance 243 between being rigid and flexible, to make the user happy by providing comfort to the user, and to make the company happy by provide early data on the travel plans and expenses from the user.

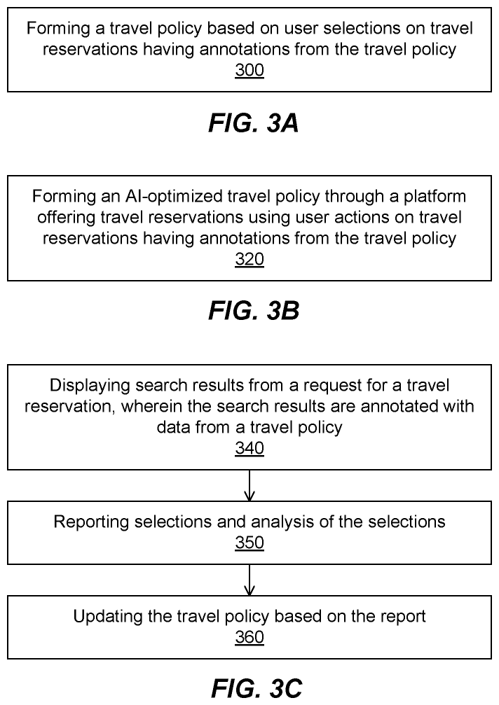

FIGS. 3A-3C illustrate flow charts for a process to form a travel policy according to some embodiments. In FIG. 3A, operation 300 forms a travel policy based on user selections on travel reservations having annotations from the travel policy.

In FIG. 3B, operation 300 forms an AI-optimized travel policy through a platform offering travel reservations using user actions on travel reservations having annotations from the travel policy.

In FIG. 3C, the method can include generating a graphical user interface for a listing of the search results, with the search results rendered for display in an order based on at least one annotation.

Operation 300 displays search results from a request for a travel reservation, with the search results annotated with data from a travel policy. A user can enter basic trip parameters and then request a search for the available reservations.

For example, a user can send a travel request to a platform. The travel request can include a departure location, an arrival location, and a date of travel. The platform can search for available flights meeting the user specifications. The platform then can show the searched flights, which can be sorted based on a user preference, such as ordered by price. Information about the flights can be shown, such as the airline name, the departure time, the arrival time, and the airfare. Other information can be included, such as the name of the departure and arrival airports. Other details of the flights can be shown, such as details of the flight characteristics, including the physical specifications of the airplane and the services of the flight crew.

In addition, there can be annotations for the search results. The search results can include a list of available hotels in the destination city. The user can also request availability at certain preferred hotels. The search results can include a list of preferred rental car vendors, with special negotiated rates.

Operation 350 reports selections and analysis of the selections. The user actions and the analysis of the user actions can be reported to the company, such as to the corporate travel manager.

Operation 360 updates the travel policy based on the report. The organization can use the user selections for bargaining with preferred suppliers, such as to show the number of bookings from users of the organization. The report can allow the organization to change the travel policy to reflect saving from the user selections, to restrict wastes, or to allow for expense adjustments during special times.

In some embodiments, the travel policy can be updated based on the actions of the user. For example, the platform can display multiple reservations with annotations from existing travel policy. Based on the selections of the user, the travel policy can be updated to reflect the selections, e.g., to improve the satisfaction of the user without compromising the organization requirement and restrictions.

The analysis of the user actions can include a trend analysis for forecasting. For example, the analyzed air travel reservations, the analyzed car rental reservations, and the analyzed hotel reservations can report the percentage of policy compliance and the policy warning for individual users, together with selected air carriers, with air travel for a given city pair, overall air cost for a given city pair, and average leg fare cost for a given city pair, and with car rental companies and hotel companies,

In some embodiments, the platform can apply machine learning to optimize the travel policy, such as assigning weights to each selection and action of the users.

In some embodiments, the method can include a travel reservation platform, which is configured to contact suppliers for searching for available travel reservations, such as contacting airlines for air reservations, contacting car rental agencies for car rental reservations, and contacting hotel managements for hotel reservations. The travel platform can be configured to communicate with users of an organization, for example, to provide search results for travel reservations. The travel platform can be configured to communicate with the organization, for example, to obtain a travel policy of the organization, including restrictions and requirements of the travel policy, and to provide reports about the user actions.

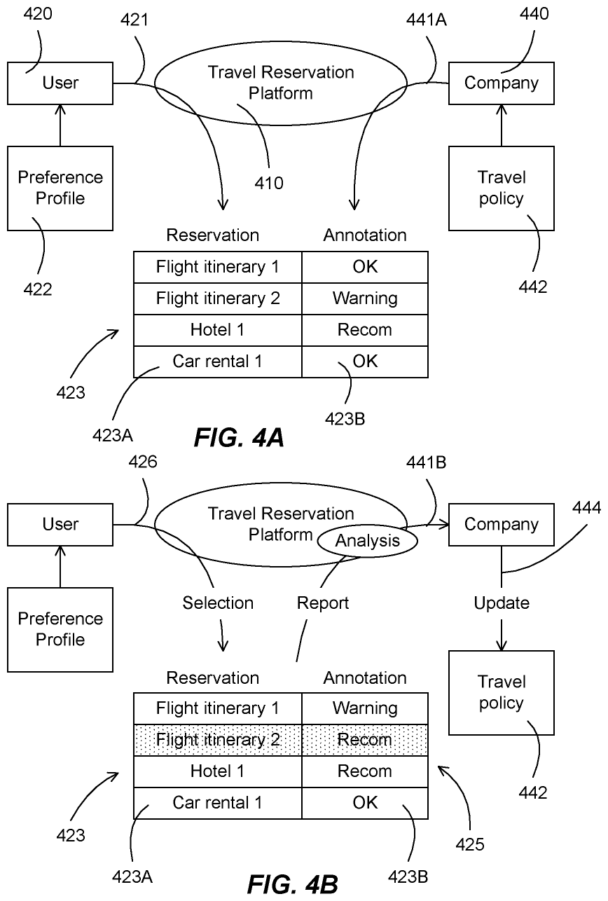

FIGS. 4A-4B illustrate configurations for communication with the travel platform according to some embodiments. In FIG. 4A, a travel reservation platform 410 can have access to multiple suppliers for searching and making reservations for travel related services. The platform 410 can also communicate with a company 440, such as an organization or a business entity, for supplying travel reservation services to the company. The company can have a travel policy 442, which can govern all aspects of business travel for users associated with the company, such as for employees or contractors of the company. The company can communicate 441A with the platform, to supply to the platform the travel policy, such as the rules and regulations, including restrictions and requirements for business travel of the users associated with the company.

The travel platform 410 can be configured to provide travel reservation services to users, including a user 420 who is associated with the company 440, e.g., an employee or a contractor who can employ the services of the platform for making travel reservations for business purpose. The user can have a preference profile 422, which can be provided to the platform, so that the platform can process the available travel reservations, such as to sort the reservations, to present to the user the reservations mostly suitable to the user. In some embodiments, the user does not have a preference profile, and the platform can use a default profile, such as low fares and high comfort.

In operation, the user 420 can communicate with the platform 410, for example, to request 421 for a travel reservation service. The travel service can include a travel reservation for a flight itinerary, a travel reservation for a car rental, or a travel reservation for a hotel. The request can include a departure location, a destination location, and a date of travel. For a flight reservation, the platform can search for flight itineraries meeting the departure and destination locations, such as the departure and destination airports at the location cities, and the date of travel. For a car rental reservation, the platform can search for car rental availability at the destination location, such as at the airport of the destination city. For a hotel reservation, the platform can search for hotel availability at the destination location, such as within 10-30 mile radius at the destination city.

Upon receiving the request 421 for a travel reservation, the platform can perform a search on the supplier websites or on the supplier databases, using data from the travel request. For example, the platform can contact airline websites, or repositories of multiple airlines such as GDS, with departure location, destination location, and date of travel, to obtain available flight itineraries meeting the user requirements. The platform can contact car rental agencies and hotel management services to obtain available car rentals and hotels meeting the user requirements. The searches for air travel, car rental, and hotel accommodation can be performed at a same time to be presented to the user, or can be performed one at a time, e.g., after the user finishes selecting a flight itinerary, the platform can search and present car rental availability, followed by hotel availability.

After finishing the search, the search results can be annotated with the rules and regulations from the travel policy of the company that the user is associated, if the user is traveled for the business of the company. For example, the platform can provide an annotation on each search result, and the reservation and the annotation then can be displayed and presented to the user.

In some embodiments, the search results are arranged or sorted according to a preference profile of the user. If the user has no preference profile, a default preference profile can be used, which can be a generic profile, such as low fare, high comfort, and high convenience.

In some embodiments, the method can include a graphical user interface, rendered to display the search results of a request for a travel reservation. The graphical user interface is also rendered to display annotations for the search results, such as for each search result. The graphical user interface can be configured to display the search results based on the preference profile, e.g., either the user preference profile or the default preference profile. In addition, only the search results to be displayed in the graphical user interface are processed to add the annotations, e.g., the search results not displayed to the user are not processed to be annotated. Thus, in some embodiments, only the search results to be displayed to the user are processed to be annotated. The graphical user interface can be configured so that a search result considered to be displayed in the graphical user interface can pass through a processing module to acquire an annotation which represents the rules and regulations of the travel policy, e.g., the annotation indicates whether the search results meets or exceeds the travel policy restrictions and requirements.

As shown, the graphical user interface can show a displayed search results 423, in which each search result 423A, representing a candidate for a travel reservation, is annotated with an annotation 423B. Further, the displayed search results 423 are shown with a mixture of different reservations, such as flight reservation, car rental reservation, and hotel reservation. In some embodiments, the different types of reservations are displayed separately. For example, only the flight reservations are shown in the graphical user interface. After the user selects a flight reservation, the graphical user interface can be processed to continue with car rental reservations, followed by hotel reservations.

In FIG. 4B, the user can select 426 travel reservations, together with performing other actions to complete the booking process, such as satisfying any requirements imposed by the annotations. For example, the user can select a flight reservation 425. Since the flight reservation 425 is annotated with a recommendation notice, there can be no additional action from the user, e.g., the selection of the user meets the travel policy requirements and restrictions of the company. The platform then can process the selected reservation, such as booking the flight reservation and sending a confirmation to the user. The process can continue for other reservations, such as for a car rental reservation, for a hotel reservation, and for other reservations such as food and entertainments.

In some embodiments, if the user selects a travel reservation that requires an approval from the company, the platform can send an inquiry to the company, and then waiting for an answer from the company before proceeding.

After an interval period, the actions of the user can be correlated and processed, such as performing an analysis on the user actions, including a summary of the user selections, a history and trend of the user selections, and the levels of compliance to the company travel policy. The platform then can communicate 441B with the company, such as to send a report to the company. The company can use the report to update 444 the travel policy, in order to improve satisfaction of the user while still maintaining the company control over the travel aspects, such as to control the travel expenses to provide a cost effective travel expenditure, e.g., a travel expenditure scheme that is generous to the user but not wasteful at a same time.

The company can communicate with the platform to provide the updated travel policy to the platform. The platform then can update the existing travel policy with the updated travel policy. The feedback process can continue, with the company continuously updating the travel policy in response to the user actions in selecting travel reservations having annotations from the travel policy.

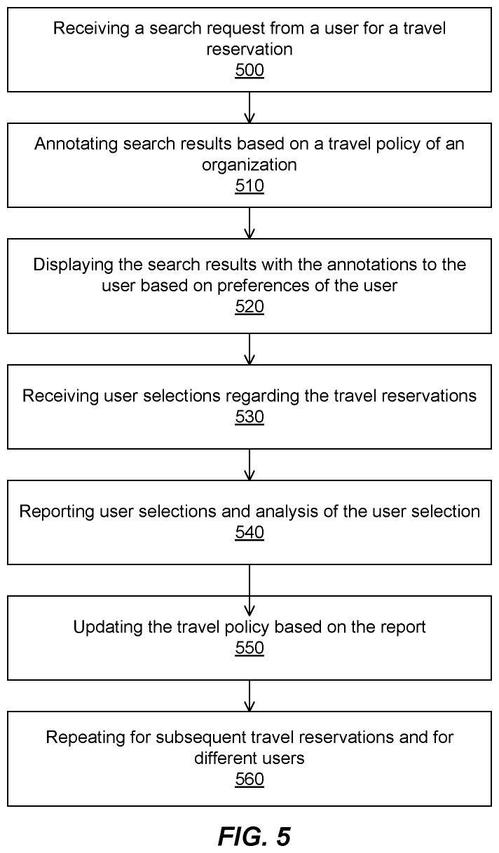

FIG. 5 illustrates a flow chart for a travel policy formation according to some embodiments. Operation 500 receives a search request from a user for a travel reservation, such as a flight reservation, a car rental reservation, or a hotel reservation. The reservation request can include information to allow for a search of matching candidates.

Operation 510 annotates search results based on a travel policy of an organization. The annotations can be provided on each search result. The annotations can be provided only on search results that are to be displayed to the user, thus can reduce the processing time. For example, the search results can be arranged and sorted based on a preference profile, such as a preference profile of the user or a default preference profile, if the user does not have a preference profile. The top arranged search results can be displayed. Further, the search results can be re-arranged and re-sorted based on inputs of the user. The search results to be displayed can be processed so that each search result can have an annotation. For example, the platform can include an annotation module, which can receive a search result and, after processing, generating an annotation for the search result based on the rules and regulations of the travel policy.

Operation 520 displays the search results with the annotations to the user based on preferences of the user. The displayed search results can be arranged based on the annotations, after being arranged by the preference of the user.

Operation 530 receives user selections regarding the travel reservations. The user selections can include a justification or a feedback, which can be required or optional, determined by the annotations for the selected search results that are selected by the user.

Operation 540 reports user selections and an analysis of the user selections. The actions of the user, including the selections, justification, feedback, and other actions, can be reported to the company. Further, an analysis of the user actions, including past user actions, e.g., user actions on reservation selections in the past, can also be reported.

Operation 550 updates the travel policy based on the report. The company can update the travel policy. The company can communicate with the platform regarding the updated travel policy, so that the platform can update the existing travel policy with the updated travel policy.

Operation 560 repeats for subsequent travel reservations and for different users. With the constant feedback of the user actions and travel policy updating, an improved or optimized travel policy can be formed, with a balance between maximum user satisfaction and company control and performance. For example, a goal of the travel policy is to maximize the employee performance, e.g., to achieve the best work from the employee. To accomplish the task, high employee satisfaction, such as on travel reservations, is necessary. Thus, the travel policy is optimized to obtain the best performance of the employee, such as to maximizing the employee satisfaction while not damaging the company operations.

In some embodiments, the travel policy can be improved or optimized based on feedback from the users. For example, each travel reservation to be shown to the user can be annotated with the rules and regulations of the current travel policy. After the selections and feedback from the user with regard to the current travel policy, the current travel policy can be updated to improve the user satisfaction, as long as the improvements do not damage the company operations. For example, a goal of the travel policy is to minimize the travel expenses while not affecting the employee performance. Thus, an optimized travel policy can be a travel policy that provides a balance between travel cost and employee satisfaction.

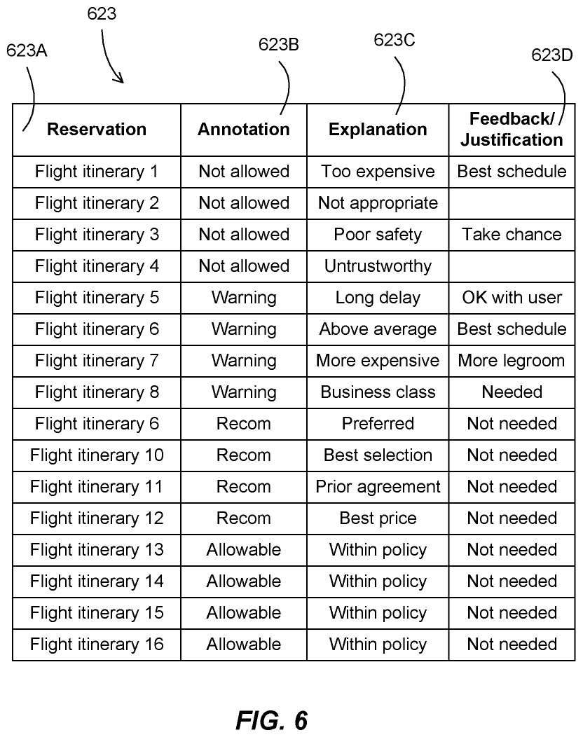

FIG. 6 illustrates a display of a graphical user interface according to some embodiments. The graphical user interface can include displayed the search results 623. The displayed search results can include reservations 623A, e.g., the candidates for the travel reservations matching the requirements of the user. The displayed search results can include annotations 623B, which can be a summary of the assessment of the travel policy regarding the reservations 623A.

The displayed search results can include explanations 623C, which can be a communication from the company to the user, for example, to explain the reasons for the classification of the reservations 623A. The communication between the company and the user is important, since it can let the user know that the company classifies the reservations for a reason. The explanation can be important because sometimes the reason can be not obvious from the present facts. For example, a low fare reservation might not obtain a recommendation classification as compared to a higher fare reservation, since the company can obtain additional benefits from the suppliers providing the higher fare reservation.

The displayed search results can include feedback or justifications 623D, which can be a communication from the user to the company, for example, to justify the reasons for the user selecting the reservations 623A or to provide feedback to the company regarding non allowed reservations. The justification can be informal, e.g., the company simply requires that the user thinks before booking the reservation. Thus, the user can book the reservation after providing the justification. The justification can be formal, e.g., the company would have to consider the user justification before approving the reservation.

In some embodiments, the annotations in the displayed search results 623 can include an annotation 623B, such as a category of the search results. For example, a search result can be categorized as being forbidden, or unbookable or not allowed. The user can view, e.g., knowing that there is a search result, the search result, but cannot book or select the not-allowed search result. The not-allowed summary can be followed by an explanation, such as the reservation is too expensive, the reservation is not appropriate, e.g., a first class flight reservation for a regular employee, the reservation is supplied by an airline having poor safety record, or by a supplier having untrustworthy reputation. The not-allowed summary can be followed by a feedback and justification from the user, such as the reservation, though expensive, can provide the best flight schedule, or that the reservation, though through a poor safety airline, can be best suited to the user and the user is willing to take the chance. The not-allowed category can have sub-classes.

A search result can be categorized as being warned by the company. The user can select the warned search results, but is required to supply a justification to the company. The warned summary can be followed by an explanation, such as the reservation is having a long delay, the price of the reservation is above average, the reservation is more expensive than average flights, or the reservation is not appropriate, e.g., a business class flight reservation for a regular employee.

The warning can have multiple sub-classes, such as a high warning level and a low warning level. In the high warning level, the user would need to wait for explicit approval from the company after the justification received and reviewed. In the low warning level, the user can be automatically approved after sending the justification. The warned summary can be followed by a feedback and justification from the user, such as the reservation, though having long delay, is acceptable by the user, or that the reservation, though having higher cost than average, can provide long legroom for the user who is also taller than average, or that the reservation, though being a business class and generally not allowable for a regular employee, can be particular suited for the current situation in which this is a red-eye flight and the user needs the extra comfort to be ready in the morning.

A search result can be categorized as being approved by the company. The user can select the approved search results, and can be automatically approved. The approved summary can be followed by an explanation, such as the reservation is from a preferred supplier, the reservation is the best selection from the company point of view, the reservation is from a supplier having a prior agreement with the company, the reservation is having a best price from the company point of view, or the reservation is within the policy.

The approval can have multiple sub-classes, such as a recommending level and an allowable level. The recommending level is more preferred by the company, as compared to the allowable level, but there can be no difference in the booking process from the user point of view.

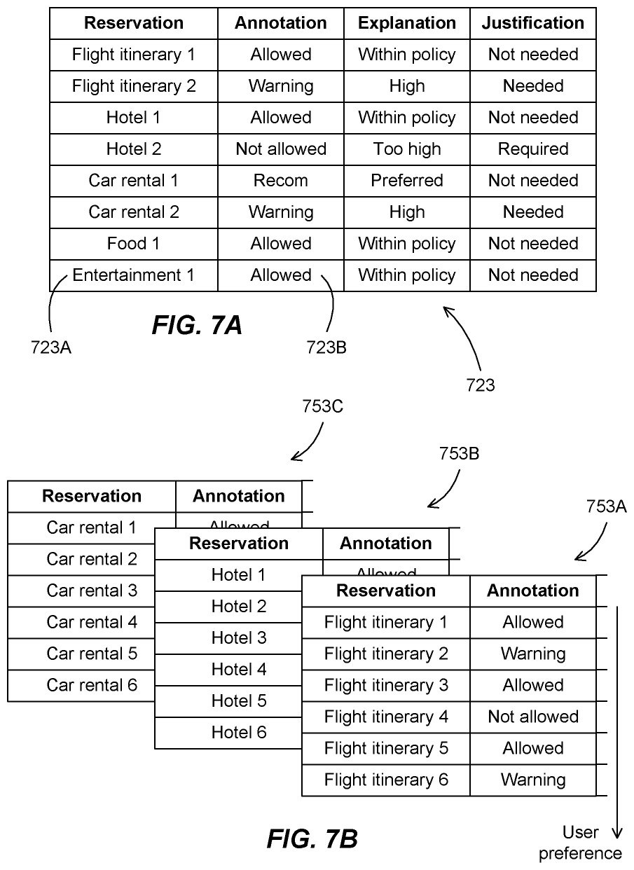

FIGS. 7A-7B illustrate configurations of displayed search results according to some embodiments. In FIG. 7A, a display 723 can include reservations for flight reservations 723A, car rental reservations, and hotel reservations. The display can include annotation 723B for the reservations 723A. Thus, a user can select a flight reservation, a car rental reservation, and a hotel reservation from the display of annotated search results.

In FIG. 7B, there can be multiple displays, such as a display 753A for flight reservations, a display 753B for car rental reservations, and a display 753C for hotel reservations. The user can select a flight reservation. After completing the flight reservation, the user can then select a car rental reservation and a hotel reservation. The display can be arranged in order of the user preferences.

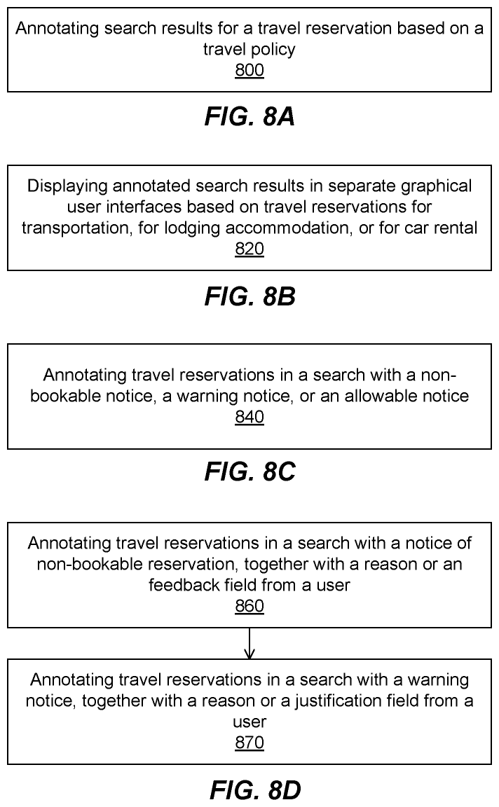

FIGS. 8A-8D illustrate flow charts for search result displays according to some embodiments. In FIG. 8A, operation 800 annotates search results for a travel reservation based on a travel policy. The annotations can include a classification of the search results, such as not allowable, warned, or approved. The annotations can include a communication from the company or a communication from the user.

In FIG. 8B, operation 820 displays annotated search results in separate graphical user interfaces based on travel reservations for transportation, for lodging accommodation, or for car rental. The user can select a flight reservation, and perform the booking of the selected flight reservation. Afterward, the user can select a car rental reservation, followed by a selection of a hotel reservation. Other reservations can be selected, such as food reservation and entertainment reservation.

In FIG. 8C, operation 840 annotates travel reservations in a search with a non-bookable notice, a warning notice, or an allowable notice. The annotation can be derived from the travel policy, e.g., interpreting the travel policy with regard to the individual search results.

In FIG. 8D, operation 860 annotates travel reservations in a search with a notice of non-bookable reservation, together with a reason or a feedback field from a user. Operation 870 annotates travel reservations in a search with a warning notice, together with a reason or a justification field from a user.

In some embodiments, the travel policy can be configured to observe market conditions, instead or in addition to provide fixed values for the travel expenses. For example, an air fare can be considered as too high as compared to an average value offered by the market, and not as compared to a fixed value. The determination of travel expenses based on market conditions can allow the user to book comfortable flights under various scenarios, such as a low fare flight in discounted market, an average fare flight in normal market, and a high fare flight in an emergency or high demand market.

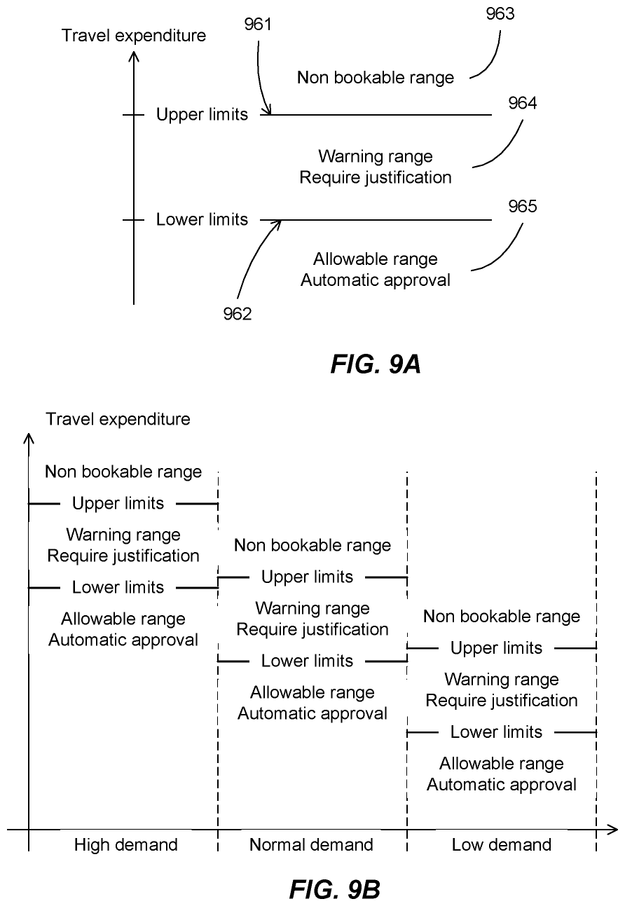

FIGS. 9A-9B illustrate configurations of travel expenditures based on market conditions according to some embodiments. In FIG. 9A, the travel expenditure can be based on a fixed scale. The travel expenses can be divided into multiple ranges, such as an upper range 963, a middle range 964 and a lower range 965 of expenses. An upper limit value 961 is used to separate the upper range and the middle range. A lower limit value 962 is used to separate the upper range and the middle range.

In the lower range of expenses, the reservations are automatically approved, since the expenses are within an average range of expenses. The lower range can be considered as the allowable range. In the middle range of expenses, the reservations are approvable, but requiring justification, since the expenses are above the average range. The middle range can be considered as the warning range. In the upper range of expenses, the reservations are not allowed, since the expenses are way above the average range. The upper range can be considered as the non-allowable range or the non-bookable range.

The ranges can be further divided into sub ranges. For example, the middle range or the warning can be divided into upper middle range, e.g., high warning range, and lower middle range, e.g., low warning range. In the high warning range, explicit approval from the company is required. The user first needs to submit a justification to justify the selection of a travel reservation having expenses in the high warning range. The justification is received and reviewed by the company. If the justification is accepted, the reservation is approved and the user can book the reservation. Otherwise, the reservation is rejected.

In the low warning range, automatic approval from the company is provided. The user first still needs to submit a justification, but can book the reservation after submitting the justification.

In FIG. 9B, the travel expenditure can be based on a market condition scale. For example, in normal market condition, the upper and lower limits can be averaged from the market data. In high demand market, the upper and lower limits can be higher than normal, which can be determined from the market condition. In low demand market, the upper and lower limits can be lower than normal, e.g., can be determined from the market condition.

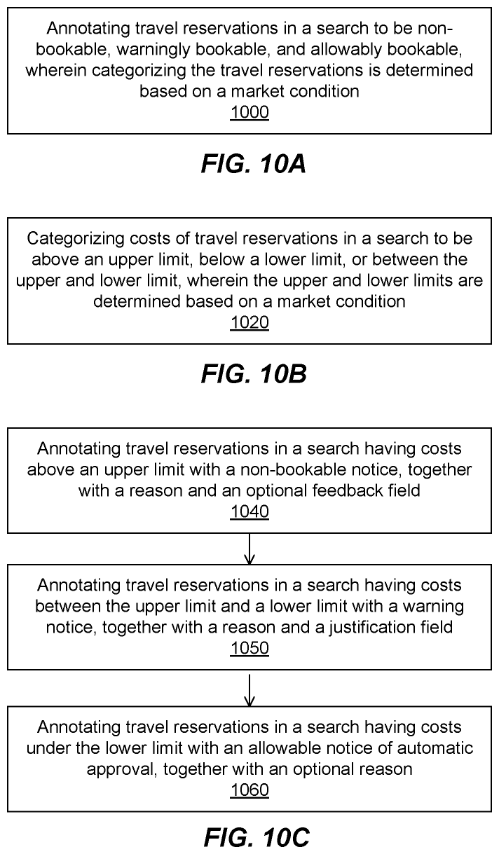

FIGS. 10A-10C illustrate flow charts for search result displays according to some embodiments. In FIG. 10A, operation 1000 annotates travel reservations in a search to be non-bookable, warningly bookable, and allowably bookable, wherein categorizing the travel reservations is determined based on a market condition.

In FIG. 10B, operation 1020 categorizes costs of travel reservations in a search to be above an upper limit, below a lower limit, or between the upper and lower limit, with the upper and lower limits determined based on a market condition.

In FIG. 10C, operation 1040 annotates travel reservations in a search having costs above an upper limit with a non-bookable notice, together with a reason and an optional feedback field. Operation 1050 annotates travel reservations in a search having costs between the upper limit and a lower limit with a warning notice, together with a reason and a justification field. Operation 1060 annotates travel reservations in a search having costs under the lower limit with an allowable notice of automatic approval, together with an optional reason.

In some embodiments, the selections of the user, together with an analysis of the user actions, including past history and data trend, can be reported to the company, for example, to provide the company with the compliance of the users with the travel policy. The report can allow the company to modify the travel policy to improve the user satisfaction and also to improve a cost effectiveness of the travel policy.

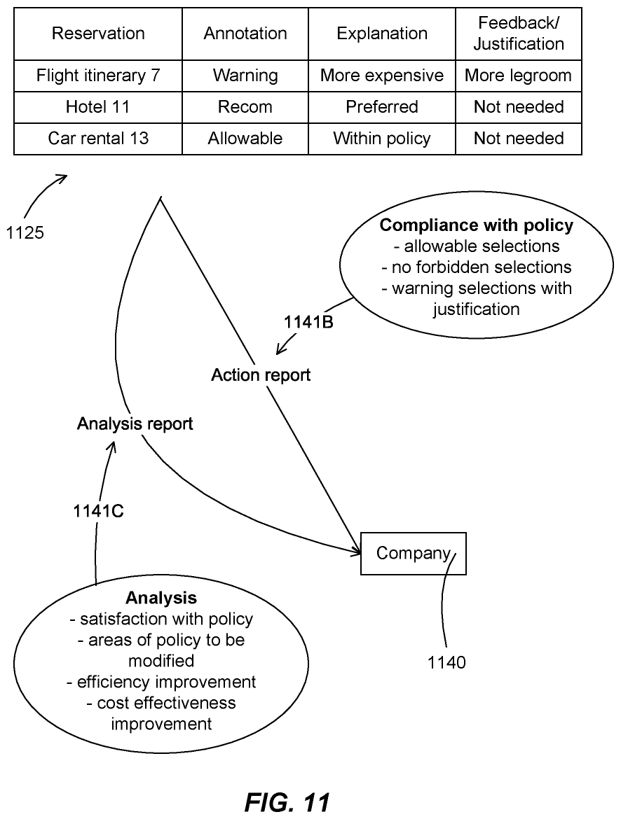

FIG. 11 illustrates a process for reporting user actions according to some embodiments. From selections 1125 of the user on the search results for the travel reservations, the platform can provide an action report 1141B to the company 1140. The action report can include the compliance of the user with the travel policy, including the allowable selections and the warning selections with justification. The platform can process and provide an analysis report 1141C to the company. The analysis report can include the satisfaction of the user with policy, the areas of policy to be modified, the efficiency improvement, and the cost effectiveness improvement.

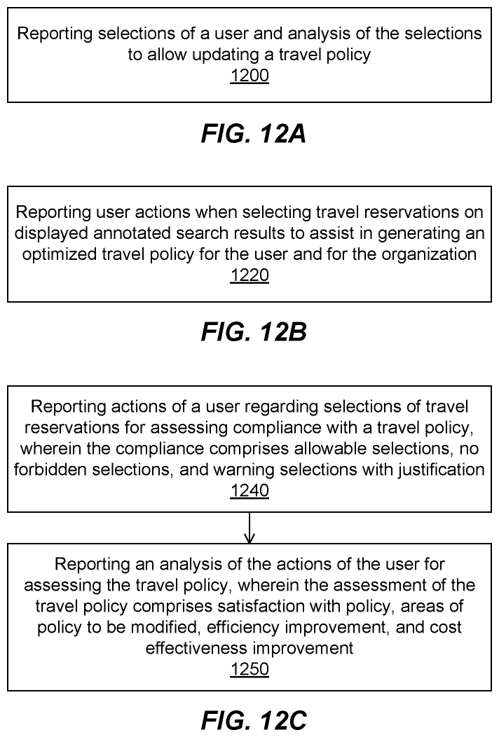

FIGS. 12A-12C illustrate flow charts for reporting user actions according to some embodiments. In FIG. 12A, operation 1200 reports selections of a user and analysis of the selections to allow updating a travel policy. In FIG. 12B, operation 1220 reports user actions when selecting travel reservations on displayed annotated search results to assist in generating an optimized travel policy for the user and for the organization.

In FIG. 12C, operation 1240 reports actions of a user regarding selections of travel reservations for assessing compliance with a travel policy. The compliance can include allowable selections, no forbidden selections, and warning selections with justification. Operation 1250 reports an analysis of the actions of the user for assessing the travel policy. The assessment of the travel policy can include satisfaction with policy, areas of policy to be modified, efficiency improvement, and cost effectiveness improvement

In some embodiments, the company can modify the travel policy based on the reports of user actions and the reports on the analysis of the user actions. The modification can be designed to improve the satisfaction of the user, together with lowering travel expenses and higher control on the user travel.

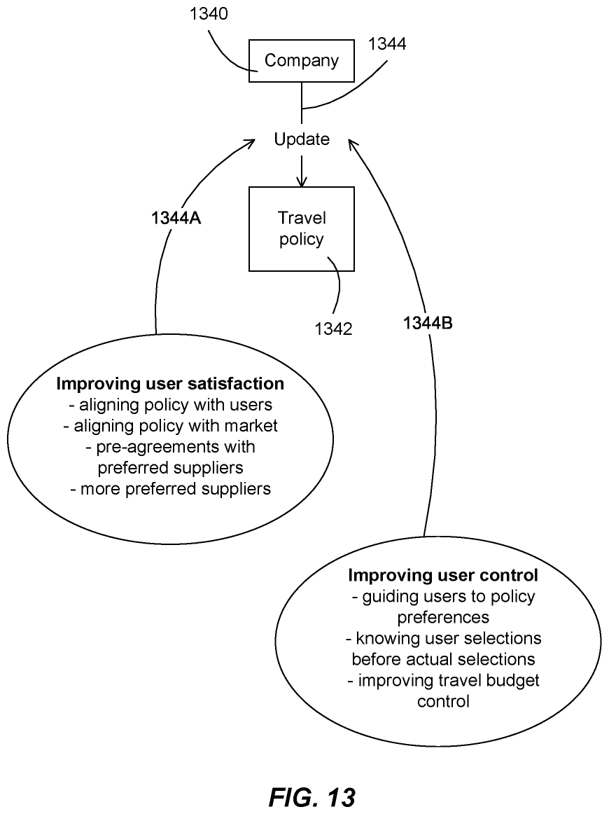

FIG. 13 illustrates a process for updating a travel policy according to some embodiments. A company 1340 can updates 1344 the travel policy 1342, for example, based on the reports from the platform. The travel policy update 1344A can include modifications to improve user satisfaction, such as to align the travel policy with the users, to align the travel policy with the market, to make pre-agreements with preferred suppliers, and to have more preferred suppliers. The travel policy update 1344B can include modifications to improve user control and lower travel cost, such as to guide users to the preferences of the travel policy, to know the user selections before the actual selections, and to improve the travel budget control.

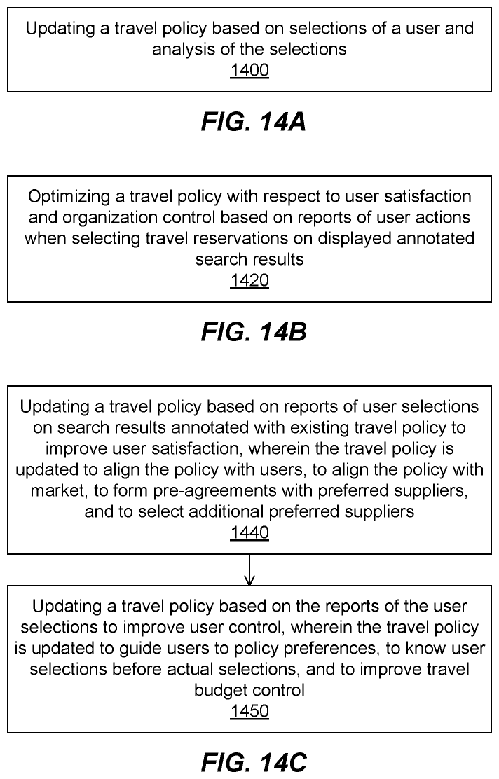

FIGS. 14A-14C illustrate flow charts for updating a travel policy according to some embodiments. In FIG. 14A, operation 1400 updates a travel policy based on selections of a user and analysis of the selections. In FIG. 14B, operation 1420 optimizes a travel policy with respect to user satisfaction and organization control based on reports of user actions when selecting travel reservations on displayed annotated search results.

In FIG. 14C, operation 1440 updates a travel policy based on reports of user selections on search results annotated with existing travel policy to improve user satisfaction, with the travel policy updated to align the policy with users, to align the policy with market, to form pre-agreements with preferred suppliers, and to select additional preferred suppliers. Operation 1450 updates a travel policy based on the reports of the user selections to improve user control, with the travel policy updated to guide users to policy preferences, to know user selections before actual selections, and to improve travel budget control.

In some embodiments, the present invention discloses a computer program having machine-readable instructions to cause a processing device to implement any one of the methods described above. The present invention also discloses a machine readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, or a nonvolatile electronic memory. The software program may be run on a variety of devices, including a processor or a processing device to perform any one of the methods described above.

In some embodiments, the methods can be realized in hardware, software, or a combination of hardware and software. The methods can include computer-implemented methods, using a computer or a data processing system to execute the methods, including executing operations by a hardware processor. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

In some embodiments, the present invention discloses a system having a non-transitory memory and one or more hardware processors coupled to the non-transitory memory and configured to read instructions from the non-transitory memory to cause the system to perform operations necessary to perform the methods described above.

The terms “computer program,” “software,” “application,” variants and/or combinations thereof, in the context of the present specification, mean any expression, in any language, code or notation, of a set of instructions intended to cause a system having an information processing capability to perform a particular function directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

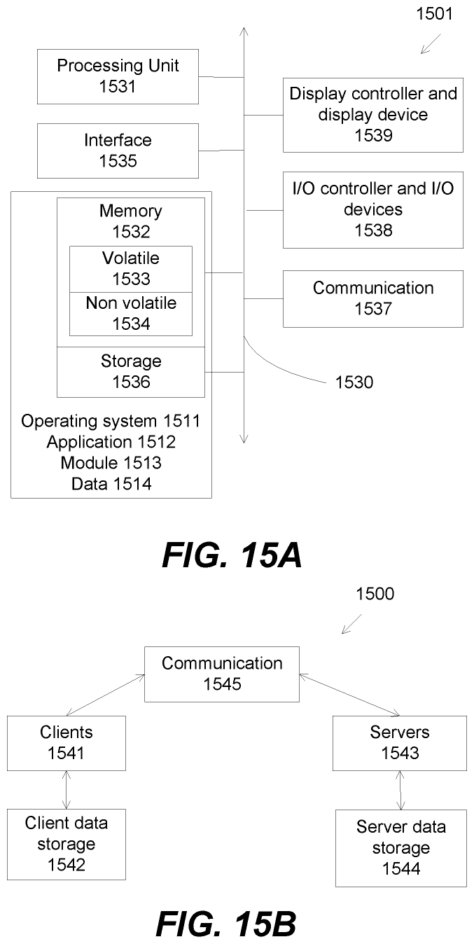

FIGS. 15A-15B illustrate computing environments according to some embodiments. FIG. 15A shows a computing environment. An exemplary environment for implementing various aspects of the invention includes a computer system 1501, comprising a processing unit 1531, a system memory 1532, and a system bus 1530. The processing unit 1531 can be any of various available processors, such as single microprocessor, dual microprocessors, or other multiprocessor architectures. The system bus 1530 can be any type of bus structures or architectures. The system memory 1532 can include volatile memory 1533 and nonvolatile memory 1534.

Computer system 1501 also includes storage media 1536, including removable storage media or nonremovable storage media, and volatile or nonvolatile disk storage. A removable or non-removable interface 1535 can be used to facilitate connection. These storage devices can be considered as part of the I/O device 1538 or at least they can be connected via the bus 1530. Storage devices that are “on board” generally include EEPROM used to store the BIOS.

The computer system 1501 further can include software to operate in the environment, such as an operating system 1511, system applications 1512, program modules 1513 and program data 1514, which are stored either in system memory 1532 or on storage media 1536. Various operating systems or combinations of operating systems can be used.

Input devices can be used to enter commands or data, and can include a pointing device such as a mouse, stylus, touch pad, and other devices such as keyboard, microphone, connected through I/O devices 1538. I/O devices 1538 can include connection ports, such as serial ports, parallel ports, or universal serial buses (USB). The interface ports 1538 can also accommodate output devices. For example, a USB port may be used to provide input to computer 1501 and to output information from computer system 1501 to an output device. Output adapter 1539, such as video or sound cards, is provided to connect to some output devices such as monitors, speakers, and printers.

Computer system 1501 can operate in a networked environment with remote computers. The remote computers, including a memory storage device, can be a data processing system, such as a personal computer, or a workstation, and typically includes many or all of the elements described relative to computer system 1501. Remote computers can be connected to computer system 1501 through a network interface 1535 and communication connection 1537, with wire or wireless connections. Network interface 1535 can be communication networks such as local-area networks (LAN), wide area networks (WAN) or wireless connection networks.

FIG. 15B shows a schematic block diagram of a sample computing environment with which the present invention can interact. The system 1500 includes a plurality of client systems 1541. The system 1500 also includes a plurality of servers 1543. The servers 1543 can be used to employ the present invention. The system 1500 includes a communication network 1545 to facilitate communications between the clients 1541 and the servers 1543. Client data storage 1542, connected to client system 1541, can store information locally. Similarly, the server 1543 can include server data storages 1544.

Profile with User Satisfaction Indications

In some embodiments, action data from the customers can assist in determining satisfactions of the customers with regard to the restrictions of the travel policy. Determining a compliance with the travel policy can be determined from booking actions of the customers. For example, if a customer books a travel schedule, which can be a flight itinerary, a hotel accommodation, or a car rental reservation, which is within an expense allowance range of the policy, the customer has complied with the travel policy. If the customer books a travel schedule that is within an expense warning range of the policy with an acceptable justification, the customer has complied with the travel policy. If the customer books a travel schedule that is within an expense warning range of the policy without an acceptable justification, or within an expense non-allowable range without a company approved, the customer has complied with the travel policy.

Determining a satisfaction of the customer can also be determined from the actions of the customers in selecting a travel schedule or elements of the travel schedule for booking. For example, if the customer performs searches and spends time looking at travel schedules that are within an expense allowance range of the policy, the customer has shown indications of happiness and satisfaction with the restrictions of the travel policy. If the customer performs searches and spends time looking at travel schedules that are in an expense warning or non-allowable range of the policy, the customer has shown indications of being not satisfied with the restrictions of the travel policy. If the customer provides multiple justifications or requests for restricted travel schedules, or feedbacks on the restrictions of the policy, these actions can be indications of non-satisfaction.

The customer actions can be collected through a display of the travel schedules resulted from a travel search based on inputs from the customers. The actions of the customers can include selecting different travel schedules or different elements of the travel schedules, such as cost element, departure element, convenient element, or comfort element.

Thus, by collecting actions of the customers in selecting travel schedules, indications for the customer satisfaction can be generated. An artificial intelligent algorithm can be used to generate the satisfaction indications based on patterns and trends provided by the customer actions.

In some embodiments, products and services, such as travel schedules, are provided to customers by a platform, e.g., a system running on a server. The platform can be run by the company, which is configured to provide a travel policy to its employees. The platform can be run by the third party, such as an independent company configured to provide travel services to the employees of the company, together with providing suggestions to the company to optimize the travel policy.

The products and services can display the search results of an inputted inquiry of a customer, e.g., multiple products or services meeting the input criterion, into different configurations and presentations, together with allowing the customers to re-arrange and to filter the products or services. The arrangeable and filterable display of the products or services can allow the customers to select the optimum product or service, e.g., the product or service most suitable to the customers need.

For example, the customer can arrange the search products according to price or brands, or the customer can identify certain features of the products in order to emphasize or remove selected products. The switching between different configurations and presentations can be performed using saved search results, without the need for updating for every single change. In addition, after a certain period, the search results can be automatically updated, allowing the customer to have access to the latest product information.

Communication information of the customer during the product selection session, together with actions of the customers during the product selection can be saved in a user profile, which can be a profile used to characterize the behavior, satisfaction, or preference of the user with regard to the product selections. The profile can include indications of user behavior, satisfaction, or preference determined from the communication information and the actions. The actions of the customers can include price selections, brand selections, or the selections of other features of the products. Indications of the customer thinking, such as behavior, preference, or satisfaction, can be derived from the actions, such as low price selections or a deselection of luxury brands can indicate a customer frugality, while a disregard for prices can indicate a customer high comfort value. In addition, satisfaction of the user toward the travel policy can be derived from the user actions, such as consistently selecting travel schedules within restrictions of the travel policy can indicate a high satisfaction with the travel policy, since the restrictions do not prevent the user from selecting preferred travel schedules. Alternatively, multiple feedbacks of the user regarding the restrictions can indicate a low satisfaction, since the restrictions have significantly interfered with the selections of the user.

The communication information can include the device used by the customer, the Internet Protocol (IP) addresses, the login time and location, together with the mouse and keyboard usage of the customer. The access to the communication information used by the customer can provide indications of the customer behavior or state of mind, such as a long delay time before a selection can indicate a reluctance of the customer for high price products or for products restricted by the policy, a short delay time can indicate a sure thinking, e.g., a strong preference for a product regardless of the policy restrictions, multiple login times during after business hour can indicate a customer having a normal working schedule, or consistent IP addresses and login locations can indicate a less traveled customer.

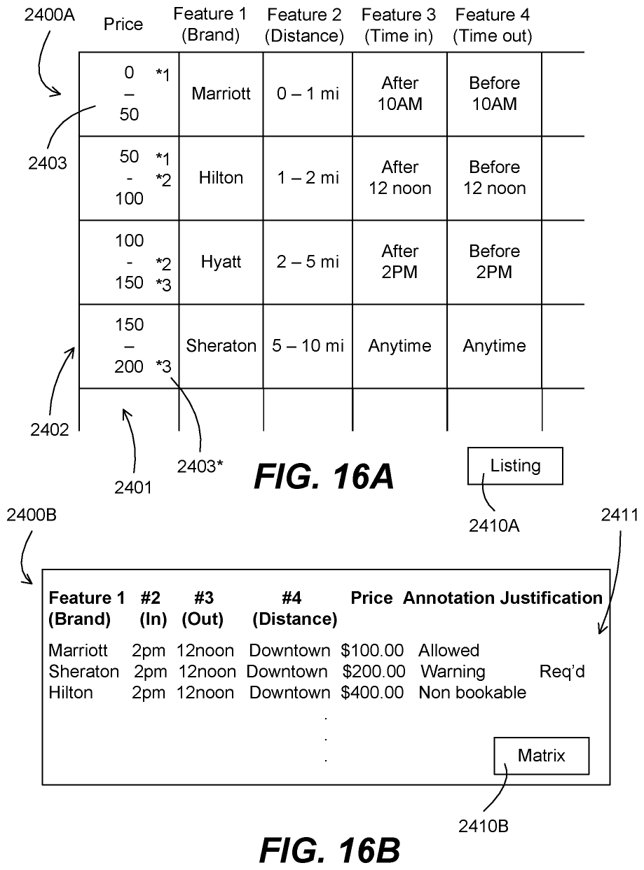

FIGS. 16A-16B illustrate display configurations for the search results of a hotel according to some embodiments. In FIG. 16A, the results of a search for a hotel, which include multiple accommodation places, can be displayed in a matrix format 2400A. Different categories or features of the search results can be shown in columns 2401, such as a price column, a brand column for showing the brand name of the hotels, a distance column for showing the distance between the hotel and a downtown location, a check in time column for showing the check in time of the hotel, a check out time for showing the checkout time of the hotel. Other categories can also be shown, such as the availability of amenities such as parking, Wi-Fi, breakfast, bar or lounge, fitness center. In the figure, the features are included for illustration purpose, and not a complete set of categories for hotel features and amenities.

The matrix 2400A can include rows 2402, which can show different data for different features, e.g., columns 2401 of the matrix. For example, row 1 of the column price, e.g., element 2403 of matrix 2400A, which is the intersecting element of column 1 and row 1, shows the price range of 0-50, row 2 of the column price shows the price range of 50-100, etc. Similarly, row 1 of the hotel name shows the name of a hotel, such as Marriott, row 2 of the hotel name shows the hotel name of Hilton, etc.

Elements of the matrix 2400A can have annotations, indicating allowable (optional), warning, or non-bookable. For example, element 2403 can have annotations 2403*, showing the restrictions of the travel policy. Since there can be multiple hotel selections for a single matrix element, an element can have more than one annotations.

As specific examples, the element of 0-50 price range can have an annotation of allowable, which is shown as *1 annotation. Since the 0-50 element only has the allowable annotation, all hotels having the price range of 0-50 are allowable by the travel policy. The allowable annotation can be optional, meaning the selection is allowable with or without the allowable annotation.

The element of 50-100 price range can have annotations of allowable and warning, which is shown as *1 and *2 annotations, respectively. With two annotations, some hotels having the price range of 50-100 are allowable by the travel policy, while some other hotels are warned by the travel policy, e.g., requiring justification.

The element of 100-150 price range can have annotations of warning and non-bookable, which is shown as *2 and *3 annotations, respectively. With two annotations, some hotels having the price range of 100-150 are warned by the travel policy, while some other hotels are restricted from booking by the travel policy, e.g., requiring approval from the company.

The element of 150-200 price range can have annotations of allowable, warning, and non-bookable, which is shown as *1, *2, and *3 annotations, respectively. With three annotations, some hotels having the price range of 150-200 are allowable by the travel policy, while some hotels are warned by the travel policy, and some other hotels are restricted from booking by the travel policy.

As shown, only matrix elements in the column 2401 of price are annotated. Alternatively, other matrix elements can also have annotations.

The results of a search for a hotel can be displayed in different formats, such as three dimensional matrices, or in a tile configuration. There can be a switch button 2410A, which can be used for switching from the 2D matrix format 2400A to another format, such as to the listing format 2400B.

In FIG. 16B, the results of a search for a hotel can be displayed in a listing format 2400B. In the listing format, multiple hotels 2411 can be shown, with each hotel listing shown elements or features of the hotel. For example, feature 1 can be the brand of the hotel, such as Marriott, Sheraton, or Hilton. Feature 2 can show the check in time of the hotel, such as after 2 pm. Feature 3 can show the checkout time of the hotel, such as before noon. Feature 4 can show the distance of the hotel to a specific location, such as to a downtown center of the city. There are other features, such as prices.

The listing format can also show annotations for the hotel listings, such as for allowable hotels, e.g., hotels approved by the travel policy. The allowable annotations can also show recommend hotels, e.g., hotels that the policy recommends, for example, since the company has a prior arrangement. The allowable annotations can be optional, e.g., without any annotations, the listings are considered as allowable.

The annotations can be warning annotations or non-bookable annotations. The warning annotations show hotels that are borderline allowable, such as slightly out of the approved range of the company policy, for example, due to high prices, low safety records, or not in line with the values of the company. For hotels annotated with the warning annotations, justifications can be required for approval. The listing format can show a justification field, such as a text field for accepting a text to justify the booking of the warning hotels. Alternatively, the justification field can include a justification icon for each of the warning hotels. The user can slick on the icon, and a communication area can be generated. The communication area can be an enlarged area of the listing format, or can be a pop up area. The communication area can be a text area configured to accept a justification text from the user. The communication area can be a chat area configured for a two way communication between the user and an artificial intelligent chatbot. The user can send a justification text in the chat area. The chatbot can respond instantaneously, such as to approve, reject, or to refer the case to a higher authority. The response of the chatbot can be based on the compliant history of the user, together with the level of deviation from the allowable range of the hotel listing. The AI-based chatbot can also have a machine learning algorithm, to provide appropriate answers based on an on-going change of the user compliance and the company policy.

The communication area can be a two way communication between the user and a representative of the company. For example, the chatbot can refer the user to the company representative to have a final say on the user request.

The non-bookable annotations show hotels that are significantly out of the approved range of the company policy. For hotels annotated with the non-bookable annotations, requests for approval, e.g., stronger justifications, can be required. The listing format can show a request field, which can be similar to the justification field, e.g., a text field or an icon leading to a text field, a chatbot, or a company representative. The request field can also be configured as a two way communication with a company representative, which can take longer time to get an answer as compared to the justification field.

The listing format can also show feedbacks for the hotel listings, which can be inputs from the users with regard to the annotations. For example, a user can provide feedback on a warning hotel, presenting arguments to show that the hotel should be in an allowable range instead of in a warning range.

There can be other listing formats, which are discussed in later sections. There can be a switch button 2410B, which can be used for switching from the listing format 2400B to another format, such as to the matrix format 2400A.

Displays for other products or services can be used, such as for car rental, flight travel plan, or other products or services.

The actions of the users when using the display to select hotel accommodations can be stored in the user profiles, optionally with indications of the user thinking, e.g., behavior, preference, or satisfaction with the travel policy, which can be generated from the user actions, for example, by an AI algorithm. The profiles can include communication information of the user, with the communication information, actions and behavior indications obtained or generated from interactions of the user with a display of products.

In some embodiments, the display can be used for travel agency services, after receiving a travel plan as an input. The travel plan can include the date and places of traveling. For example, a customer can specify a departure and an arrival airport. Alternatively, the customer can specify a departure city and an arrival city, and the travel agency services can look up the nearby airports. In some embodiments, multiple airports can be used as input for the travel plan. For example, a customer can specify JFK airport or New York City as an arrival destination. The travel agency services can also include La Guardia airport and Newark airport, in addition to JFK airport, as the destination airport.

The travel agency services can perform a search for flight itineraries on the input date connecting the departure and arrival locations. The search results can be displayed in a multiple dimensional output such as a matrix. For example, one dimension of the multiple dimensional outputs, such as the columns of the matrix of the search results, can show different categories of the flight itineraries resulted from the search. The first column can show a first category, the second column can show the second category, until the last column showing the last category of the matrix. The categories can include price, departure time, date and airport, arrival time, date, and airport, travel time, layover time, number of flight segment, airlines, and other information such as early boarding, preferred seating, airline lounge access, lie-flat seats, Wi-Fi on international services, and new aircraft with more leg room.

Another dimension of the multiple dimensional outputs, such as the rows of the matrix of the search results, can show different data for the categories, such as different ranges or different values. Different elements, e.g., different rows, in a column of the matrix can show different data of the category representing in the column. For example, in the category of “price”, different price ranges, such as 100-200, 200-300, etc., can be listed in different rows. In the airline category, different airline names, such as American Airlines, United, etc., can be listed in different rows.

Different display outputs can be used, such as a matrix having rows as categories and columns as data of the categories. The matrix can be two dimensional, with the columns of the matrix showing the categories of the matrix, and the rows of the matrix showing the data of the categories.

Folded or wrapped matrix can be used, such as the categories can occupy two (or more) rows. The category can be split into two category lists. The odd row (first row, third row, etc.) can correspond to the first category list, and the even row (second row, fourth row, etc.) can correspond to the second category list. For example, a wrapped matrix with 2 adjacent rows can be used for a row dimension, e.g., x direction. The first row can include price, departure date and time, arrival date and time, flight time, travel time, layover time, and airlines. The second row can include other information, such as the availability of early boarding, preferred seating, airline lounge access, lie-flat seats, Wi-Fi on international services, and leg room dimension. Thus the odd rows of the matrix, e.g., row 3, row 5, etc., can include data for the first row, such as price range, departure time range, etc. The even rows of the matrix, e.g., row 4, row 6, etc., can include data for the second row, such as yes for early boarding, no for preferred seating, etc.

In some embodiments, matrix configurations with more than 2 dimensions can be used, such as three dimensional matrices, with the third dimension representing additional information from the search results.

Other display output formats can be used, such as a tile and bucket format. The search results can be displayed in multiple tiles, which can be configured in a two dimensional configuration, with each data in a bucket. The tile configuration can be similar to a matrix, with each bucket corresponds to an element of the matrix.

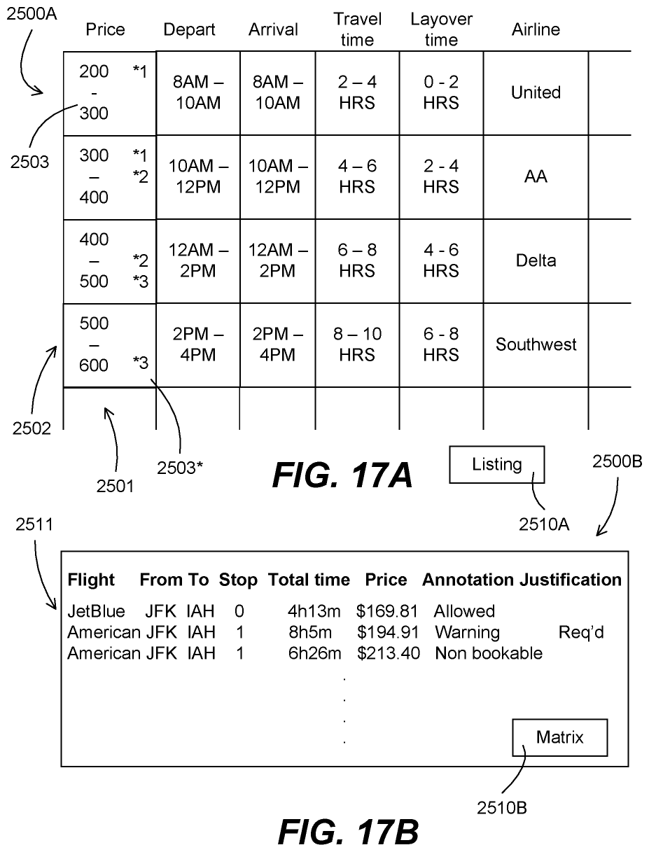

FIGS. 17A-17B illustrate display configurations for the search results of a travel plan according to some embodiments. In FIG. 17A, the results of a search for a travel plan, which include multiple flight itineraries, can be displayed in a matrix format 2500A. Different categories of the search results can be shown in columns 2501, such as a price column, a departure column for showing the time of departure, or optionally a date or a range of dates of departure, an arrival column for showing the time of arrival, or optionally a date or a range of dates of arrival, a travel time column for showing the total travel time, a layover time for showing the waiting time between flight segments, an airline column for showing the name of the airlines operating the flight itineraries. Other categories can also be shown, such as the availability of flight amenities such as early boarding, preferred seating, airline lounge access, lie-flat seats, Wi-Fi on international services, and new aircraft with more leg room. In the figure, the categories are included for illustration purpose, and not a complete set of categories for flight itineraries. For example, the departure column can include the date of travel (including a range of the possible travel dates) and the departure airport, in addition to the time of travel. The travel time can be the flight time instead of the total travel time, e.g., the total travel time can be calculated by adding the flight time and the layover time. Additional columns representing additional categories can be included, such as departure and arrival airports.

The matrix 2500A can include rows 2502, which can show different data for different categories, e.g., columns 2501 of the matrix. For example, row 1 of the column price, e.g., element 2503 of matrix 2500A, which is the intersecting element of column 1 and row 1, shows the price range of 200-300, row 2 of the column price shows the price range of 300-400, etc. Similarly, row 1 of the column departure shows the time range of 8 am-10 am, row 2 of the column departure shows the time range of 10 am-12 am, etc. Alternatively, the departure column can show ranges of the dates, such as row 1 showing March 1st to March 2nd, row 2 showing March 3rd to March 4th, etc. Generally, the customer has decided on the date of travel, and thus the time ranges of that date can be shown, so that the customer can select the most suitable or desirable times. In some cases, there is no need for a precise travel date, and thus the customer can look for different flight itineraries for a range of dates, for example, to choose the best possible flight itineraries. Row 1 of the column airline show the airline United, row 2 of the column airline show the airline American Airlines, etc.

Elements of the matrix 2500A can have annotations, indicating allowable (optional), warning, or non-bookable, similar to those mentioned above with respect to a matrix format for hotel accommodations. For example, element 2503 can have annotations 2503*, showing the restrictions of the travel policy. Since there can be multiple travel schedule selections for a single matrix element, an element can have more than one annotations.

As shown, only matrix elements in the column 2501 of price are annotated. Alternatively, other matrix elements can also have annotations.

The results of a search for a travel plan can be displayed in different formats, such as three dimensional matrices, e.g., the third dimension can be underneath or on top of the displayed 2d matrix. The third dimension matrices can be accessed, for example, by peeling away the top matrices. For example, the customer can slide the displayed matrix away to expose the under layer matrix. The results of a search for a travel plan can be displayed in a tile configuration, which can be similar to the matrix configuration. Information can be displayed in buckets of the tile configuration, with the buckets similar to the elements of the matrix.

There can be a switch button 2510A, which can be used for switching from the 2D matrix format 2500A to another format, such as to the itinerary format 2500B.

In FIG. 17B, the results of a search for a travel plan can be displayed in a flight itinerary format 2500B. In the flight itinerary format, multiple flight itineraries 2511 can be shown, with each flight itinerary shown elements of the flight itinerary.

The listing format can also show annotations, justifications, requests, or feedbacks for the flight itinerary listings, such as for allowable flight itineraries, e.g., flight itineraries approved by the travel policy, similar to those mentioned above with respect to a matrix format for hotel accommodations. The allowable annotations can also show recommend flights, e.g., flights that the policy recommends, for example, since the company has a prior arrangement. The allowable annotations can be optional, e.g., without any annotations, the listings are considered as allowable. The annotations can be warning annotations or non-bookable annotations. The listing format can show a justification field or icons, which can provide one way or two way communication using a chatbot or directly to a company representative, as discussed above with regard to hotels.

There can be other itinerary formats, which are discussed in later sections. There can be a switch button 2510B, which can be used for switching from the flight itinerary format 2500B to another format, such as to the matrix format 2500A.

In some embodiments, the display of the search results can be filtered to provide suitable flight itineraries according to a customer desire. For example, the flight matrix, e.g., the matrix containing information of the flight itineraries that are the results of the search for the travel plan, can be filtered, using a customer input, such as a saved customer preference or an interactive customer action, to remove elements of the flight matrix according to the customer input.

The customer input can be a positive input, e.g., a selection, or a desired or a selected characteristic of flight itineraries, and thus flight itineraries not meeting the positive customer input can be removed. The customer input can be a negative input, e.g., a deselection, or a non-desired or an unselected characteristic of flight itineraries, and thus flight itineraries meeting the negative customer input can be removed. The removal can be performed by taking out the flight itineraries, or by making the corresponding flight itineraries not selectable or not viewable, such as graying out these flights.

The customer input can be a cancel input, meaning the current input can cancel the earlier input. For example, a customer input can be a selection of United airlines. The flight matrix can be filtered to only show the flight itineraries of United airlines. A new input can be a cancellation of the previous selection of American airlines. The flight matrix can be filtered to show the flight itineraries of other airlines instead of just United airlines.

The customer input can be a supersede input, meaning the current input can replace the earlier input. For example, a customer input can be a selection of United airlines. The flight matrix can be filtered to only show the flight itineraries of United airlines. A new input can be a selection of American airlines. If the new input is a supersede input, the selection of American airlines can replace the earlier selection of United airlines. The flight matrix can be filtered to show the flight itineraries of American airlines.

The customer input can be an OR input, meaning the previously filtered flight matrix having flights having the previous input can be enlarged to include flights having the current input. Or the flight matrix can be filtered with the previous input or the current input, e.g., the flight matrix can be filtered to provide flights having the previous input or the current input. For example, a customer input can be a selection of United airlines. The flight matrix can be filtered to only show the flight itineraries of United airlines. A new input can be a selection of American airlines. If the new input is an OR input, the flight matrix can be filtered to show the flight itineraries of both United airlines and American airlines, e.g., the customer input is to show flights from either United airlines or American airlines.

The customer input can be an AND input, meaning the previously filtered flight matrix having flights having the previous input can be narrowed to include flights having both the previous input and the current input. For example, a customer input can be a selection of United airlines. The flight matrix can be filtered to only show the flight itineraries of United airlines. A new input can be a selection of layover time less than 2 hours. If the new input is an AND input, the flight matrix can be filtered to show the flight itineraries of United airlines having layover time less than 2 hours.

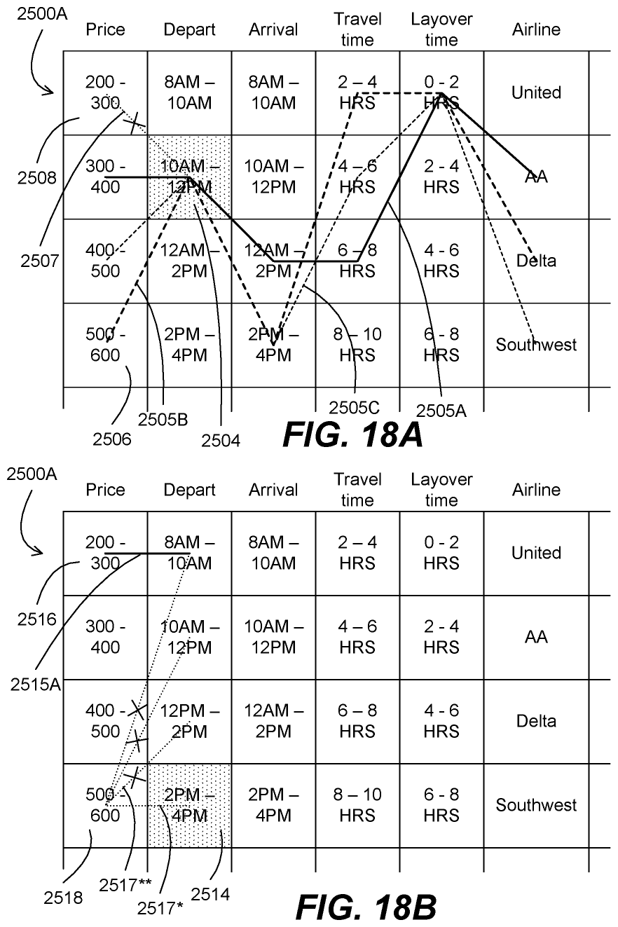

FIGS. 18A-18B illustrate positive selection, e.g., selection, and negative selection, e.g., deselection, processes for a flight matrix according to some embodiments. A flight matrix can be a presentation of the search results for a travel plan. In the flight matrix, categories of the flight itineraries and data of the categories can be included, which can allow a customer to view the possible flight itineraries in a visual display. The flight matrix can include a list, e.g., a two dimensional list, of the characteristics of the flight itineraries resulted from the search results of the inputted travel plan.

The number of flight itineraries can be high, e.g., can be a hundred or two of possible flights connecting two locations at the date specified. Thus a selection of suitable flights can be performed to provide the optimum flights for the customer.

The selection can be a positive selection, meaning selecting a characteristic of the flight itineraries to be included in the flight itineraries under consideration. The selection can be a negative selection, which is called deselection in this disclosure, meaning selecting a characteristic of the flight itineraries to be removed from consideration, e.g., a characteristic that the flight itineraries under consideration should not have. In addition, a subsequent selection can cancel or undo a previous selection, or can supersede the previous selection. The multiple selections can be OR selections, e.g., the selected flight itineraries can have the characteristics specified in either selections, or the selected flight itineraries need to satisfy only one selection characteristic. The multiple selections can be AND selections, e.g., each of the selected flight itineraries will have all characteristics specified by the multiple selections.

A positive selection, or simply a selection since the default for selection is a positive selection, can be performed on a flight matrix. An element of the matrix can be selected, for example, as an input from the customer. The selection can be marked as a positive selection, meaning the selection is for desired characteristics of the suitable flights. The marking can be automatic, e.g., inherited from a previous selection characteristic. The marking can be manual, e.g., the customer can choose from a menu, stating that the current selection is positive. Alternatively, after making the selection, a menu can pop up, asking for a choice of characteristics of the current selection, such as positive selection, negative selection, supersede selection, AND selection, or OR selection. For example, the selected element can include a choice for preferred airlines, such as Southwest airline.

After the positive selection, such as a choice for a preferred airline, such as Southwest airline, the flight matrix can be marked or updated based on the selected element, e.g., elements of the flight matrix can be marked as whether or not having a flight satisfying the selected matrix element. For example, an element of the flight matrix is marked as having a flight if there is at least a flight itinerary that also has information of the selected element, e.g., having information of both elements. As a specific example, if the selected element is Southwest airline, then an element of the flight matrix containing a departure time between 10 and 12 can be marked as having a flight if there is a Southwest flight departing between 10 and 12.

An element of the flight matrix can be marked as not having flight if there is no flight itinerary meeting information of both elements. As a specific example, if the selected element is Southwest airline, then an element of the flight matrix containing a departure time between 2 and 4 can be marked as not having a flight if there is no Southwest flight departing between 2 and 4.

In some embodiments, the marking of the matrix elements can be performed on the display matrix or on the saved search results of flight itineraries. Thus there is no updating of flight information, and the performance of the server can be instantaneous. Alternatively, the flight matrix can be updated after the selection.

FIG. 18A shows a positive selection 2504 on a flight matrix 2500A. The flight matrix 2500A can present a list of characteristics of possible flight itineraries, for example, the price ranges, the departure time, the arrival time, the travel time, the layover time, the airlines operating the flight, etc. A selection 2504 can be performed, which can be a positive selection. There can be a menu, not shown, listing the choices of selection, such as positive, negative, cancel, supersede, OR, and AND selections. For example, the menu can be shown next to the flight matrix, with the default choice for the selection highlighted. Alternatively, after selecting an element of the matrix, a menu can be popped-up, asking for the choice of selections.

The positive selection 2504 can select a departure time of between 10 and 12 in the morning. The flight itineraries that do not meet the selection, e.g., the flights that do not depart between 10 and 12, can be removed from the flight matrix, such as being removed from being further selected. The flight itineraries that meet the selection, e.g., the flights that depart between 10 and 12, can remain or can be highlighted, for example, for further selection.

For example, after the selection of element 10 AM-12 AM on departure category, elements 2508 can be grayed out, meaning there is no 200-300 flight 2507 departing between 10 and 12. The remaining elements 2506 can stay the same, meaning there is at least a 500-600 flight, such as flights 2505A, 2505B, or 2505C, departing between 10 and 12. Thus the flight matrix has been filtered, separating the flights meeting the selection characteristics and the flights not meeting the selection characteristics. Other formats can be used for the separation of flights meeting and not meeting the selections, such as highlighting the flights elements meeting selection characteristics (such as highlighting element 2506), and leaving alone the elements not meeting selection characteristics (such as not touching or not changing element 2508).

A negative selection, or a deselection, can be performed on a flight matrix. An element of the matrix can be deselected, for example, as an input from the customer. After the negative selection, e.g., a deselection of a matrix element, such as a selection of an airline that the customer prefers not to use, such as Southwest airline, the flight matrix can be marked or updated based on the deselected element, e.g., elements of the flight matrix can be marked as whether or not having a flight excluding the deselected matrix element. For example, an element of the flight matrix is marked as having a flight if there is a flight itinerary that does not contain the deselected element. As a specific example, if the deselected element is Southwest airline, then an element of the flight matrix containing a departure time between 10 and 12 can be marked as having a flight if there is a non-Southwest flight departing between 10 and 12.

An element of the flight matrix can be marked as not having flight if all flights meet the deselected element. As a specific example, if the deselected element is Southwest airline, then an element of the flight matrix containing a departure time between 2 and 4 can be marked as not having a flight if all flights departing between 2 and 4 are Southwest.

FIG. 18B shows a negative selection 2514, e.g., a deselection 2514, on a flight matrix 2500A. The deselection process, or the negative selection process, can include a selection together with a selected choice of negative selection. For example, after selecting an element of the matrix, there can be a menu listing the choices for the selection, such as positive, negative, cancel, supersede, OR, and AND selections.

In a negative selection process, the selected element can be considered as an undesired characteristic of suitable flight itineraries. Alternatively, the negative selected element can be considered as having lowest priority in the list of suitable flight itineraries. Thus when a negative selection is performed, all flight itineraries that contain the information in the negative element can be removed from the flight matrix.

In a flight matrix 2500A, the element 2514 of 2-4 departure time can be deselected, e.g., negative selection, or selected to be not a desired characteristic of suitable flight itineraries. The matrix can be filtered, e.g., other elements of the matrix can be marked as having flight or not having flight according to the selection 2514. For example, element 2516 of 200-300 price range can be marked as having flight, such as highlighting the element or remaining an unaffected element, if there is at least a flight 2515A at the price range of 200-300 that departs at a time different than the time range 2-4, such as departing at a time range 8-10. The element 2518 of 500-600 can be marked as not having flight, such as grayed out, if there is no flight 2517** having a price of 500-600 and departing at a time different than 2-4, such as there are no flights departing at 8-10 AM, no flights departing at 10-12 AM, no flights departing at 12-2 PM, with the only 500-600 flight 2517* departs at 2-4.

Subsequent selections can be positive or negative selections. Further, the subsequent selections can be a cancel or supersede selection, e.g., canceling or replacing the previous selections, AND selections, e.g., flights must satisfy both selections, and OR selections, e.g., flights that can satisfy either selections.

In a cancel selection, the customer can select the already-selected element again. The re-selection can toggle the selection to cancel the selection. Alternatively, the customer can select an element, and then select a cancellation choice. The selection of the already-selected element is canceled, and the elements of the flight matrix are returned to the previous states, e.g., in the states before the already-selected element is selected.

In a supersede selection, the customer can select an element and then choose the option of supersede. For example, the customer can select the already-selected element, and choose an option different than that of the already-selected element. As a specific example, the already-selected element can be a positive selection. The customer can select the element again, then choose the option of negative selection, which operates to supersede the previously selected positive selection. Alternatively, the customer can select a new element, and choose a choice of supersede, such as supersede positive or supersede negative.

The supersede selection is equivalent to a cancellation, plus a selection of the subsequent element, such as a positive or a negative selection of the second element. Thus, after a cancellation to return the matrix to its original state, the matrix can be re-sorted according to the new supersede selection.

For example, the selected first positive element can be Southwest airline. The customer can change his selection, e.g., using a subsequent selection to replace the previous positive selection, such as by selecting United Airlines as the second positive element with the identification of the second element being the superseded element. The elements of the flight matrix are then subjected to the positive selection of United airlines, e.g., the elements of the flight matrix can be marked as whether or not having a United flight.

Alternatively, the customer can change his selection, such as selecting American airlines as the second negative element as superseding the selected first positive element of Southwest airline. The elements of the flight matrix are then subjected to the negative selection of American airlines, e.g., the elements of the flight matrix can be marked as not being or being an American flight, as discussed above with regard to a negative selection or a deselection.

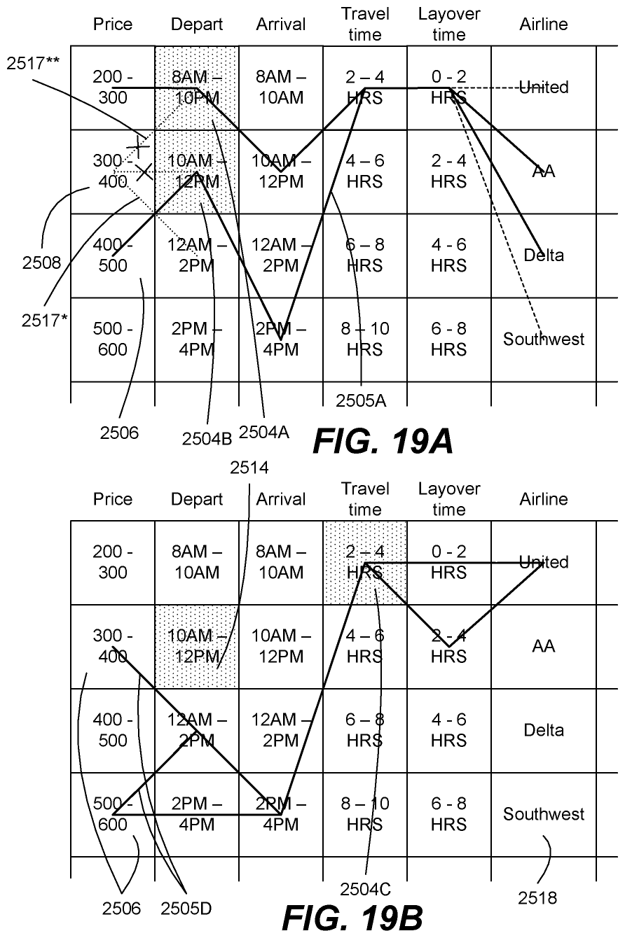

FIGS. 19A-19B illustrate OR and AND selection processes for a flight matrix according to some embodiments. A first selection, followed by another selection, such as a positive selection followed by another positive selection, can be performed on a flight matrix. The second selection can be an OR or an AND logical operation between the first and second selections.

As an example, after a first positive selection, e.g., after a selection of a first element with marking designated the selected first element as a positive selected element, the flight matrix can be marked or updated based on the selected positive first element, e.g., the elements of the flight matrix can be marked as whether or not having a flight satisfying the selected first positive element, as discussed above.

A second positive element can be selected. The selected second positive element can be automatically chosen or by manually chosen such as by a positive selection from a pop up menu as discussed above. For example, the selected second element can be marked as a cancellation element, a supersede element, or a combinable element (e.g., AND or OR) with the first positive selection.

If the selected second element is marked as a logical AND or OR, then elements of the flight matrix are marked as whether or not having a flight satisfying the selected first and second elements. For example, the first selection can be a positive selection of Southwest airline.

The second selection can be a positive selection of United airline, with a logical OR combination. An element of the flight matrix is marked as having a flight if there is either a Southwest or a United flight meeting the information of the matrix element. For example, an element of 10-12 departure time of the flight matrix is marked as having a flight if there is either a Southwest or a United flight that departs at 10-12. An element of the flight matrix, such as a 300-400 cost, is marked as not having a flight if there is no Southwest or United flight that costs 300-400.

Alternatively, the second selection can be a positive selection of 10-12 departure time, with a logical AND combination. An element of the flight matrix, such as a 0-2 hour layover time, is marked as having a flight if there is a Southwest flight departing at 10-12 having a layover time of less than 2 hours. An element of the flight matrix, such as a 300-400 cost, is marked as not having a flight if there is no Southwest flight departing at 10-12 that costs 300-400.

Alternatively, the second selection can be a negative selection of 10-12 departure time, with a logical AND combination. An element of the flight matrix, such as a 0-2 hour layover time, is marked as having a flight if there is a Southwest flight having a layover time of less than 2 hours that does not depart at 10-12. An element of the flight matrix, such as a 300-400 cost, is marked as not having a flight if there is no Southwest flight not departing at 10-12 that costs 300-400.

FIG. 19A shows an OR selection of two positive selections on the flight matrix. The element 2404A of 8-10 AM departure time can be first selected, and the matrix sorted according to the selection. Then an OR selection 2404B of 10-12 AM departure time can be performed. The matrix can be re-sorted according to the combination of the two selections. The selections can be OR, meaning flights meeting either selection can be selected and flights not meeting both selections can be removed. Thus new flights in the matrix can marked as having flights. For example, after the selection 2504A, element 200-300 is marked as having flights (no not marked if the non-marked elements are considered as having flights).

With the additional selection 2504B of 10-12 departure time, there can be flights with the price range of 400-500, and the element 2406 can be selected as containing flights meeting the selection characteristics. The element 2408 of 300-400 can be grayed out, e.g., marked as not having flight, since there are no flights departing at 8-10 and at 10-12 with the price range of 300-400. The flight having price range of 300-400, such as flight 2517*, departs at 12-2, thus not meeting the OR selection of 8-10 and 10-12.

Alternatively, the first selection can be a negative selection, with the second selection being a cancellation of the first negative selection, a supersede of the first negative selection, an AND or an OR logical operation between the first negative selection and the second selection.

After the first negative selection, e.g., after a deselection of a first element, the flight matrix can be marked or updated based on the selected first element, e.g., the elements of the flight matrix can be marked as whether or not having a flight satisfying the selected first negative element, as discussed above.

A second element can be selected. The selected second element can be automatically marked or manually marked. For example, the selected second element can be marked as a cancellation element, a supersede element, or a combinable element (e.g., AND or OR) with the first negative selection.

If the selected second element is marked as a logical AND or OR, then elements of the flight matrix are marked as whether or not having a flight satisfying the selected first and second elements. For example, the first selection can be a negative selection of Southwest airline. The second selection can be a positive selection of 10-12 departure time, with a logical AND combination. An element of the flight matrix, such as a 0-2 hour layover time, is marked as having a flight if there is a non-Southwest flight departing at 10-12 having a layover time of less than 2 hours. An element of the flight matrix, such as a 300-400 cost, is marked as not having a flight if there is no non-Southwest flight departing at 10-12 that costs 300-400.

Alternatively, the second selection can be a negative selection of 10-12 departure time, with a logical AND combination. An element of the flight matrix, such as a 0-2 hour layover time, is marked as having a flight if there is a non-Southwest flight having a layover time of less than 2 hours that does not depart at 10-12. An element of the flight matrix, such as a 300-400 cost, is marked as not having a flight if there is no non-Southwest flight not departing at 10-12 that costs 300-400.

FIG. 19B shows an AND selection of a negative selection and a positive selection on the flight matrix. The element 2414 can be first deselected, e.g., selected to be a negative selection, and the matrix sorted according to the selection. Then an AND selection 2404C can be performed. The matrix can be re-sorted according to the combination of the two selections. The selections can be AND, meaning, flights meeting both selections can be marked and flights not meeting at least one selection can be removed. Thus new flights in the matrix can marked as having flights.

For example, the first selection 2514 can be a negative selection of flights departing at 10-12. A subsequent positive selection 2504C of a total travel time of 0-2 hrs can be selected. There can be flights 2505D with the price range of 300-400 and 500-600 that do not depart at 10-12 and that have a total flight time of 0-2 hrs. Thus, elements 2406 can be selected as containing flights meeting the selection characteristics. There can be no Southwest flights that do not depart at 10-12, e.g., all Southwest flights depart at 10-12, and the Southwest element 2418 can be grayed out.

In some embodiments, the display of the search results can be re-arranged to show additional flights characteristics. The flight matrix can be expanded to broaden the search results, e.g., to include more information or flight itineraries. For example, a column or row of the matrix can be expanded into two or more columns or rows, with the two or more columns or rows comprising information related to the information of the column or row.

For example, new category can be added to existing categories, such as departure time and departure city can be added to departure, to provide nearby cities or airports. A customer might specify a departure airport. The search can include nearby airports, to provide the customer with a wider selection of possible flight itineraries.

New data or data ranges can be added to rows, such as expanding an element of 8 am-10 am into two elements of Sam-9 am and 9 am-10 am. The customer might specify a departure date. The search can include days before and days after the specified date, such as a few weeks, e.g., 1, 2, 3 or 4 weeks before or after, or a few months, such as 1, 2, 3 or 4 months before or after, as to provide the customer a wider selection of possible flight itineraries.

The flight matrix can be contracted to simplify the display, e.g., combining more information in elements of the flight matrix. For example, multiple columns or rows of the matrix can be consolidated or contracted into one column or row, with the one column or row comprising data of the multiple columns or rows. For example, existing categories can be consolidated into fewer categories, such as departure time and departure city can be consolidated into departure, or departure city can be omitted. Data or data ranges can be consolidated into fewer rows, such as two elements of Sam-9 am and 9 am-10 am can be consolidated into one element of 8 am-10 am. Alternatively, a date range of the category departure date can be 1 hour, 2 hours, 10 hours, 1 day, 2 days, or 1 week.

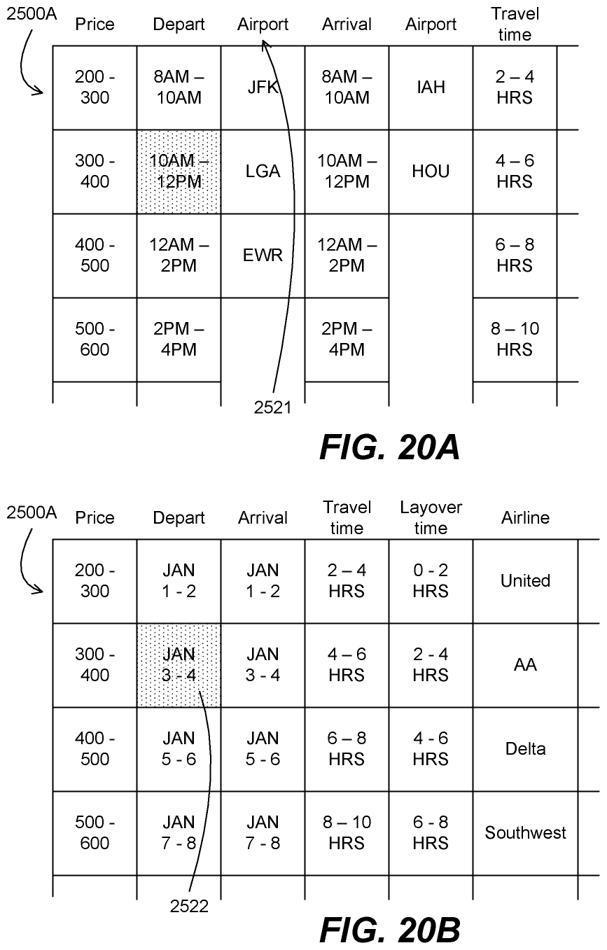

FIGS. 20A-20B illustrate expanded and contracted flight matrices according to some embodiments. In FIG. 20A, the flight matrix 2500A can be expanded to include a category of airport 2521, which can include the nearby airports corresponded to an input airport from the customer. For example, the customer can specify New York City, and the search can include the airports in and near New York City, which includes JFK, LGA and EWR.

In FIG. 20B, the flight matrix 2500A can be contracted so that the date range of the departure time can be 2 days, thus at least an element 2522 can be 2 days. As shown, other elements of the departure date category can be 2 days, but other configurations can be used, such as different date ranges for different elements of the departure time column.

In some embodiments, the display of the search results can be re-arranged to show suitable flight itineraries.

The flight matrix can show the list of available characteristics of flight itineraries, without actually showing the flight itineraries. For example, the flight matrix can show that there are flights cost between 200 and 300, and there are flights from United. However, there might not be a United flight that costs 200-300. The re-arrangement of the flight matrix can show the flight itineraries.

The flight matrix can be re-arranged, to switch between showing the list of available flight characteristics and the flight itineraries. The re-arrangement can be performed any time, for example, after a filtering process, e.g., removing elements of the flight matrix according to the customer selections. The re-arrangement of the flight matrix can be performed without updating the search results, since the re-arrangement can simply re-arrange the same data for display purposes.

The re-arrangement can include connecting lines, e.g., adding connections between elements of the matrix, for showing the information of individual flight itineraries. The re-arrangement can include re-arranging the flight matrix into multiple rows, with each row containing information of a flight itinerary.

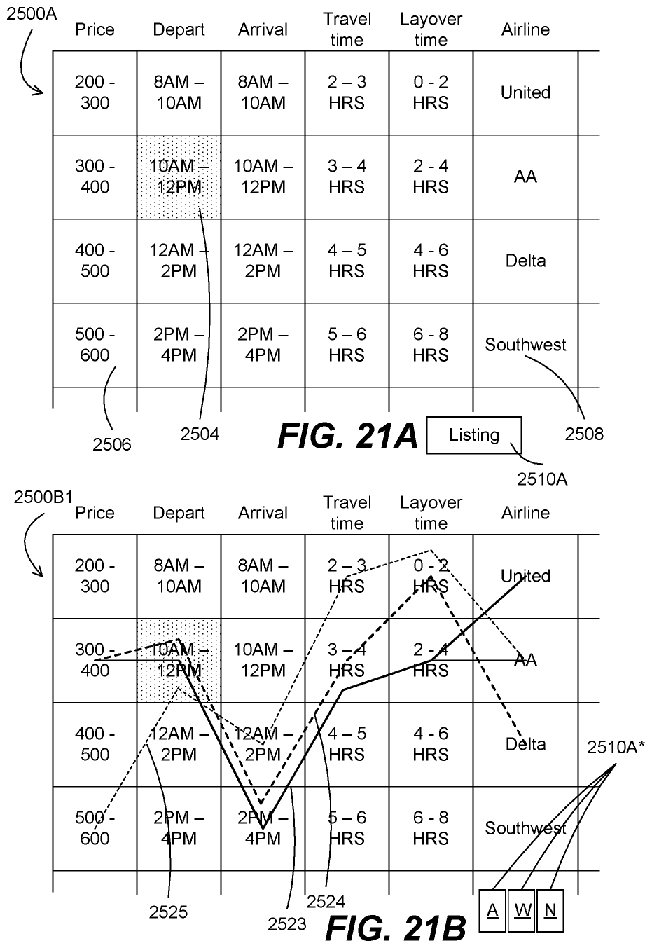

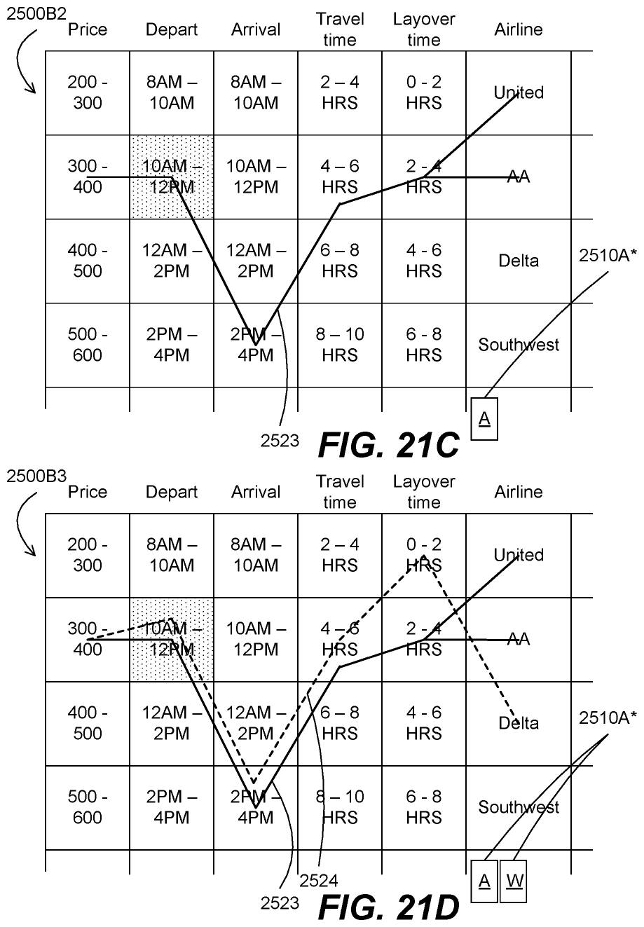

FIGS. 21A-21D illustrate a re-arrangement of flight matrices according to some embodiments. Connecting lines can be added to show individual flight itineraries. The search results of a travel plan can be displayed in a flight matrix, for example, a matrix using categories in columns and data of categories in rows. In FIG. 21A, a flight matrix format 2500A can be displayed, optionally with element 2504 (flight departing between 10 and 12) selected as a flight criterion. For the selection of departure time between 10 and 12, the elements of the matrix can be marked, such as elements 2506 marked as having flight and elements 2508 marked as not having flights. The marking of the elements can be performed after one or more selections of flight characteristics, as described above. As shown, the flight matrix 2500A lists characteristics of possible flight itineraries, such as element 2506 showing that there is at least a flight itinerary that cost between 500 and 600. Or that element 2508 shows that there is no Southwest flight for the input travel plan.

In FIG. 21B, the flight matrix 2500A can be re-arranged into a flight itinerary or flight listing format 2500B1, which can show the flight itineraries, for example, by an action of the user selecting the listing icon 2510A to present the flight listings. For example, connecting lines 2523, 2524, and 2525 in the flight matrix can be included to show the individual flight itineraries. Three flight itineraries can be shown for this flight matrix arrangement. For example, there is a flight itinerary 2525, which costs between 500 and 600, which departs between 10 and 12, arrives between 12 and 2, for 2-4 hour travel time with 0-2 layover time, and is operated by American Airlines. There are two other flight itineraries 2523 and 2524, with flight itinerary 2523 operated by a combination of United and American Airlines and flight itinerary 2524 operated by Delta, which have some similar flight characteristics such as cost and departure time, but having different travel times.

The re-arrangement of the flight matrix, e.g., toggling between listing of information (as shown in flight matrix format 2500A) and flight itineraries (as shown in flight itinerary format 2500B1), can be performed without updating of the search results. All data have been stored in the saved search results, so the toggling or re-arrangement of the flight matrix can be quickly completed. Thus the customer can perform selections of suitable flight itineraries without or with minimum waiting time, since the operation can be completed using saved search results.

In some embodiments, the search results can be periodically updated, for example, after every 5 minutes, 10 minutes, 15 minutes, 20 minutes, etc. The periodic update can ensure that the flight matrix contains up-to-date information, such as reflecting changes due to other customers accessing same flight database during the time the customer looks for suitable flight, especially for high demand flights. The update of flight information can be performed in a background.

The flight itineraries shown in the flight itinerary or flight listing format 2500B1 can be annotated with the restrictions of the travel policy. For example, flight itinerary 2523 is shown connected by solid lines, which can indicate that the flight itinerary is allowable by the travel policy. Flight itinerary 2524 is shown connected by dashed lines, which can indicate that the flight itinerary is in a warning range of the travel policy, with approval requiring a justification from the user. Flight itinerary 2525 is shown connected by dotted lines, which can indicate that the flight itinerary is in a non-bookable range of the travel policy, with approval requiring a request for approval from the user.

As shown, only one flight itinerary for each restriction range of the policy is shown, e.g., flight 2523 for allowable, flight 2524 for warning, and flight 2525 for non-bookable. Alternatively, multiple flights can be shown, which can be ranked to avoid clustering the display. For example, Top 1 flight, top 2 flights, top 3 flights, top 5 flights, or any other number of flights can be selected to shown in the display.

The display can also include multiple icons 2510A* to show the different flights according to the policy restrictions. The icons 2510A* can include an icon A, which is configured to show allowance flights, an icon W, which is configured to show warning flights, and an icon N, which is configured to show non bookable flights. For example, in display 2501B1, all icons are selected, and thus all flights according to restrictions allowable 2523, warning 2524, and non-bookable 2525 are shown.

FIG. 21C shows a flight itinerary or flight listing format 2500B2, which can show the allowable flight itineraries, for example, by an action of the user selecting the A icon of the group of icons 2510A* to present the listings of the allowable flights.

FIG. 21D shows a flight itinerary or flight listing format 2500B3, which can show the allowable and warning flight itineraries, for example, by an action of the user selecting the A and W icons of the group of icons 2510A* to present the listings of the allowable flights and the warning flights. Other formats can be shown, by different combinations of the icons A, W, and N of the group of icons 2510A*.

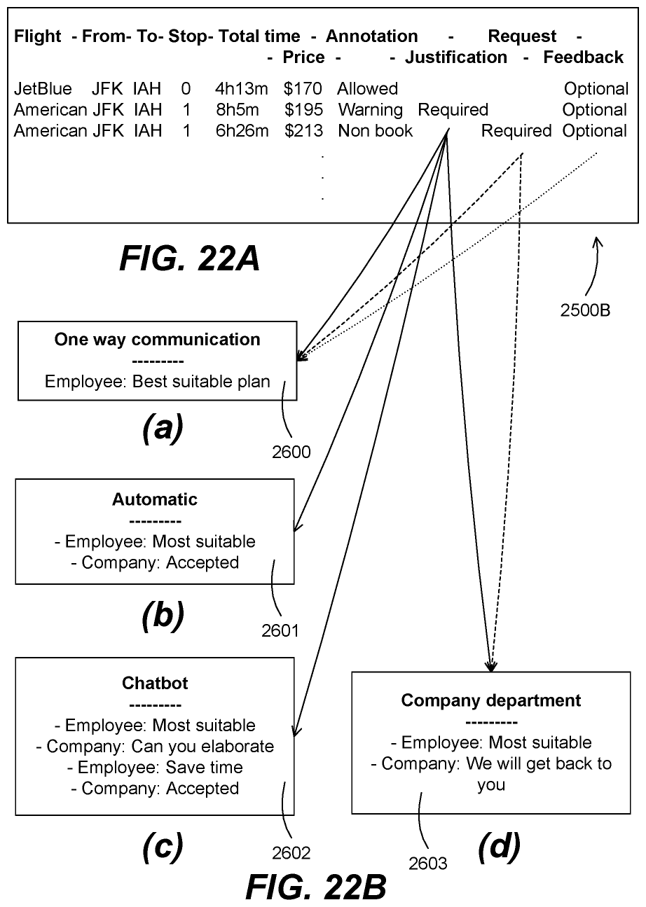

FIGS. 22A-22B illustrate a configuration for a display in a travel listing format according to some embodiments. FIG. 22A shows a travel listing format 2500B for a flight search result, e.g., a flight itinerary format. In the flight itinerary format, multiple flight itineraries can be shown, with each flight itinerary shown elements of the flight itinerary, together with the annotations dictated by the travel policy. The annotations can include allowable, which is optional since a flight can be considered to be allowable without any annotations. The annotations can also include warning, which requires justifications from the user, or non-bookable, which requires requests for approval from the user, or which can accept a feedback from the user. The display 2500B also shows a field for the justification, a field for the request, and a field for the feedback. The justification field can be associated with the warning flights, to allow the user to provide a justification to the company. The request field can be associated with the non-bookable flights, to allow the user to provide a justification to the company. The feedback field can be optional, and can be associated with different flights, e.g., for allowable flights, for warning flights, or for non-bookable flights.

The justification field, the request field, and the feedback field can be configured as functions or icons, which can provide one way or two way communication using a chatbot or directly to a company representative.

FIG. 22B(a) shows a one way communication 2600 configured to allow the user (e.g., employee or customer) to provide a message to the company. For example, when the user selects the justification field, the request field, or the feedback field in the display 2500B, the one way communication 2600 can be provided, with the communication 2600 presented as an enlargement area of the display or a pop up area, to allow the user to provide the justification, the request, or the feedback, respectively. The one way communication 2600 can be a text area or a voice area.

FIG. 22B(b) shows an automatic response communication 2601 configured to automatically provide a response to the user (e.g., employee or customer), such as a response to the justification of the user based on specific user or based on a past compliant history of the user with the travel policy. For example, when the user selects the justification field in the display 2500B, the automatic communication 2601 can provide an automatic response to the user justification for the warning flight itinerary. Alternatively, when the user selects the feedback field in the display 2500B, the automatic communication 2601 can provide an automatic response of “feedback received”. Other automatic response can be generated for any of the fields.

FIG. 22B(c) shows a chatbot communication 2602 configured to communicate with the user (e.g., employee or customer), such as to obtain further detail or clarification of the justification of the user. The chatbot can be an AI program, obtaining data from the past interactions with other users. The chatbot can further include a machine learning algorithm to allow the chatbot to use the subsequent communications or actions of the users for improve the responses with the users.

FIG. 22B(d) shows a real life person communication 2603 configured to communicate with the user (e.g., employee or customer). A representative of the company can answer the user inquiry, and can refer the user questions to a higher authority.

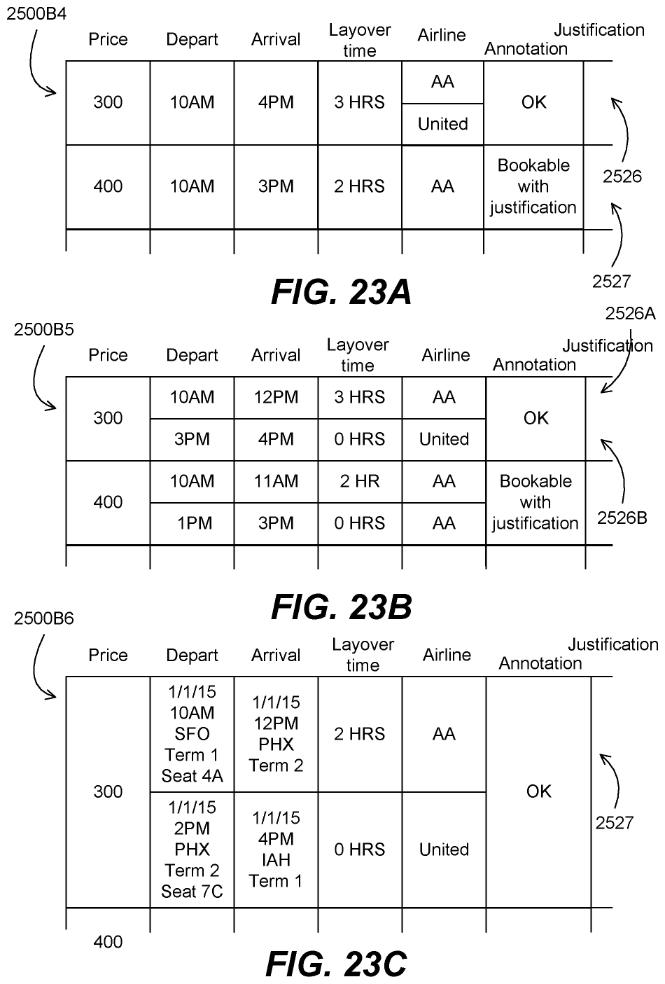

FIGS. 23A-23C illustrate a re-arrangement of flight matrices into flight itineraries or flight listing according to some embodiments. The flight matrix can be re-ordered into multiple rows, with each row containing information of a flight itinerary.

FIG. 23A shows a flight matrix 2500B4, which can be a simple flight listing re-arrangement of the flight matrix 2500A above. The flight matrix 2500B4 can include multiple rows 2526 and 2527. Each row can represent a flight itinerary. For example, row 2526 can show a flight itinerary that departs at 10 am, arrives at 4 pm, with 3 hours total travel time and 3 hours layover time. The cost of the flight is 300. The flight itinerary is operated by American Airlines and United. This flight itinerary can be similar to the flight itinerary 2423, shown by connecting lines in flight matrix 2500B1, except with more detail information.

For example, the connecting lines 2423 connect the cost element of 300-400, to the departure time of 10-12, to the arrival time of 2-4, to the travel time of 4-6, to the layover time of 2-4, to the airline of United/American Airlines. In contrast, the flight itinerary 2526 can list the exact value, such as the cost of 300, the departure time of 10, the arrival time of 4, the travel time of 6, the layover time of 2, and the airline of American Airlines and United. Flight 2526 is also annotated with an allowable annotation.

Row 2527 can show a flight itinerary that departs at 10 am, arrives at 3 pm, with 3 hours total travel time and 2 hour layover time. The cost of the flight is 400. The flight itinerary is operated by American Airlines. This flight itinerary can be similar to the flight itinerary 2525, shown by connecting lines in flight matrix 2500B1, except with more detail information. Flight 2527 is also annotated with a justification or warning annotation.

FIG. 23B shows a flight matrix 2500B5, which can be another flight listing re-arrangement of the flight matrix 2500A, and which can show more detail information. Two sub-rows 2526A and 2526B can be used to describe the flight itinerary 2526. Since the flight itinerary can have multiple flight segments, sub-rows can be used to provide detail information. For example, in sub-row 2526A, a first flight segment from American Airlines can depart at 10, arrive at 12 for 2 hour travel time. After a layover time of 3 hours, sub-row 2526B show a second flight segment from United, which departs at 3, arrives at 4 for 1 hours of travel time. The total price for the two flight segments is the same, which is 300.

FIG. 23C shows a flight matrix 2500B6, which can be another flight listing re-arrangement of the flight matrix 2500A, and which can show more detail information. Additional information can be included, such as date, airport, terminal, and seat.

In some embodiments, the different flight matrices, e.g., flight matrix 2500A, 2500B, 2500B1, 2500B2, 2500B3, 250B4, 2500B5, and 2500B6 can be toggled, e.g., switching from each other, to allow the customer different views of the possible flight itineraries, for example, by icons used for the toggling operation (not shown).

As shown, the flight itineraries are sorted based on price. The flight itineraries can be sorted based on different criterion, such as based on a customer preference.

In some embodiments, the personal travel agency service can display the search results of an inputted travel plan according to a saved customer preference, e.g., sorting the search results according to the customer preference. Thus the most suitable flight itineraries, e.g., the flight itineraries that meet most of the customer preference, can be displayed first, together with the most concerned features showing on the screen. Other flight itineraries and/or other features can be seen by scrolling the screen.

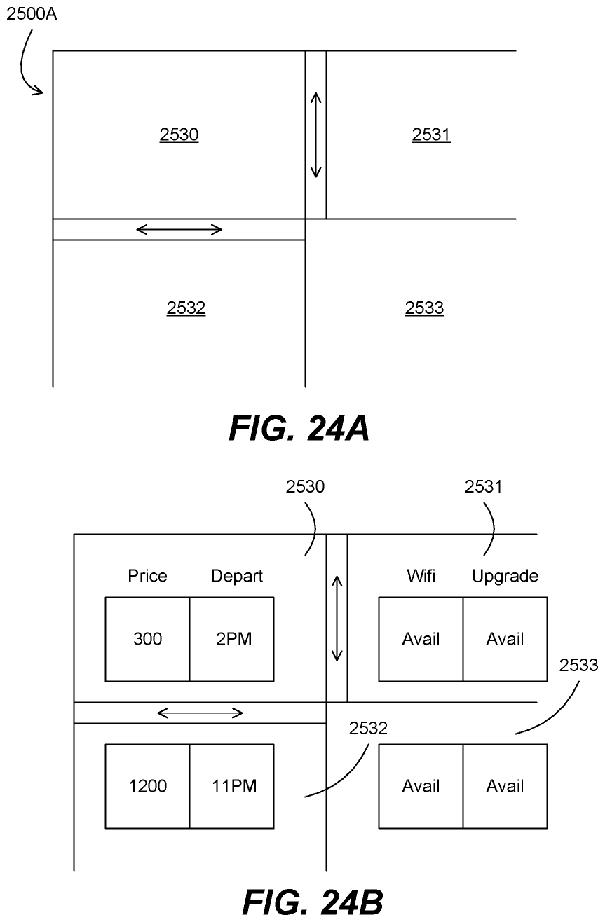

FIGS. 24A-24B illustrate flight matrices to be displayed on a screen according to some embodiments. A flight matrix 2500A, which can contain the search results for a customer travel plan, can be displayed on a screen. The size of the flight matrix 2500A can be larger than the size of the screen, for example, there can be hundreds of flight itineraries, and a large number of flight categories. Thus only a portion of the flight matrix can be seen on the screen. The rest of the flight matrix can be viewed by scrolling the display. For example, the top left portion 2530 can be shown on the screen. The right portion 2531 can be viewed when scrolling the screen to the right. The bottom portion 2532 can be viewed by scrolling down the screen. The right bottom portion 2533 can be viewed by scrolling down and to the right.

The platform can be configured to display the most suitable flight itineraries in the visible screen portion. The most suitable flight itineraries are based on the individual customers, e.g., different customers can have different suitable flights. In other words, a most suitable flight itinerary for a first customer is not necessarily suitable for a second customer. The suitability of the flight itineraries can be based on a customer preference, with the preference updated based on the actions of the customer in selecting flight itineraries.

The suitable flight itineraries can be arranged so that the most suitable flight itineraries are shown first, e.g., in the visible screen. The most unsuitable flight itineraries can be shown last, e.g., in the scroll-down portion 2533 of the screen. For example, if price is very important to a customer, then cheaper flights are shown first, and more expensive flights last. If the total travel time, or the layover time, e.g., the time waiting between flight segments, is important, e.g., a customer might accept up to 4 hours in layover time, then flights with less than 4 hour layover time are shown first, and flights with the most layover time are shown last.

Further the categories of the flight itineraries can be arranged so that the important features of the flight itineraries are shown on the left portion, e.g., on the visible screen. The less important features can be shown on the scroll-right portion 2531. For example, the features of price, departure and arrival information, travel time and layover time, and airline names can be important, which can be shown in the visible screen 2530. The availability of amenities, such as Wi-Fi, upgradable, early boarding, lounge access, etc., can be less important, which can be viewed in the scroll-right screen 2531. Any amenity features that are considered to be important to a particular customer, such as based on a saved customer preference, can be re-arranged to be on the visible screen.

In some embodiments, the present invention discloses methods, systems, and programs that can perform the methods, to optimize a travel policy for a company, including for balancing a satisfaction of the company employees with a control of the employee travel expenditures through the employee interaction with a display showing search results for a product or service, such as getting suitable flight itineraries to an employee. The programs can form a platform, which runs on a data processing system, such as a computer or a mobile device like a cell phone.

The policy optimization process can include forming a behavior profile for an employee. The behavior profile can include data from communication sessions of the employee with the platform, past actions, and characteristics of the actions of the employee when the employee selects the product or service, and then associating the communication data, the actions, and the action characteristics with indications of behavior of the employee.

The behavioral profile can be used for assessing a satisfactions of the employees with the travel policy, e.g., with the restrictions imposed by the travel policy on the selections of the travel related schedules by the employees. The degrees of the employee satisfactions can be used to provide feedback to the company, for example, to allow the company to adjust, e.g., to relax or to strengthen, the restrictions while still maintaining a control of the travel expenses.

The satisfaction assessment process is based on the actions of the employee, including the actions stored in the profile. For example, an AI algorithm can assess the data inferred from the employee in communicating with the platform, including the current IP address, the location, the time, the device used by the employee, together with actions of the employee in selecting the product, to provide behavioral patterns of the employee with regard to the restrictions of the policy.

The assessment can determine whether or not the employee is satisfied with the allowed travel schedules, and whether or not the restricted travel schedules represent any hardship for the employee. The employee satisfaction then can be assessed in view of the policy restrictions. If all employees are completely satisfied, the restrictions might be too easy, and a tightening of the restrictions might be necessary. Alternatively, if a lot of employees are dissatisfied, the restrictions might be too harsh, and a relaxing of the restrictions might be necessary.

The balancing between the employee satisfaction and policy restrictions can be gradually improved, for example, due to the employee understanding the reasons behind the restrictions. In a beginning, a low degree of satisfaction, such as lower than 60%, can be the goal of the travel policy to ensure a reasonable control of the travel expenses. Gradually, the degree of satisfaction can increase, with the expense control either relaxed or tightened, based on the employees. For example, a 60-90% or 70-80% satisfaction can be achieved. Ultimately, a 100% satisfaction can be achieved with an expense control that the company can support.

In some embodiments, an initial profile can be formed, for example, by collecting data and information from the employee, such as by asking the employee to fill in a questionnaire. The questionnaire can be directly related to the preferences of the employee, which can provide indications of the employee behavior. For example, the employee can specify that low fare is highly desirable, which can translate to a preference of low fares.

The questionnaire can be indirectly related to the behavior preferences. For example, the employee can specify memberships in frequent flyer programs. This information can imply that the airlines with the frequent flyer programs should be of higher preference. If there is more than one frequent flyer program, then the program with the most mileages in it can be more preferred. The frequent flyer data can provide indications of the employee behavior. If all other characteristics are similar, a fraudulent flag can be raised if the employee selects a flight from an airline that the employee has not enrolled in its frequent flyer program.

Data for the profile can be collected from public or private databases, such as credit history, professional association, or correspondence of the employees. For example, the income level of an employee can be determined by the employee answering the questionnaire, or by knowing the profession of the employee through a public database. Thus a low income employee can imply that comforts, such as not excessive layover times between flight segments, additional legroom, or better employee service, can be less preferred than low prices. Thus, a fraudulent flag can be raised if the employee selects an expensive flight while there are lower price flights that are less convenient.

The preferences in the travel preference profile can be relative or conditional, e.g., not always absolute. For example, a preference of low fares can be rated or having a scale factor, e.g., from 0 to 10 with 0 being no preference at all and 10 being an absolute preference. A zero preference of low fares means that money is not a concern in planning the travel itinerary. A preference of low fares means that the employee would do anything in order to have the lowest fare possible. In this case, the travel fare is the first choice, and only different flight itineraries with a same lowest fare are being considered. The AI algorithm can consider all the available data to determine if the current data meets the employee behavior pattern specified by the profile.

In general, most employees have a gray level of preference instead of the extreme values of black and while. When an employee specify a preference of low fares, it typically means a relative preference, e.g., a low fare is preferred if the flight itinerary is not too uncomfortable or too inconvenient. Thus the employee can specify a preference level for low fares, but the specified level can be vague and not accurate, since there can be many factors of comfort and convenience that can affect the low fare decision.

In some embodiments, the preference level can be determined from past actions of the employee, e.g., the actions of the employee in selecting flight itineraries in the past, since the actions of the employee present a clear indication of the meaning of the preference, e.g., the importance of the preference with respect to other aspects of travel. For example, even though the employee might indicate a preference for low fares, the employee might still select a flight itinerary with higher fares. The selected flight itinerary can show the level of the low fare preference, such as selecting a higher fare flight since the low fare flight contains a long layover time between the flight segments. Thus the actions of the employee can be a more reliable indication of the employee travel preferences. The AI algorithm can consider all factors related to the employee behavior, to provide a pattern that can be used for matching with the current actions.

The profile can contain previous actions of the employee during the previous product selections, such as selecting or deselecting features or characteristics, as discussed above, on the matrix format or on the listing format. The employee preference can be updated with the selections made by the employee on the displayed flight itineraries, together with indications of the employee behavior generated from the actions. For example, if the employee chooses morning flights, then morning flights can be added to the preference list. If the employee wants to avoid red-eye flights, then the preference list can include a low preference for red-eye flights.

The actions and characteristics of the actions can indicate a thinking of the employee, e.g., a desire, a preference, or a behavior of the employee. For example, if the employee selects a particular airline, this can indicate a strong preference of the employee toward the selected airline. If the employee selects short layover times between flight segments or stops, this can indicate a preference of comfort and convenience, e.g., over low fares.

The employee selections can be related to different aspects of the flights, such as early boarding option, Wi-Fi, better meal services, safety record of the airline, on time performance of the airline. The selections can indicate a preference of the employee with respect to the airline service. The actions of the employee can also indicate the level of the preference, for example, by the additional fare that the employee is willing to pay for such services.

The employee can browse for flights, e.g., searching but not booking or buying. The preferences associated with the browsing actions can have a lower weight in the travel preference profile, such as comparing to actions resulted in flight booking.

In some embodiments, the characteristics of the actions can include a delay time between two consecutive actions. For example, if there is a very short time between two actions, with the second action supersedes the first action, then there could be an error in the selection process, and any preference associated with the first action might not be valid. If there is a long time delay before a second selection, then the employee might be hesitant, e.g., not sure about the second selection, and thus the second selection can carry less weight as compared to other selections.

The profile can contain the information that the employee provides to the platform, either directly or inferred by the platform. For example, the information can include data from a questionnaire filled by the employee. The information can include name, birthday, traveling preferences, membership in frequent flyer programs, and income. Other information can also be collected, since the information can be used to make decision in fraudulent detection. The use of the information can be explicit. For example, an employee can specify that low fare is the highest priority. Thus flight itinerary selection can be simplified with fares being the top priority. The use of the information can be implicit. For example, a high income employee would be likely to select comforts over prices, and thus higher fare plan for short layover time (e.g., waiting time between segments of the travel plans) or additional legroom or better employee service can be preferred over lower fare plans.

In some embodiments, the information can be collected from public or private databases, such as credit history and professional association of the employees. The information can be collected from the employee activities, such as from correspondence of the employees, which can indicate a traveling preference of the employees. For example, the employees can send emails, discussing traveling, and indicating that early check-in or boarding can be an important consideration in air traveling. This information can be used to provide indications of the employee behavior, such as a preference to comfort for early checking or boarding.

The profile can contain the communication information from the employee when contacting the service provider, such as the devices used by the employee, the IP addresses, the login times and locations, and mouse and keyboard usage of the employee. The access to the communication information used by the employee can provide indications of the employee behavior, such as a long delay time before a high price selection can indicate a reluctance of the employee for high price products, multiple login times during after business hour can indicate an employee having a normal working schedule, or consistent IP addresses and login locations can indicate a less traveled employee.

In some embodiments, the profiles can be updated, e.g., the programs can ask the employees for additional data, e.g., beyond the stored data and information that the employees have supplied, to provide a complete behavior profile. For example, in cases in which the current actions are ambiguous, e.g., not clearly distinct or clearly matched the profile pattern, the programs can ask the employee for addition information to determine the employee authentication. The programs can provide simulated flight booking for additional information in behavior. An employee can browse through the flight itineraries, with all actions similar to a real flight booking. The actions and characteristics of the actions of the employee during the simulated booking can provide the additional information needed by the AI algorithm during the determination of whether or not there is a deviation from the current actions to the profile behavior pattern.

For example, the programs can have a machine-learning module, which can learn from past actions of the employees, such as the selection of travel plans that the programs present to the employees. The programs can provide travel plans with different characteristics, such as one having low fare/low comfort and one having high fare/high comfort. Based on the selection of the employees, a preference matrix can be established, formulating a preference relationship between price and comfort.

In some embodiments, the employee preference can be updated through the employee selections on the flight matrix. For example, if the employee selects United to be a selected element, e.g., a positive selection, in the display flight matrix, then the item “United airlines” can accumulate an additional priority point. In contrast, if the employee selects American Airlines to be a non-selected element, e.g., a negative selection, in the display flight matrix, then the item “American Airlines” can have a priority point subtracted. In some embodiments, if the employee selects a final itinerary for purchase, then the features of the flight matrix shown in the visible display can each be added a priority point, implying that the display matrix represents an employee preference. The employee preference can be generated, or assisted in the generation, through artificial intelligence and machine learning.

In some embodiments, the information can be collected from past actions of the employees. For example, even though the employees specify a preference of comforts over prices, the employees still select flight itineraries having lower fare and slightly high discomforts. Thus the past actions of the employees can be a more reliable indication of the employee travel preference, for example, over the answered questionnaires.

In some embodiments, associating action characteristics with employee behavior can include linking the action characteristics with the behavior of the employee. Indications of the employee behavior can be generated from the data received or inferred from the employee, to form a pattern of the employee behavior, which can assist the AT algorithm is authenticate the employee.

In some embodiments, the employee behavior can be multiple modals instead of single modal, e.g., the employee can exhibit different behavior patterns depending on different situations. For example, the employee can have a first behavior pattern when traveling on personal expenses and a second behavior pattern when traveling on business expenses. For example, convenience can have a higher priority than prices for business traveling. In addition, traveling with family, especially with young children can have different preferences than traveling alone. Thus the employee behavior pattern can be classified into different modes, such as business mode for business traveling, personal mode for leisure traveling, and family mode for traveling with family, either for business or pleasure.

In some embodiments, the methods can include machine intelligence, which can contain an AI algorithm to authenticate the employees from the actions and communication of the employees with the platform. The algorithm can be based on the employee travel profiles, such as preference profiles and behavioral profiles. Different preference travel profiles can be used, such as traveling for business (e.g., business profile) or pleasure (personal profile), with or without family members (single or family profile). For example, the methods can detect anomaly in actions and communication of the employees, which can increase an estimate for fraudulent risk of the employee activities, when the current actions and communication of the employees are not consistent with the employee profiles. The profiles for multiple employees can be stored in a database, and can be updated with the employee data, including the current actions and communication of the employees.

In some embodiments, the present invention discloses programs that can perform the machine intelligence methods for selecting flight itineraries for the employees. The programs can be used in a data processing system, or can be used in a mobile system, such as a cell phone, which can communicate with airlines for generating travel plans, and which can perform the machine intelligence algorithms for choosing flight itineraries for the employees. The programs can communicate with the employees through voice and/or display. For example, an employee can dictate (or type) to the programs to find a travel plan on a certain date to a certain city. The programs can respond by display and/or speech to tell the employee the available travel options.

In some embodiments, the present invention discloses behavioral profiles for employee travels. The profiles can be dynamically developed, e.g., the profiles can be updated with the employee behavior and actions. For example, an initial profile can be provided, using inputs from the employee. The initial profiles can include information similar to that given to a human travel agent. For example, the initial profiles can include a preference of the employee regarding seat selection, e.g., aisle or window seat.

The profiles can be dynamically enhanced, for example, with data input from the client's purchase history and behavior in making choices from the travel offerings that are presented to him/her. The profiles can also be dynamically enhanced with data collected on the client from social media and the World Wide Web. The dynamic enhancement can help refine the behavioral predictability and help the programs making decisions that minor the client's own behavior.

In some embodiments, the profiles or the preference matrix can include multiple elements, each with different important scale. For example, the profiles can include price, which can be a less important factor when travelling for business as compared to travelling for leisure. The profiles can include schedule convenience, which can be firmer for business travel versus more flexibility for leisure travel. The schedule convenience can include departure time, arrival time, number of flight segments, e.g., number of stops, and layover time between flight segments. The profiles can include other elements, such as maximum number of stops, connections, or flight segments, optimal layover time between flight segments, free checked bags, priority boarding, complimentary upgrades, system wide upgrades, better employee service/dedicated phone lines, discounted/free lounge access, mileage earning bonuses, access to preferred seating ahead of time, waived award fees for tickets, free same-day changes, free or discount on ticket change fees, price hold on booking for a period of time, free/discounted refund or exchange fees, free Wi-Fi, free meals, extra leg room, free entertainment (movies, games etc.).

In addition to the travel preferences of the employees, other behaviors of the employees can be generated from the employee actions, including satisfaction of the employees with the restrictions of the travel policy imposed by the company. The satisfaction can be obtained from the booking actions, such as booking an allowed travel schedule can indicate a policy satisfaction, while selecting a warning travel schedule can indicate a slight dissatisfaction, and selecting a non-bookable travel schedule can indicate a high dissatisfaction level. The satisfaction levels can be obtained from other actions, such as a justification, a request for approval, or a feedback action can indicate dissatisfaction.

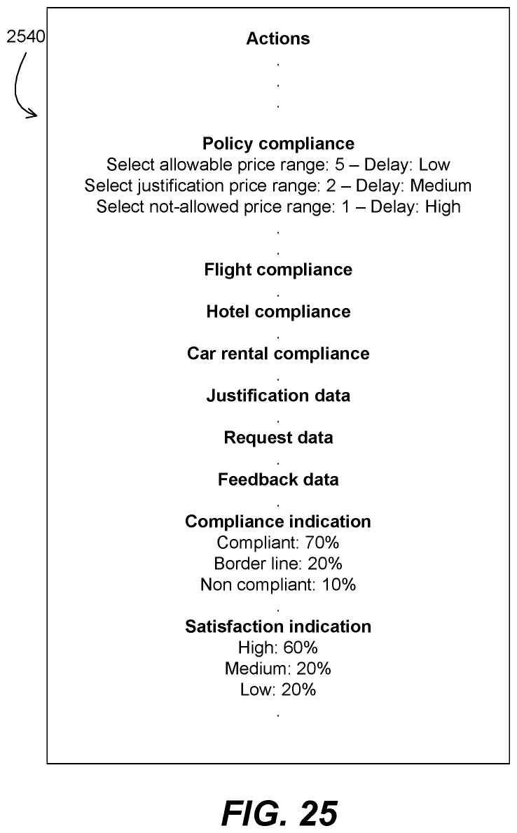

FIG. 25 illustrates a configuration of a behavior profile according to some embodiments. A profile 2540 for an employee can have a number of elements. Each element of the profile can have a scaling factor, which indicates the importance of the element for a particular trip.

The profile for an employee can contain actions of the employee during the process of selecting a travel schedule. The storing of the employee actions is an accumulated process, e.g., actions are stored from past travel selections, including the current travel selection. Further, the actions can be processed to provide statistical indications of the employee with regard to the employee behaviors, such as a satisfaction level of the employee with the travel policy. The correlation of the employee actions with the employee satisfaction level can be performed by an artificial intelligent algorithm, to provide patterns of the employee behaviors based on the employee actions in the process of selecting travel schedules. The artificial intelligent algorithm can include a machine learning portion, to allow a continuous improvement of the assessing of the employee satisfaction.

The employee profile can include an assessment of the satisfaction of the employee with the travel policy based on the employee actions. The satisfaction level can be generated for individual employee, based on the actions of the employee. Further, since the travel policy is a company policy, e.g., designed for all employees of the company, and optionally for any entities related to the company, such as for company associates like contractors and consultants, the satisfaction level can be generated from all employees, e.g., to generate a satisfaction with the travel policy, from all employees, and not just a satisfaction of any individual employee.

The employee profile can include an assessment of the compliance of the employee with the travel policy based on the employee actions, such as the booking of travel schedules, and the delay time when selecting the travel schedules. For example, during a past time period, an employee has selected 5 allowable travel schedules, with a low delay time between each selection. This gives an indication that the employee is satisfied with the policy restrictions, e.g., the restrictions do not cause any hardship for the employee. The employee has also selected 2 justification travel schedules, with a medium delay time between each selection. The medium delay time can show a slight hesitation of the employee in the selection of these justification selections. This gives an indication that the employee is slightly dissatisfied with the policy restrictions, e.g., the restrictions has caused a slight hardship for the employee. The employee has also selected 1 non bookable travel schedules, with a long delay time before the selection. The long delay time can show a hesitation of the employee, which shows that the non-bookable schedule might not be very important to the employee. This gives an indication that the employee is not satisfied with the policy restrictions, e.g., the restrictions has caused a hardship for the employee. Overall, the employee can be considered as satisfied. The AI algorithm can classify the employee as 70-80% satisfied.

The AI algorithm can obtain patterns from all employee profiles, to generate a level of satisfaction of the employees with the policy. Further the AI algorithm can also generate areas of restrictions that cause dissatisfaction, in order to provide improvement suggestion to the company. For example, a reformatting of the restrictions can improve the overall satisfaction level by pleasing more employees, while not really change the substance or nature of the restrictions.

The AI algorithm can be configured to optimize a number of employees with high satisfaction for a same level of policy restrictions. Alternatively, the AI algorithm can be configured to optimize a number of satisfied employees with respect to the policy restrictions. The optimization process can provide a balance or optimal point between the level of satisfaction of the employees and a control of the travel policy represented by the policy restrictions. For example, if a small relaxation of policy restrictions can result in a high increase of satisfied employees, the AI algorithm can provide improvement suggestion to the company in term of relaxing the policy restrictions. If a large relaxation of policy restrictions can result in a low increase of satisfied employees, the AI algorithm can provide improvement suggestion to the company in term of tightening or not changing the policy restrictions.

The profile can store actions of the employee during processes of selecting travel accommodations, including air travel, land travel such as bus or tour, hotel accommodations, car rental accommodations, or entertainment accommodations. The satisfaction and compliance levels of the employee in the profile can be classified as a compliance with individual elements of the travel accommodations. The individual assessments, e.g., satisfaction level and compliance level, can allow the AI algorithm to provide individual improvement suggestions to the travel policy. Alternatively or additionally, the assessments can include total assessments of satisfaction and compliance of all employees with regard to all travel aspects. The total assessment can provide a general view of the restrictions of the policy by the employees of the company.

The profile can store data generated by the employee, such as the justification data, the request data, and the feedback data. The justification data, the request data, and the feedback data can be used by the AI algorithm to determine the levels of satisfaction and the levels of compliance of the employees, either for individual employees or for a collection of all employees. The data can be used to provide an optimization of satisfaction for a given set of policy restrictions, or for a balance of satisfaction and compliance of the employees, e.g., the policy restrictions can be modified to optimize the employee satisfaction.

The profile can store compliance and satisfaction indications for the employee. Each indication can be a value, showing the level of compliance or satisfaction. Each indication can be a statistical function, showing different degrees of compliance or satisfaction. For example, a satisfaction indication can have 60% highly satisfied, 20% averagely satisfied, and 20% low satisfied. This satisfaction indication can show that the employee is generally satisfied, but the travel policy can be improved to increase the satisfaction level. A compliance indication can have 70% compliant, 20% borderline, and 10% non-compliant. This compliance indication can show that the employee is generally compliant, but there can be restrictions of the travel policy that cause non-compliant activities from the employees. Together with the satisfaction indication, the compliance indication can provide a view of the employee toward the company, which is largely dedicated to the company, but with some concern on the inadequacy of the travel policy.

The profiles of the employees can provide indications of the dedication and the intelligence of the individual employees toward the growth of the company, exemplified by the satisfaction and compliance of the employees with respect to the control of the travel expenditures dictated by the restrictions in the travel policy. Further, the collective assessment of the employee profiles, such as an aggregation of the satisfaction and compliance of the employees, can provide a direction for an improvement of the policy, such as to optimize the collective satisfaction and compliance with a given policy. Further, the assessment can also allow a modification of the policy to further improve the optimization of the satisfaction and compliance of the employees.

The satisfaction and compliance indications can serve as a guideline in finding areas of improvement in the travel policy. The AI algorithm can find patterns of dissatisfaction and non-compliance amount the employees with respect to different aspects of the policy restrictions in order to provide improvement suggestion to the company to modify the travel policy to optimize the satisfaction of all employees based on a set of determined policy restrictions, and can modify the travel policy to optimize both the satisfaction of all employees and the policy restrictions.

In addition to the data and processes to obtain employee satisfaction and policy compliance, the profile can be used to obtain employee travel preference, which can be used to modify the travel policy for better suited to the employee. An employee can place high importance to price, thus the price element can have a scaling factor of, for example, 7 out of 10. The employee can travel alone with minimum baggage, thus can place low importance to pre-boarding access or priority boarding, thus the pre-boarding element can have scaling factor of, for example, 2 out of 10. The scaling factor can be a function, instead of a number. For example, a layover time of 2 hours can be considered optimal, and can have a scaling factor of 8. A layover time of 6 or more hours can be considered undesirable, and thus can have a scaling factor of 1. The profiles can be used to rank the different available travel plans, and the travel plans having high ranks can be selected for the employee review, or for purchasing the flight. The scaling factor can be a function of airlines, e.g., the employee can have different preferences for different airlines. For example, an employee may not want American Airlines to offer a lounge at the airport because the employee already has a yearly lounge pass with American Airlines. An employee may or may not want United Airlines to offer a lounge at the airport because the employee already has a yearly lounge pass with American Airlines. For example, if the United Airlines lounge is closer to a departing gate as compared to the American Airlines lounge, the employee might be interested in obtaining the United Airlines lounge pass.

The profile can include actions of the employee, together with the transaction values. For example, the profile can include a number of employee selections for different price ranges, together with values for the delay between consecutive actions. The profile can also include transaction volumes, which provide the number of transactions the employee, transaction rates, which provide the rate of transactions the employee, transaction locations, which provide the locations of the transactions, such as the locations of the employee or the location of the departure or arrival of a flight itinerary of the employee, transaction times, which provide the times and dates of the transactions.

The profile can include access data, which includes the communication information between the employee and the platform. For example, the access data can include the Internet Protocol (IP) addresses that the employee uses when contacting the platform, the login times and locations of the employee, and the devices used by the employee. In addition, the access data can include the emotional state of the employee during the communication sessions, such as the mouse and keyboard usage.

The profile can include indications of the behavior of the employee, such as indications of the employee lifestyle, such as a high frugality, low luxury, and high comfort and convenience.

Method to Optimize a Company Travel Policy

In some embodiments, a method to optimize a company travel policy is presented, which is based actions of the company employees during the selections of travel schedules. The actions can be processed, for example, by an AI algorithm with machine learning capability, to obtain satisfactions and compliance of the employees. The satisfactions and compliance of the employees can be aggregated to show areas of the travel policy having high or low levels of support from the employees, indicated by the satisfactions and compliance of the employees with the travel policy. The assessment of the employee actions can be used to generate an improvement suggestion to the travel policy, such as to optimize the satisfactions and compliance based on a given travel policy that is mostly suitable for the company. For example, the travel policy can be adjusted with a same overall expense control by the company to improve the overall satisfactions and compliance of the employees. For example, areas of the policy with a high number of low employee satisfaction can be relaxed to reduce the high number of low satisfaction, while areas of the policy with a high number of high employee satisfaction can be tightened to reduce the high number of high satisfaction. With both relaxing and tightening actions of the travel policy, an overall control is maintained but with an improvement on overall satisfaction and compliance of the employees.

The improvement suggestion can be designed to further optimize the satisfactions and compliance with further modifying the travel policy. For example, the travel policy can be adjusted with a same overall expense control by the company to improve the overall satisfactions and compliance of the employees. For example, areas of the policy with a high number of low employee satisfaction can be relaxed to reduce the high number of low satisfaction, while areas of the policy with a high number of high employee satisfaction can be tightened to reduce the high number of high satisfaction. With both relaxing and tightening actions of the travel policy, an overall control is maintained but with an improvement on overall satisfaction and compliance of the employees.

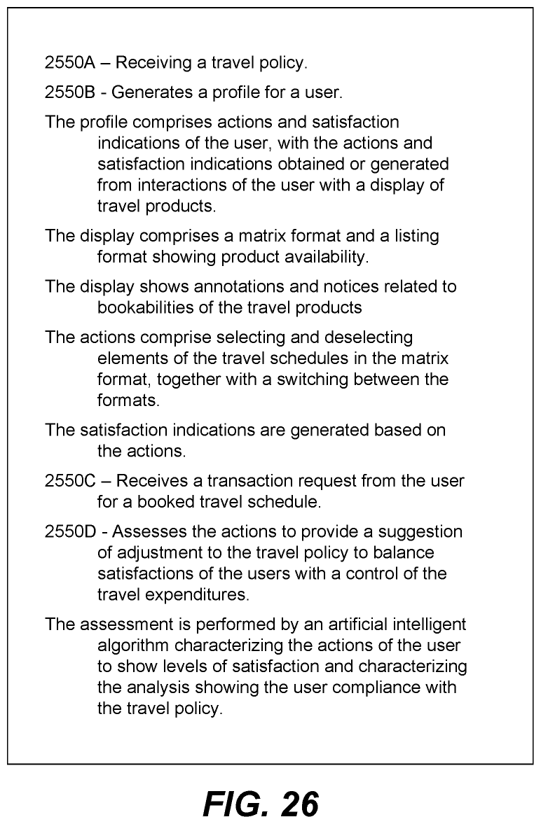

FIG. 26 illustrates a flow chart for authenticating a user according to some embodiments. Operation 2550A receives a travel policy of a company, for example, by a travel agency selected by the company to provide travel related services, e.g., travel schedules such as flight itineraries, hotel accommodations, car rental services, or other services such as entertainment or meals.

Operation 2550B generates a profile for a user, e.g., an employee of the company or an entity or person related to the company, such as a contractor or a consultant. The profile comprises actions and satisfaction indications of the user, with the actions and satisfaction indications obtained or generated from interactions of the user with a display of travel products.

The display comprises a matrix format and a listing format showing product availability. The display also shows annotations and notices related to bookabilities of the travel products

The actions comprise selecting and deselecting elements of the travel schedules in the matrix format, together with a switching between the formats. The satisfaction indications are generated based on the actions.

Operation 2550C receives a transaction request from the user for a booked travel schedule. Operation 2550D assesses the actions to provide a suggestion of adjustment to the travel policy to balance satisfactions of the users with a control of the travel expenditures. The assessment is performed by an artificial intelligent algorithm characterizing the actions of the user to show levels of satisfaction and characterizing the analysis showing the user compliance with the travel policy.

In some embodiments, the present invention discloses a computer-implemented method to form profiles for multiple users, such as employees of a company or persons related to the company, which can be used to assess thinking or state of mind of the users through an AI algorithm characterizing satisfactions and compliance of the users with a travel policy imposed restrictions to the expenditures and the selections of travel related services. The characterization can be used to generate improvement suggestion to the company with regard to the travel policy.

The method includes (1) receiving a travel policy for a company. For example, the company can send a travel policy for its employees and associates to a service provider, such as a travel agency. The travel agency can provide travel related services, such as searching for flight itineraries, hotel accommodations, car rental services, and other services such as meal and entertainment booking. The travel policy serves as a guideline to control the travel expenditures of the users of the travel agency, which include the employees and associates of the company.

The travel policy includes restrictions regarding travel related expenditures for the users. The restrictions can include an upper threshold limit for spending, which establishes a ceiling for the travel expenses incurred by the users, e.g., travel expenses higher than the upper threshold limit require an explicit approval from the company. The upper threshold limit can be different for different locations and services, such as a limit for air flight, a limit for hotel, and a limit for car rental. The restrictions can include a lower threshold limit for spending, which establishes a preapproved limit for the travel expenses incurred by the users, e.g., travel expenses lower than the lower threshold limit are automatically approved by the company. Similar to the upper threshold limit, the lower threshold limit can be different for different locations and services, such as a limit for air flight, a limit for hotel, and a limit for car rental. Also, the upper and lower threshold limits can be dynamically adjusted, for example, due to seasons and inflation.

Between the upper and lower threshold limits is a warning range of travel expenses. The warning range can be considered as a buffer zone or a gray zone between an automatic approval limit (e.g., the lower threshold limit), and an automatic rejection limit (e.g., the upper threshold limit). The travel expenses within the warning range require a justification from the user, in order to provide flexibility to the travel policy. In addition, the justification can serve to evaluate a suitability of the travel policy, e.g., providing an assessment of the travel policy from the point of view of the users.

Also, to further provide an assessment of the travel policy from the point of view of the users, the travel policy can accept requests for approval and feedbacks from the users with regard to the upper threshold limit. The justification, requests and feedbacks can be used, for example, by an AI algorithm, to generate improvement suggestions to the company in order to optimize the satisfaction of the users.

The method also includes (2) forming a database comprising profiles of the users. The database can be stored at the service provider or at the company, for example, by the service provider sending the profile data to the company. The profiles can be used to service the travel policy, such as to provide satisfaction or compliance indications, or to provide improvement suggestions to the company with respect to the travel policy.

The profiles can store data of the users, with each profile linked to a user, e.g., a profile in the database is associated with an employee or an associate of the company. The individual profiles can have a benefit of being linked to the specific users, and therefore can be used for other purposes such as to provide travel preferences for the users. Each profile can include a log of actions in transactions associated with the user, indications of user travel preferences based on the actions, and indications of the user satisfaction and compliance with the travel policy based on the actions;

Alternatively, the service provider can form one or more user profiles, with each user profile storing an aspect of all users, or a profile storing all user data related to the travel services. For example, an action profile can be used to store all actions of all users during the processes of the users selecting travel services. A satisfaction or a compliance profile can be used to store satisfaction or compliance data, respectively, for the users. Thus, the one or more profiles can be anonymous, e.g., there are user data used for the improvement of the travel policy, without linking to any specific user.

The method also includes (3) receiving a travel search request from a user. The user can be an employee of the company, looking for a travel service, for example, for a company business. Since the travel service will be used for the company business, the travel expenses associated with the travel service will be paid for by the company, and thus, the travel service is subjected to the control of the company, such as under the restrictions of the travel policy. The request can include a flight search, e.g., a search for a flight itinerary using a departure, a destination, and time of travel. The request can include a hotel search, a car rental search, or a meal or entertainment search.

The method also includes (4) displaying a travel search result for the travel search request from the user. The travel search result includes multiple travel schedules for a travel related activity in the travel search request. For example, if the travel search request is a flight request, the travel search result includes multiple flight itineraries meeting the requirements of the travel search request.

The travel search result is displayed in a travel matrix format or a travel listing format. The display of the travel search result can be shown in a format of a matrix, configured to show multiple schedule elements in different travel categories in a first dimension and either different ranges or values of the travel categories in a second dimension. For example, the matrix format of a flight search can be shown in a 2D matrix with a column dimension showing different flight categories such as departure city, arrival city, departure time, or arrival time. The 2D matrix can have a row dimension showing different ranges or values corresponded to the categories, such as the departure city can have values of Boston, New York, or other cities, and the departure time can have ranges of 8-10 AM, 10-12 AM, 12-2 PM, or other time ranges. The matrix format is configured to show elements of the travel schedule, such as the departure time range, the arrival time range, the value of the departure city, the value of the arrival city for a flight matrix.

The matrix format is not configured to show the schedule listings, for example, a flight matrix does not the flight itineraries. A flight matrix only shows the elements of the flight itineraries, such as a departure city of Boston or a departure time between 8 and 10 AM. The matrix elements can be marked, such as grayed out, highlighted, or color coded to represent different values of the travel listing. As an example, a matrix element can be grayed out to indicate that there is no flight meeting the value of the matrix element. For example, an element of 6 hrs layover time in the flight matrix can be grayed out, to show that none of the flight itineraries meeting the user requirements has a 6 hour layover time.

The listing format is configured to show a list of at least some of the multiple travel schedules meeting the user requirements. The number of displayed travel schedules can be designed to provide clarity to the display, and can be changed by an action of the user, such as by the user entering the number of travel schedules to be shown. The listing format can be a list listing format, e.g., a listing format showing a list of travel schedules, such as a list of the flight itineraries for a flight listing format. The schedule listings in the list can be very detail, such as a flight itinerary can show the departure time, the arrival time, or the different flight segments. Alternatively, the schedule listings can be short and general, showing only the important features of the schedules, for example, to allow a big overview of the available schedules in a display of a travel search result.

The listing format can be a matrix row listing format, based on the matrix format, with each row or column of the matrix showing a travel schedule. For example, a flight listing format can be a matrix, with the columns of the matrix showing different categories of the flight itinerary, such as a price column, a departure time column, a departure city column, etc. The first row of the flight listing matrix format can show a first flight itinerary, with the values of the first flight itinerary corresponded to the categories in the matrix columns. For example, the value of the first flight itinerary in the price column can show the price of the first flight itinerary, the value of the first flight itinerary in the departure time column can show the departure time of the first flight itinerary, etc.

The listing format can be a line matrix format, based on the matrix format, with a schedule listing being multiple line segments connecting different elements of the matrix. For example, a flight itinerary of 300 price, of 8-10 AM departure time, and of Boston departure city can be represented by lines connecting a 300 price element, an 8-10 AM departure element, and a Boston departure city element.

The formats can have commands, such as icons shown on the display, with the commands selectable by the user for switching between the formats, such as between the matrix format, the list listing format, the matrix row listing format, and the connecting line matrix format.

The travel schedules in the display are annotated with the restrictions of the travel policy, for example, the flight itineraries in the list listing format, the matrix row listing format, and the connecting line matrix format are annotated with the policy restrictions.

The restrictions of the travel policy can classify the travel schedules into three policy groups. The policy groups can include an allowance group, which includes travel schedules meeting the restrictions of the policy, e.g., travel schedules complied with the policy. The travel schedules in the allowance group have expenses below the lower threshold limit, and therefore can be automatically approved when the user selects the travel schedule in this group.

The policy groups can include a non-bookable group, which includes travel schedules not meeting the restrictions of the policy, e.g., travel schedules not complied with the policy. The travel schedules in the non-bookable group have expenses above the upper threshold limit, and therefore can be automatically rejected when the user selects the travel schedule in this group.

The policy groups can include a justifiable group, or a borderline group, which includes travel schedules not meeting the restrictions of the policy, e.g., travel schedules not complied with the policy. However, the travel schedules in the justifiable group have expenses in the warning range, e.g., below the upper threshold limit but above the lower threshold limit. Thus, the travel schedules in this group can be approved or rejected, based on various factors, such as based on a history of compliance of the user, or based on how close the expense is to the lower or upper limit.

The annotations to the travel schedules are configured to show the policy restrictions, for example, to alert the user about the policy when the user searches for a travel schedule. The annotations can include notices, with each notice coupled to a travel schedule to classify the travel schedule according to the policy restrictions, e.g., to place the travel schedule into one or the different policy groups. For example, the annotations can include a first notice corresponded to the justifiable group. The annotations can include a second notice corresponded to the non-bookable group. And the annotations can include an optional third notice corresponded to the allowable group.

The first notice of the annotations can be a non-compliance notice for travel schedules having an expense within the warning range. The first notice can be a non-compliant but bookable notice with a bookable reason or justification provided by the user. Thus, the annotation of the justification group can further include a justification field for accepting a justification from the employee.

The second notice of the annotations can be non-compliant when an expense of the travel schedule is above the upper threshold limit. The second notice can be a non-compliant and non-bookable notice. In general, the non-compliant non-bookable travel schedule is not bookable except in exceptional cases. Thus, the annotation of the non-bookable group can further include a field of request for approval for accepting a user request, which provides reasons for the company to grant an exception to the policy restrictions.

The third notice of the annotations can be an allowable notice, e.g., to show that the travel schedule is acceptable by the travel policy. The allowable notice can be optional, e.g., travel schedules without any annotation are allowable schedules.

The annotations can include feedback fields, for example, for some or for all the travel schedules, e.g., for allowable schedules, for justification schedules, and for non-bookable schedules. The feedback fields can be configured to accept feedbacks from the users regarding the policy restrictions, e.g., regarding the classification of the travel schedules or the values of the threshold limits. The user feedbacks can be used, for example, by an AI algorithm, to assess the effectiveness of the travel policy with regard to the control of the travel expenditures while ensuring a satisfaction of the users.

The display can also include explanations for the restrictions, with the explanations different for different users and based on actions of the user. The annotations can further include a recommendation notice to indicate recommending items by the travel policy. The travel search result is arranged based on the annotations, with results without annotations displayed first, e.g., allowable schedules, followed by results having the justification notice, and followed by results having the non-bookable notice.

The display can be configured to generate a graphical user interface rendered to accept the justification, the feedback, or the request from the users. The display, such as the graphical user interface, can be configured to provide a two-way communication between the company and the user for the company to respond to the justification, the feedback, or the request from the user. All of the multiple travel schedules from the search result can be presented to the employee, including travel schedules not meeting requirements of the travel policy or travel schedules restricted by the travel policy.

The method also includes (5) receiving an action from the user on the display for selecting a travel schedule. The user action can include a first action of the user, which includes a switching between the travel matrix format and the travel listing format. The switching action from the matrix format to the listing format can indicate that the elements of the matrix format are of interest to the user, and the user wants to see if there are any schedules for the selections of the matrix elements. The switching action from the listing format to the matrix format can indicate that the user is not completely satisfied with the elements of the listing format, and the user wants to seed better options.

The user action can include a second action of the user, which includes a selection or a deselection of a schedule element in the travel matrix format. A selection of an element in the matrix format can indicate that the user is interested in the element, and prefers the value or range of the matrix element. A deselection of an element in the matrix format can indicate that the user does not want the element, and can indicate a dissatisfaction with the value or range of the matrix element.

The user action can include a third action of the user, which includes a selection of a travel schedule in the travel listing format, such as a selection of the travel schedule for browsing, e.g., for finding more information about the travel schedule, or a selection of the travel schedule for booking or purchasing, e.g., to select the travel schedule as the final choice. The selection of a travel schedule in the listing format can indicate that the user is interested in the element, and prefers the value or range of the matrix element.

The user action can include a fourth action of the user, which includes the action of providing a justification from the user. For example, a user can select a travel schedule that is annotated as requiring a justification, e.g., a schedule that is borderline approved, meaning not allowed but can be allowed in needed situations. The user then prepares and submits the required justification, explaining the reasons for the selection of the non-bookable schedule.

The selection of the justification schedule can be processed and approved based on a compliance level of the user. For example, if the user history is largely compliant to the travel policy, the justification is accepted and the user can select the non-bookable schedule. The approval can be based on how close the non-bookable schedule is to allowable schedules. For example, if the non-bookable schedule is only slightly different, then the justification is accepted.

The justification action can provide an indication of how the user feels and thinks about the travel policy. For example, the reasons stated in the justification can indicate a satisfaction of the user with the restrictions of the policy. The information obtained from the justification can assist the company in the optimization of the travel policy.

The user action can include a fifth action of the user, which includes the action of providing a request for approval from the user. For example, a user can select a travel schedule that is annotated as requiring a request for approval, e.g., a schedule that is not allowed but can be allowed in special situations. The user then prepares and submits the required request, explaining the reasons for the selection of the non-bookable schedule.

The selection of the non-bookable schedule can be processed and approved or disapproved based on the situation of the user, and based on the reasons that the user presents in the request. For example, if the selection of the non-bookable schedule can be beneficial to the company, such as allowing the user a needed time to prepare his work, the request can be approved, and the user can select the non-bookable schedule.

The approval request action can provide an indication of how the user feels and thinks about the travel policy. The information obtained from the request can show the company that the policy should be flexible in certain situations.

There can be other actions, such as an action of providing a feedback from the user on certain travel schedules. The feedback can be used for any schedule, such as for allowable schedules, for justification schedules, and for non-bookable schedules. The feedback action can provide an indication of how the user feels and thinks about the travel policy. The information obtained from the feedback can assist the company in the optimization of the travel policy.

The other actions can also include an action of replacing a first flight element in the flight matrix format with a second flight element in the flight matrix format. For example, the user can select Southwest as a preferred airline, and then change the selection to choose Delta instead.

The selection or deselection of a flight element can include an AND or an OR selection or deselection, respectively.

The method also includes (6) updating the display of the travel search result after the user action. For example, after the user performs a switching action, the display is updated to show a display format that the user selected. After the user performs a selection action on the display, the display is updated to remove travel schedules not meeting the selected schedule element, e.g., to show only the travel schedules meeting the selected schedule element. For example, after the user performs a selection action on a Southwest airline element in a flight matrix, the elements of the matrix are updated, such as to grayed out elements not having a Southwest flight. After the user performs a selection action on a travel schedule in a flight listing, the flight listing is updated, such as to show only the selected flight with other flights removed.

After the user performs a deselection action on the display, the display is updated to remove travel schedules meeting the selected schedule element, e.g., to show only the travel schedules not meeting the selected schedule element. For example, after the user performs a selection action on a Southwest element in a flight matrix, the elements of the matrix are updated, such as to grayed out elements with only Southwest flights. After the user performs a selection action on a travel schedule in a flight listing, the flight listing is updated, such as to remove the selected flight.

The method also includes (7) analyzing the action from the user. The analysis can be optional. The analysis can be performed on each action of the user. Alternatively, the analysis can be performed after a trigger event, such as after a certain number of actions, such as 2, 5, or 10, or after a particular action, such as a browsing or a booking action. The analysis is configured to provide an indication of the user behavior or state of mind, at least with regard to the travel policy. For example, the analysis can generate a level of satisfaction of the user with respect to the travel policy, or to provide a correlation between the user satisfaction with a compliance of the user with the travel policy.

The method also includes (8) updating the profile of the user with the action and the analysis. The profile updating with the analysis can be optional, e.g., the analysis can be performed at any time when needed, since the analysis is based on the action.

Also, the profile updating can be performed on each action of the user. Alternatively, the profile updating can be performed after a trigger event, such as after a certain number of actions, such as 2, 5, or 10, or after a particular action, such as a browsing or a booking action.

The method also includes (9) assessing the profiles of the users to provide a suggestion of adjustment to the travel policy. The suggestion can be configured to assist in balancing satisfactions of the employees with a control of the travel related expenditures as dictated by the travel policy. The assessment can be performed on individual profiles of the users, or on one or more collected or aggregated profiles of the users. For example, each user can have a profile, and the profiles from all users can be assessed to provide an improvement suggestion on the travel policy. Alternatively, there can be one profile for all users, e.g., the policy improvement is based on a collective satisfaction of the users and not on individual users, e.g., the identities of the individual users are not relevant for the policy optimization.

The assessment can provide indications of behaviors of the users based on the actions of the users. The assessment can be performed by an artificial intelligent algorithm characterizing the actions of the employees to show levels of satisfaction and characterizing the analysis showing the employee compliance with the travel policy.

The analysis of the action can include generating an indication of user satisfaction and compliance with the travel policy. For example, a delay time between two consecutive user inputs can provide an indication user satisfaction and compliance with the travel policy.

The analysis of the action can include generating a balance of the travel policy with respect to a satisfaction of the users and an expense control of the travel policy. The analysis can be performed by the artificial intelligent algorithm configured to improve efficiency and cost effectiveness of the travel related expenditures with between 70 and 90% of user satisfaction.

The adjustment suggestion can include a suggestion for modifying the travel policy based on the justification, the feedback, or the request for approval from the user. The adjustment suggestion can include adjusting the upper threshold limits based on a history of compliance of the user with the travel policy.

A selection of the flight itinerary for browsing or for booking or purchasing can provide an indication of a user travel preference or satisfaction with a flight element involved in the selected flight itinerary. The levels of travel preference or satisfaction can increase in the preference associated with the flight element. The increase in the browsed flight itinerary can be lower than the increase in the booked or purchased flight itinerary.

A deselection can provide an indication of a user travel preference or satisfaction with a flight element involved in the selected flight itinerary. The levels of travel preference or satisfaction can decrease in the preference associated with the flight element.

A replacement can provide an indication of a user travel preference or satisfaction with a flight element involved in the replacing or replaced flight itinerary. The levels of travel preference or satisfaction can increase in the preference associated with the replacing element and a decrease in the preference associated with the replaced element.

A selection or deselection with AND or OR logic can provide an indication of a user travel preference or satisfaction with flight elements involved in the selected flight itinerary. The levels of travel preference or satisfaction can increase or decrease in the preference associated with the selected flight elements.

The method also includes (10) sending the adjustment or improvement suggestion to the company for modifying the travel policy.

The profile can include a log of actions in transactions associated with the user, together with information on the communication session between the user and the service provider, and together with indications of user behaviors based on the user actions. The profile can be stored in a database, together with the profiles of other users.

In addition to use the profiles for improving the travel policy, the profiles can also be used to obtain preferences of the users, also based on the actions. The actions can be obtained during a process of the user selecting a travel schedule, such as a flight itinerary, among multiple flight itineraries, which are the result of a flight search presented to the user based on a flight search request from the user to the service provider. The multiple travel schedules can include flight itineraries, bus or train itineraries, lodging accommodations, car rental, meals, or entertainment. The profile further can include information related to the user and collected by the service provider, such as data supplied to the platform by the user during the communication session, or data inferred by the service provider from the communication. For example, the user can sign up to the services of the service provider, and then answer a questionnaire having a password, a PIN number, secret questions, or a numerical sequence, an email address or billing address, possession comprising at least one of a mobile phone, wearable devices, a token, or a smartcard, inherent feature comprising at least one of fingerprint, voice recognition, iris recognition, or facial features. The profile can contain information obtained indirectly from the user, such as the IP addresses or the communication equipment or devices that the user uses when contacting the service provider, The indirectly-obtained information or data can include the times or the locations that the user uses when contacting the service provider, or the habit of the user in using the communication equipment, such as the usage of the keyboard or mouse. The profile can contain information obtained from public or private agencies or institutions, such as from disclosure or correspondence of the user in social media or in email.

The indications of the user behaviors can be generated by the service provider based on the information directly or indirectly obtained from the user. For example, the data obtained from the user can be conflict or contradict each other due to differences in user situations that are not known by the service provider. Thus, a machine learning program or an AI algorithm cam be used to determine the user behavior based on the user information.

There can be a direct relationship between the obtained information and the customer behavior, such as a low price selection can provide an indication of a frugal nature of the customer, or a localization of the user locations based on the IP addresses can provide an indication of the place of residence of the user.

There can be an indirect relationship between the obtained information and the customer behavior, such as after-business times of contacting the service provider can provide an indication of a 9-to-5 employee, or a consistence of contacting the service provider during business hours can provide an indication of a self-employed user or a non-working user.

The indications of the user behaviors can be generated by the service provider through a statistical analysis of the user information, such as lower price than high price selections can provide a high percentage of the user being frugal, or many long delay times between two consecutive inputs such as selections can provide a high percentage of the user being cautious.

The user information can be obtained directly or indirectly from the actions of the user in selecting a product, such as a flight itinerary, among multiple flight itineraries that the service provider presents to the user based on a search request from the user. The indirection information can include status data from the communication session between the user and the service provider, such as the IP address, the device or equipment used, the habit of keyboard and mouse usage. The direct information can include the actual selections of the user on a display of the flight search result.

The flight search result can be displayed in a flight matrix format or a flight itinerary format. The flight matrix format can be configured to show multiple flight elements configured in different flight categories in a first dimension and either different ranges or values of the flight categories in a second dimension. In the flight matrix format, there can be one or more elements of the flight matrix that are marked as there can be not a flight itinerary of the search result meeting the flight category and the range or value of the one or more elements.

The matrix format only shows the availability of the ranges or values of the flight categories, without showing the flight itineraries. Elements of the flight matrix can be configured to show that there is not a flight itinerary meeting the flight category and the range or value of the elements. For example, the flight matrix can show that there are Southwest flights, there are flights departing at 8-10, and there are flights costing 300-400. However, the flight matrix does not show that there are Southwest flights departing at 8-10 with the cost of 300-400. In contrast, the flight itinerary format can be configured to show a list of the multiple flight itineraries, but not the individual ranges or values of flight categories.

The actions can include a switching action of the user between the flight matrix format and the flight itinerary format. For example, there can be a command button which can allow the user to change the format, such as a listing button in the matrix format for changing to the listing format, and a matrix button in the listing format for changing to the matrix format.

The actions can include a selection or a deselection of a flight element in the flight matrix format. For example, the user can select Southwest, showing a preference for Southwest, since the user has a frequent flyer with Southwest. The user can deselect United, showing a dislike for United, perhaps since the user has a bad travel experience with United. The selection and deselection can show indications of the user behavior,

The display of the flight search result can be updated with the selection of the one or more flight elements removing flight itineraries not meeting the selected one or more flight elements, and with the deselection of the one or more flight elements removing flight itineraries meeting the selected one or more flight elements.

The actions can include a selection or a deselection of a flight itinerary in the flight itinerary format, for browsing or for booking. For example, the user can select a low cost flight or deselect an expensive flight, which can show a preference for low cost and a dislike for high cost. Thus, the actions of the user can be used to generate a behavior profile for the user, with the user behavior profile including indications of the user behavior.

After each action, e.g., either a selection or a deselection, the display of the flight search result can be updated with flight itineraries not meeting the selected flight element or flight itineraries meeting the deselected flight element removed from the flight matrix format;

The display formats of a matrix and a listing shown are an example of a selection of a product which is a flight itinerary. Other product searches can be displayed, such as a hotel search result, a car rental search result, or other products or services.

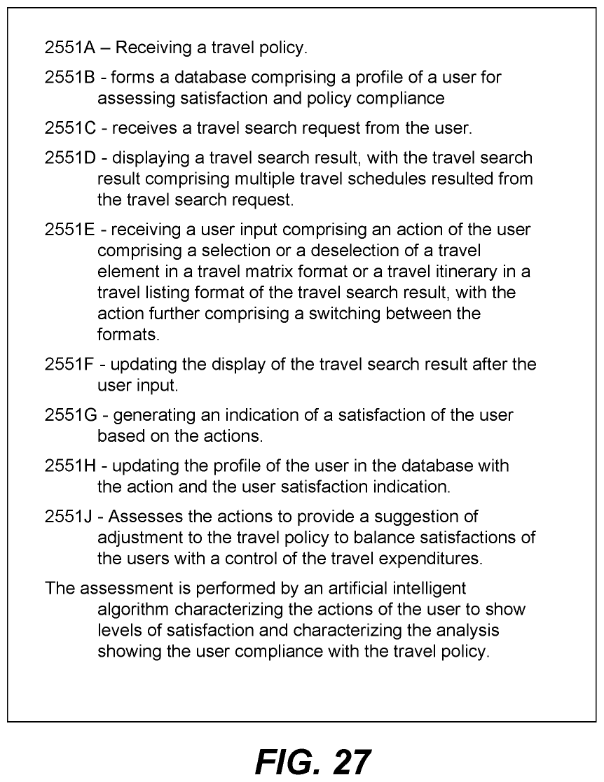

FIG. 27 illustrates a flow chart for optimizing a travel policy according to some embodiments. Operation 2551A receives a travel policy. Operation 2551B forms a database comprising a profile of a user for assessing satisfaction and policy compliance

Operation 2551C receives a travel search request from the user. Operation 2551D displays a travel search result, with the travel search result comprising multiple travel schedules resulted from the travel search request. Operation 2551E receives a user input comprising an action of the user comprising a selection or a deselection of a travel element in a travel matrix format or a travel itinerary in a travel listing format of the travel search result, with the action further comprising a switching between the formats. Operation 2551F updates the display of the travel search result after the user input.

Operation 2551G generates an indication of a satisfaction of the user based on the actions. Operation 2551H updates the profile of the user in the database with the action and the user satisfaction indication. Operation 2550 assesses the actions to provide a suggestion of adjustment to the travel policy to balance satisfactions of the users with a control of the travel expenditures. The assessment is performed by an artificial intelligent algorithm characterizing the actions of the user to show levels of satisfaction and characterizing the analysis showing the user compliance with the travel policy.

In some embodiments, the present invention discloses a computer-implemented method to optimize a travel policy of a company by assessing actions of its users, e.g., employees and associates of the company when using a travel service provided by a travel service provider. The assessment can be based on profiles of the users, which can use an AI algorithm to characterize the user actions to obtain indications of satisfaction.

The method includes (1) receiving a travel policy for a company. The travel policy can include restrictions regarding travel related expenditures for users, e.g., employees and associates of the company. The restrictions regarding travel related expenditures can include an upper threshold limit, a lower threshold limit, and a warning range for the travel related expenditures. The expenses above the upper threshold limit require approval from the company. The expenses under the lower threshold limit are automatically approved. The expenses within the warning range require justifications from the employees;

The method further includes (2) forming a database comprising profiles of the users. Each profile can be associated with a user. Alternatively, a profile can be formed for all users subjected to the travel policy of the company.

The profile can include a log of actions in transactions associated with the user, indications of user travel preferences based on the actions, and indications of the user satisfaction and compliance with the travel policy based on the actions. The actions are obtained during a process of the user selecting a travel schedule of multiple travel schedules, with the multiple travel schedules resulted from a travel search result presented to the user based on a travel search request from the user.

The travel search result is displayed in a travel matrix format or a travel listing format. The travel matrix format is configured to show multiple schedule elements configured in different travel categories in a first dimension and either different ranges or values of the travel categories in a second dimension. The travel listing format is configured to show a list of at least some of the multiple travel schedules.

At least a travel schedule in the travel listing format is annotated with the restrictions of the travel policy. The annotations can include a first notice of non-compliance when an expense of the travel schedule is within the warning range, with the first notice including a notice of bookable together with a bookable reason, and a first field for accepting a justification from the user. The annotations can include a second notice of non-compliance when an expense of the travel schedule is above the upper threshold limit, with the second notice including a notice of non-bookable together with a non-bookable reason, and a second field for accepting a feedback or a request for approval from the user.

The actions are selected from a group of actions comprising a switching action of the user between the flight matrix format and the flight itinerary format using a command displayed together with the flight matrix format and the flight itinerary format.

The actions can further include a selection or a deselection of a flight element in the flight matrix format or a flight itinerary in the flight itinerary format. After the selection action of the flight element, the display of the flight search result is updated with flight itineraries not meeting the selected flight element removed from the flight matrix format. The actions can further include a selection of a travel schedule in the travel listing format. The actions can further include the justification of the user, with the justification configured to be approved based on a compliance level of the user. The actions can further include the feedback or the request for approval,

The method further includes (3) updating the profile of the user with the actions and analysis of the actions. The analysis can include an estimate of a degree of compliance of the selection of the travel schedule with the requirements of the travel policy.

The method further includes (4) assessing the profiles of the users to provide a suggestion of adjustment to the travel policy, with the suggestion configured to assist in balancing satisfactions of the users with a control of the travel related expenditures as dictated by the travel policy. Assessing the profiles can be performed by an artificial intelligent algorithm characterizing the actions of the users to show levels of satisfaction and characterizing the analysis showing the user compliance with the travel policy.

The method further includes (5) sending the adjustment suggestion to the company for modifying the travel policy.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a travel policy for a company,
wherein the travel policy comprises restrictions regarding travel related expenditures for users related to the company,
wherein the restrictions regarding travel related expenditures comprises an upper threshold limit, a lower threshold limit, and a warning range for the travel related expenditures,
wherein expenses above the upper threshold limit require approval from the company,
wherein expenses under the lower threshold limit are automatically approved, and
wherein expenses within the warning range require justifications from an employees;
forming a database comprising at least a profile of the users,
wherein the profile comprises a log of user actions, indications of user travel preferences based on the actions, and indications of user satisfaction and compliance with the travel policy based on the actions;
receiving a travel search request from a user of the users;
displaying a travel search result, with the travel search result comprising multiple travel schedules for a travel related activity in the travel search request,
wherein the travel search result is displayed in a travel matrix format or a travel listing format,
wherein the travel matrix format is configured to show multiple schedule elements configured in different travel categories in a first dimension and either different ranges or values of the travel categories in a second dimension,
wherein the travel listing format is configured to show a list of at least some of the multiple travel schedules,
wherein each of the travel matrix format and the travel listing format comprises a command selectable by the employee for switching between the formats,
wherein at least a travel schedule of the multiple travel schedules in the travel listing format are annotated with the restrictions of the travel policy, and
wherein the annotation is selected from a notice group comprising:
a first notice of non-compliance when an expense of the travel schedule is within the warning range, with the first notice comprising a notice of bookable together with a bookable reason, and a first field for accepting a justification from the user, or
a second notice of non-compliance when an expense of the travel schedule is above the upper threshold limit, with the second notice comprising a notice of non-bookable together with a non-bookable reason, and a second field for accepting a feedback or a request for approval from the user;
receiving an action from the user,
wherein the action is selected from a group of actions comprising at least one of:
a first action of the user comprising a switching between the travel matrix format and the travel listing format,
a second action of the user comprising a selection or a deselection of a schedule element in the travel matrix format,
a third action of the user comprising a selection of a travel schedule in the travel listing format,
a fourth action comprising the justification of the user, with the justification configured to be approved based on a compliance level of the user, or
a fifth action comprising the feedback or the request for approval;
updating the display of the travel search result after the action,
wherein the selection of the schedule element removes travel schedules not meeting the selected schedule element, and
wherein the deselection of the schedule element removes travel schedules meeting the deselected schedule element;
analyzing the action from the user,
wherein the analyzing comprises an estimate of a satisfaction of the user or a compliance with the requirements of the travel policy;
updating the profile of the user with the action and the analyzing;
assessing the profile to provide a suggestion of adjustment to the travel policy, with the suggestion configured to assist in balancing satisfactions of the users with a control of the travel related expenditures as dictated by the travel policy,
wherein assessing the profiles is performed by an artificial intelligent algorithm characterizing the actions of the users to show levels of satisfaction and characterizing the analyzing showing the employee compliance with the travel policy; and
sending the adjustment suggestion to the company for modifying the travel policy.

2. The method of claim 1, wherein the at least a profile comprise multiple profiles with each profile associated with a user.

3. The method of claim 1,
wherein the at least a profile comprise multiple profiles with each profile associated with a user, and
wherein the profile associated with a user is also used to generate travel preferences for the user.

4. The method of claim 1, wherein the at least a profile comprise a profile associated with the users.

5. The method of claim 1, wherein at least one element of the travel matrix is configured to show that there is not a flight itinerary of a set of multiple flight itineraries meeting a flight category and the range or value of the at least one element.

6. A method as in claim 1, wherein the display is configured to generate a graphical user interface rendered to accept the justification, the feedback, or the request from the employee.

7. A method as in claim 1,
wherein the display is configured to generate a graphical user interface rendered to accept the justification, the feedback, or the request from the employee, and
wherein the graphical user interface is configured to provide a two-way communication between the company and the employee for the company to respond to the justification, the feedback, or the request from the employee.

8. A method as in claim 1, wherein the display is configured to provide a two-way communication between the company and the employee for the company to respond to the justification, the feedback, or the request from the employee.

9. A method as in claim 1, wherein all the multiple travel schedules from the search result are presented to the employee, including travel schedules not meeting requirements of the travel policy or travel schedules restricted by the travel policy.

10. A method as in claim 1, wherein the annotations further comprise a recommendation notice to indicate recommending items by the travel policy.

11. A method as in claim 1, wherein the travel search result is arranged based on the annotations, with results without annotations displayed first, followed by results having the first notice, and followed by results having the second notice.

12. A method as in claim 1, wherein the display comprises explanations for the restrictions, with the explanations different for different employee and based on actions of the employee.

13. A method as in claim 1, wherein the multiple travel schedules comprises flight itineraries, bus or train itineraries, lodging accommodations, car rental, meals, or entertainment.

14. A method as in claim 1, wherein analyzing the action comprises generating an indication of the indications of employee travel preferences of the indications of the employee satisfaction and compliance with the travel policy.

15. The method of claim 1, wherein analyzing the action further comprises generating, based on a delay time between two consecutive employee inputs, an indication of the indications of employee travel preferences or of the indications of the employee satisfaction and compliance with the travel policy.

16. The method of claim 1,
wherein when the action comprise a selection of a flight itinerary in a flight itinerary format for browsing or for booking or purchasing, the indications of the employee travel preferences are generated with an increase in the preference associated with a flight element involved in the selected flight itinerary, with the increase in the browsed flight itinerary lower than the increase in the booked or purchased flight itinerary,
wherein when the action comprise a selection of the flight element in the travel matrix format, the indications of the employee travel preferences are generated with an increase in the preference associated with the flight element, or
wherein when the action comprise a deselection of the flight element in the flight matrix format, the indications of the user travel preferences are generated with a decrease in the preference associated with the flight element.

17. A method as in claim 1, wherein a balance of the travel policy is performed by the artificial intelligent algorithm configured to improve efficiency and cost effectiveness of the travel related expenditures with between 70 and 90% of employee satisfaction.

18. A method as in claim 1,
wherein the adjustment suggestion comprises a suggestion for modifying the travel policy based on the justification, the feedback, or the request for approval from the employee, or
wherein the adjustment suggestion comprises adjusting the upper threshold limits based on a history of compliance of the employee with the travel policy.

19. A method comprising:
receiving a travel policy for a company,
wherein the travel policy comprises restrictions regarding travel related expenditures for employees of the company,
wherein the restrictions regarding travel related expenditures comprises an upper threshold limit, a lower threshold limit, and a warning range for the travel related expenditures,
wherein expenses above the upper threshold limit require approval from the company,
wherein expenses under the lower threshold limit are automatically approved, and
wherein expenses within the warning range require justifications from the employees;
forming a database comprising profiles of the employees,
wherein a profile of the profiles is associated with an employee of the employees,
wherein the profile comprises a log of actions in transactions associated with the employee, indications of employee travel preferences based on the actions, and indications of employee satisfaction and compliance with the travel policy based on the actions,
wherein the actions are obtained during a process of the employee selecting a travel schedule of multiple travel schedules, with the multiple travel schedules resulted from a travel search result presented to the employee based on a travel search request from the employee,
wherein the travel search result is displayed in a travel matrix format or a travel listing format,
wherein the travel matrix format is configured to show multiple schedule elements configured in different travel categories in a first dimension and either different ranges or values of the travel categories in a second dimension,
wherein the travel listing format is configured to show a list of at least some of the multiple travel schedules,
wherein at least a travel schedule of the multiple travel schedules in the travel listing format are annotated with the restrictions of the travel policy,
wherein the annotation is selected from a notice group comprising:
a first notice of non-compliance when an expense of the travel schedule is within the warning range, with the first notice comprising a notice of bookable together with a bookable reason, and a first field for accepting a justification from the employee, or
a second notice of non-compliance when an expense of the travel schedule is above the upper threshold limit, with the second notice comprising a notice of non-bookable together with a non-bookable reason, and a second field for accepting a feedback or a request for approval from the employee;
wherein the actions are selected from a group of actions comprising a switching action of a user between a travel matrix format and a flight itinerary format using a command displayed together with the flight matrix format and the flight itinerary format,
wherein the group of actions further comprises a selection or a deselection of a flight element in the flight matrix format or a flight itinerary in the flight itinerary format,
wherein after the selection action of the flight element, the display of the flight search result is updated with flight itineraries not meeting the selected flight element removed from the flight matrix format,
wherein the group of actions further comprises a selection of a travel schedule in the travel listing format,
wherein the group of actions further comprises the justification of the employee, with the justification configured to be approved based on a compliance level of the employee, and
wherein the group of actions further comprises the feedback or the request for approval,
updating the profile of the employee with the actions and analysis of the actions,
wherein the analysis comprises an estimate of a degree of compliance of the selection of the travel schedule with the requirements of the travel policy;
assessing the profiles of the employees to provide a suggestion of adjustment to the travel policy, with the suggestion configured to assist in balancing satisfactions of the employees with a control of the travel related expenditures as dictated by the travel policy,
wherein assessing the profiles is performed by an artificial intelligent algorithm characterizing the actions of the employees to show levels of satisfaction and characterizing the analysis showing the employee compliance with the travel policy; and
sending the adjustment suggestion to the company for modifying the travel policy.

20. A method comprising:
receiving a travel policy for a company,
wherein the travel policy comprises restrictions regarding travel related expenditures for employees of the company,
wherein the restrictions regarding travel related expenditures comprises an upper threshold limit, a lower threshold limit, and a warning range for the travel related expenditures,
wherein expenses above the upper threshold limit require approval from the company,
wherein expenses under the lower threshold limit are automatically approved, and
wherein expenses within the warning range require justifications from the employees;
forming a database comprising a profile of the employees,
wherein the profile comprises a log of actions in transactions associated with the employees, indications of travel preferences of the employees based on the actions, and indications of satisfaction and compliance of the employees with the travel policy based on the actions,
wherein the actions are obtained during a process of an employee of the employees selecting a travel schedule of multiple travel schedules, with the multiple travel schedules resulted from a travel search result presented to the employee based on a travel search request from the employee,
wherein the travel search result is displayed in a travel matrix format or a travel listing format,
wherein the travel matrix format is configured to show multiple schedule elements configured in different travel categories in a first dimension and either different ranges or values of the travel categories in a second dimension,
wherein the travel listing format is configured to show a list of at least some of the multiple travel schedules,
wherein at least a travel schedule of the multiple travel schedules in the travel listing format are annotated with the restrictions of the travel policy, and
wherein the annotation is selected from a notice group comprising:
a first notice of non-compliance when an expense of the travel schedule is within the warning range, with the first notice comprising a notice of bookable together with a bookable reason, and a first field for accepting a justification from the employee, or
a second notice of non-compliance when an expense of the travel schedule is above the upper threshold limit, with the second notice comprising a notice of non-bookable together with a non-bookable reason, and a second field for accepting a feedback or a request for approval from the employee;
wherein the actions are selected from a group of actions comprising a switching action of a user between a travel matrix format and a flight itinerary format using a command displayed together with the flight matrix format and the flight itinerary format,
wherein the group of actions further comprises a selection or a deselection of a flight element in the flight matrix format or a flight itinerary in the flight itinerary format,
wherein after the selection action of the flight element, the display of the flight search result is updated with flight itineraries not meeting the selected flight element removed from the flight matrix format,
wherein the group of actions further comprises a selection of a travel schedule in the travel listing format,
wherein the group of actions further comprises the justification of the employee, with the justification configured to be approved based on a compliance level of the employee, and
wherein the group of actions further comprises the feedback or the request for approval,
updating the profile of the employee with the actions and analysis of the actions,
wherein the analysis comprises an estimate of a degree of compliance of the selection of the travel schedule with the requirements of the travel policy;
assessing the profiles of the employees to provide a suggestion of adjustment to the travel policy, with the suggestion configured to assist in balancing satisfactions of the employees with a control of the travel related expenditures as dictated by the travel policy,
wherein assessing the profiles is performed by an artificial intelligent algorithm characterizing the actions of the employees to show levels of satisfaction and characterizing the analysis showing the employee compliance with the travel policy; and
sending the adjustment suggestion to the company for modifying the travel policy.
